(19) United States
(12) Patent Application Publication
(10) Pub. No.: US 2024/0378480 A1
(43) Pub. Date: Nov. 14, 2024

(54) CLASSICAL AND QUANTUM COMPUTATIONAL METHOD AND APPARATUS FOR PERFORMING PRIME FACTORIZATION OF AN INTEGER, CLASSICAL AND QUANTUM COMPUTATIONAL METHOD AND APPARATUS FOR INVERTING A LOGIC GATE CIRCUIT

(71) Applicant: PARITY QUANTUM COMPUTING GMBH, Innsbruck (AT)

(72) Inventors: Wolfgang LECHNER, Rum (AT); Martin LANTHALER, Innsbruck (AT)

(21) Appl. No.: 18/683,157

(22) PCT Filed: Aug. 12, 2021
(86) PCT No.: PCT/EP2021/072520

§ 371 Date: Feb. 12, 2024

(51) Int. Cl. G06N 10/60; G06F 17/14; G06N 10/20

(52) U.S. Cl. CPC G06N 10/60; G06F 17/144; G06N 10/20

(57) ABSTRACT

A quantum computational method of performing prime factorization of an integer includes determining a logic gate circuit including logic gates, the circuit configured to compute a multiplication function outputting the integer. The method includes determining gate-encoding Hamiltonians (HG) for each logic gate, each HG encodes an input-output relation of a logic gate and is a sum of summand Hamiltonians; providing a quantum system comprising constituents, wherein each summand Hamiltonian of each HG is associated with a constituent of the system; determining a first set of short-range quantum interactions of the constituents based on the logic gates; determining a second set of short-range quantum interactions of the constituents based on the integer; implementing the first and the second set of short-range quantum interactions; measuring at least a portion of the quantum system to obtain a read-out and determining a prime factor of the integer based on the read-out.

### FIELD

Embodiments described herein relate to a quantum computational method. The quantum computational method uses a quantum system including constituents, such as qubits. The constituents of the quantum system are acted upon by, for example, a quantum processing unit, to process the information carried by the constituents. Some of the constituents of the quantum system are measured to reveal the information contained in the constituents. Based on the read-out obtained from the measurement, a computational problem is solved. Further embodiments described herein relate to a fundamental subroutine of a quantum computation operating with a quantum system. Further embodiments described herein relate to an apparatus for performing the disclosed methods.

### BACKGROUND

It is a basic mathematical fact that every integer can be decomposed as a product of prime factors. Yet, the problem of computing the prime factors of a given integer is known to be computationally difficult. In fact, no algorithm for a conventional (classical) computer is known that can factor an integer in a runtime that scales as a polynomial of the number of digits of the integer in question. This computational difficulty of the factoring problem forms the basis of cryptographic protocols, such as the RSA protocol (Rivest-Shamir-Adleman), which are widely used to encrypt information.

Quantum computers are a new type of computing devices in which information is stored in a quantum system. The quantum system can be made up of a plurality of constituents, such as qubits, which are used for storing and processing information. At the end of a quantum computation, the information can be read out by performing a measurement of at least part of the quantum system. The quantum system obeys the laws of quantum physics and thus exhibits quantum effects. Such quantum effects can be exploited to perform certain computational tasks faster than any known classical algorithms.

Quantum algorithms for performing integer factorization have been put forward. However, while several such algorithms might accomplish the task of factoring an integer of arbitrary size in theory, the practical implementation of such quantum algorithms is experimentally very demanding. In particular, the number of qubits needed for factoring integers of even moderate size may be quite considerable. Further, the quantum interactions needed for implementing the quantum algorithms in question may be long-range interactions, which are experimentally difficult, if not unfeasible, to realize.

For example, one approach is to formulate the factoring problem as an optimization problem, such as a quadratic unconstrained binary optimization (QUBO) problem, and to use existing quantum algorithms for solving such QUBO problems in general. However, such a QUBO approach to integer factorization typically involves long-range quantum algorithms. In some implementations, these long-range interactions can be removed by subsequently mapping the quantum system onto another quantum system with which the integer factorization can be realized using short-range quantum interactions only. For example, the initial QUBO related quantum algorithm may be mapped onto a quantum hardware graph as used in the DWAVE system, the latter involving short-range interactions only. However, such an additional mapping comes at the cost of the number of qubits that are needed in the resulting quantum system. In particular, the number of qubits that are needed to ensure that only short-range interactions are involved may scale as (log N)⁴, where N is the size (number of digits) of the integer to be factorized. Such a fourth order scaling may become intractable as the number of digits grows larger.

In light of the above, there is a need for improved quantum algorithms for integer factorization.

### SUMMARY

According to an embodiment, a quantum computational method of performing prime factorization of an integer is provided. The quantum computational method includes determining a logic gate circuit including logic gates, the logic gate circuit being configured to compute a multiplication function having, as an output, the integer. The quantum computational method includes determining gate-encoding Hamiltonians, one for each logic gate of the logic gates, wherein each gate-encoding Hamiltonian encodes an input-output relation of a logic gate of the logic gates and is a sum of summand Hamiltonians. The quantum computational method includes providing a quantum system comprising constituents, wherein each summand Hamiltonian of each gate-encoding Hamiltonian of the gate-encoding Hamiltonians is associated with a respective constituent of the quantum system. The quantum computational method includes determining a first set of short-range quantum interactions of the constituents based on the logic gates of the logic gate circuit. The quantum computational method includes determining a second set of short-range quantum interactions of the constituents based on the integer. The quantum computational method includes evolving the quantum system, including implementing the first set of short-range quantum interactions and the second set of short-range quantum interactions. The quantum computational method includes measuring at least a portion of the quantum system to obtain a read-out. The quantum computational method includes determining a prime factor of the integer based on the read-out.

According to a further embodiment, a quantum computational method of performing prime factorization of an integer is provided. The quantum computational method includes determining a logic gate circuit including logic gates, the logic gate circuit being configured to compute a multiplication function having, as an output, the integer. The quantum computational method includes providing a quantum system comprising constituents. The quantum computational method includes determining a first set of short-range quantum interactions of the constituents based on the logic gates. The determining comprises, for each logic gate of the logic gates, determining a subset of constituents associated with the logic gate and encoding the logic gate in short-range quantum interactions of the subset of constituents. The quantum computational method includes determining a second set of short-range quantum interactions of the constituents based on the integer. The quantum computational method includes evolving the quantum system, including implementing the first set of short-range quantum interactions and the second set of short-range quantum interactions. The quantum computational method includes measuring at least a portion of the quantum system to obtain a read-out. The quantum computational method includes determining a prime factor of the integer based on the read-out.

According to a further embodiment, a fundamental subroutine of, or for, a quantum computation operating with a quantum system including constituents is provided. The fundamental subroutine includes determining an elementary subsystem of the quantum system including at least four of the constituents. Each summand Hamiltonian of the gate-encoding Hamiltonian H_{AND} defined by

H_{AND}=−σₛ−σᵤσₛ−σᵥσₛ+σᵤσᵥσₛ

is associated with a respective constituent of the elementary subsystem. The gate-encoding Hamiltonian H_{AND} encodes an input-output relation of an AND gate having logical variables u and v as input variables and a logical variable s as an output variable. Therein, σᵤ, σᵥ and σₛ are spin observables associated with the logical variables u, v and s, respectively. The fundamental subroutine includes determining short-range quantum interactions for the elementary subsystem from the gate-encoding Hamiltonian H_{AND}. The fundamental subroutine includes evolving the quantum system, including implementing the determined short-range quantum interactions in the elementary subsystem.

According to a further embodiment, a fundamental subroutine of, or for, a quantum computation operating with a quantum system including constituents is provided. The fundamental subroutine includes determining an elementary subsystem of the quantum system including at least eight of the constituents. Each summand Hamiltonian of the gate-encoding Hamiltonian H_{AND.FA} defined by

$$\begin{matrix}{H}_{AND . FA} = - {σ}_{s} {σ}_{c} {σ}_{s} , - {σ}_{u} {σ}_{s} {σ}_{c} {σ}_{s} , - {σ}_{v} {σ}_{s} {σ}_{c} {σ}_{s} , + {σ}_{u} {σ}_{v} {σ}_{s} {σ}_{c} {σ}_{s} , \\ - {σ}_{s} {σ}_{c} {σ}_{s} , {σ}_{c} , - {σ}_{s} {σ}_{c} , - {σ}_{c} {σ}_{c} , + {σ}_{s} , {σ}_{c} ,\end{matrix}$$

is associated with a respective constituent of the elementary subsystem. The gate-encoding Hamiltonian H_{AND.FA} encodes an input-output relation of an AND.FA gate having logical variables u, v, s and c as input variables and logical variables s′ and c′ as output variables. Therein, σᵤ, σᵥ, σₛ, σ_{c}, σₛ′ and σ_{c}′ are spin observables associated with the logical variables u, v, s, c, s′ and c′, respectively. The fundamental subroutine includes determining short-range quantum interactions for the elementary subsystem from the gate-encoding Hamiltonian H_{AND.FA}. The fundamental subroutine includes evolving the quantum system, including implementing the determined short-range quantum interactions in the elementary subsystem.

According to a further embodiment, a method of performing a quantum computation is provided. The method includes providing a quantum system comprising constituents. The method includes performing one or more fundamental subroutines as described herein, such as one or more fundamental subroutines involving the AND gate and/or one or more fundamental subroutines involving the AND.FA gate. The method includes measuring at least a portion of the quantum system to obtain a read-out.

According to a further embodiment, a quantum computational method of inverting a logic gate circuit including logic gates is provided. The quantum computational method includes providing an output of the logic gate circuit that corresponds to an unknown input of the logic gate circuit. The quantum computational method includes determining gate-encoding Hamiltonians, one for each logic gate of the logic gates, wherein each gate-encoding Hamiltonian encodes an input-output relation of a logic gate of the logic gates and is a sum of summand Hamiltonians. The quantum computational method includes providing a quantum system comprising constituents, wherein each summand Hamiltonian of each gate-encoding Hamiltonian of the gate-encoding Hamiltonians is associated with a respective constituent of the quantum system. The quantum computational method includes determining a first set of short-range quantum interactions of the constituents based on the logic gates of the logic gate circuit. The quantum computational method includes determining a second set of short-range quantum interactions of the constituents based on the output of the logic gate circuit. The quantum computational method includes evolving the quantum system, including implementing the first set of short-range quantum interactions and the second set of short-range quantum interactions. The quantum computational method includes measuring at least a portion of the quantum system to obtain a read-out. The quantum computational method includes determining the unknown input of the logic gate circuit based on the readout.

According to a further embodiment, an apparatus for performing prime factorization of an integer is provided. The apparatus includes a classical computing system. The apparatus includes a quantum system comprising constituents. The apparatus includes a quantum processing unit. The apparatus includes a measurement unit. The classical computing system is configured for determining a logic gate circuit including logic gates, the logic gate circuit being configured to compute a multiplication function having, as an output, the integer. The classical computing system is configured for determining gate-encoding Hamiltonians, one for each logic gate of the logic gates, wherein each gate-encoding Hamiltonian encodes an input-output relation of a logic gate of the logic gates and is a sum of summand Hamiltonians, wherein each summand Hamiltonian of each gate-encoding Hamiltonian of the gate-encoding Hamiltonians is associated with a respective constituent of the quantum system. The classical computing system is configured for determining a first set of short-range quantum interactions of the constituents based on the logic gates of the logic gate circuit. The classical computing system is configured for determining a second set of short-range quantum interactions of the constituents based on the integer. The quantum processing unit is configured for evolving the quantum system, including implementing the first set of short-range quantum interactions and the second set of short-range quantum interactions. The measurement unit is configured for measuring at least a portion of the quantum system to obtain a read-out. The classical computing system is further configured for determining a prime factor of the integer based on the read-out.

According to a further embodiment, an apparatus for performing prime factorization of an integer is provided. The apparatus includes a classical computing system. The apparatus includes a quantum system comprising constituents. The apparatus includes a quantum processing unit. The apparatus includes a measurement unit. The classical computing system is configured for determining a logic gate circuit including logic gates, the logic gate circuit being configured to compute a multiplication function having, as an output, the integer. The classical computing system is configured for determining a first set of short-range quantum interactions of the constituents based on the logic gates. The determining comprises, for each logic gate of the logic gates, determining a subset of constituents associated with the logic gate and encoding the logic gate in short-range quantum interactions of the subset of constituents. The classical computing system is configured for determining a second set of short-range quantum interactions of the constituents based on the integer. The quantum processing unit is configured for evolving the quantum system, including implementing the first set of short-range quantum interactions and the second set of short-range quantum interactions. The measurement unit is configured for measuring at least a portion of the quantum system to obtain a read-out. The classical computing system is further configured for determining a prime factor of the integer based on the read-out.

According to a further embodiment, an apparatus for inverting a logic gate circuit including logic gates is provided. The apparatus includes a classical computing system. The apparatus includes a quantum system comprising constituents. The apparatus includes a quantum processing unit. The apparatus includes a measurement unit. The classical computing system is configured for providing an output of the logic gate circuit that corresponds to an unknown input of the logic gate circuit. The classical computing system is configured for determining gate-encoding Hamiltonians, one for each logic gate of the logic gates, wherein each gate-encoding Hamiltonian encodes an input-output relation of a logic gate of the logic gates and is a sum of summand Hamiltonians, wherein each summand Hamiltonian of each gate-encoding Hamiltonian of the gate-encoding Hamiltonians is associated with a respective constituent of the quantum system. The classical computing system is configured for determining a first set of short-range quantum interactions of the constituents based on the logic gates of the logic gate circuit. The classical computing system is configured for determining a second set of short-range quantum interactions of the constituents based on the output of the logic gate circuit. The quantum processing unit is configured for evolving the quantum system, including implementing the first set of short-range quantum interactions and the second set of short-range quantum interactions. The measurement unit is configured for measuring at least a portion of the quantum system to obtain a read-out. The classical computing system is further configured for determining the unknown input of the logic gate circuit based on the readout.

Embodiments are also directed to methods for operating the systems described herein, and to the use of the systems to perform the methods according to the embodiments described herein.

Further advantages, features, aspects and details that can be combined with embodiments described herein are evident from the dependent claims, the description and the drawings.

### BRIEF DESCRIPTION OF THE DRAWINGS

A full and enabling disclosure to one of ordinary skill in the art is set forth more particularly in the remainder of the specification including reference to the accompanying drawings wherein:

FIG. 1 shows a schematic representation of an AND gate;

FIG. 2 shows a schematic representation of a logic gate circuit;

FIG. 3 shows a schematic representation of a quantum system having local subsystems;

FIG. 4 shows a schematic representation of a local subsystem associated with an AND gate;

FIG. 5 schematically illustrates a mapping from a gate-encoding Hamiltonian to constituents of a local subsystem of a quantum system as described herein;

FIG. 6 schematically illustrates a mapping from a logic gate to a short-range quantum Hamiltonian via a gate-encoding Hamiltonian as described herein;

FIG. 7 shows a schematic representation of a quantum system associated with the logic gate circuit of FIG. 2;

FIG. 8 shows a schematic representation of an AND.FA gate;

FIG. 9 shows a schematic representation of a local subsystem associated with an AND.FA gate;

FIG. 10 shows a schematic representation of a logic gate circuit that computes a multiplication function;

FIG. 11 shows a schematic representation of a quantum system associated with the logic gate circuit of FIG. 10;

FIG. 12 shows an apparatus according to embodiments described herein;

FIG. 13 illustrates integer factorization as an inverse of integer multiplication;

FIG. 14 illustrates a mapping of a multiplication circuit to a quantum system using a method according to embodiments described herein;

FIG. 15i-ix illustrate logic gates, and interconnections between logic gates, and the associated local subsystems and quantum Hamiltonians:

FIG. 16a) illustrates a multiplication circuit composed of AND gates and AND.FA gates; FIG. 16b) illustrates the internal structure of an AND.FA gate;

FIG. 17 illustrates an AND gate and the properties of the associated gate-encoding Hamiltonian;

FIG. 18 illustrates an AND.FA gate and the properties of the associated gate-encoding Hamiltonian;

FIG. 19 shows the performance of different methods for factorizing integers using a quantum computer;

FIGS. 20A-B illustrate a method for performing inter factorization according to embodiments described herein, for the case where the inputs p and q are 3-bit integers.

### DETAILED DESCRIPTION

Reference will now be made in detail to the various exemplary embodiments, one or more examples of which are illustrated in each figure. Each example is provided by way of explanation and is not meant as a limitation. For example, features illustrated or described as part of one embodiment can be used on or in conjunction with other embodiments to yield yet further embodiments. It is intended that the present disclosure includes such modifications and variations.

Within the description of the drawings, the same reference numbers refer to the same or similar components. Generally, only the differences with respect to the individual embodiments are described. The structures shown in the drawings are not necessarily depicted true to scale, and may contain details drawn in an exaggerated way to allow for a better understanding of the embodiments.

Embodiments described herein relate to a quantum computational method of performing prime factorization of an integer. The quantum computational method includes determining a logic gate circuit including logic gates, the logic gate circuit being configured to compute a multiplication function having, as an output, the integer. The quantum computational method includes determining gate-encoding Hamiltonians, one for each logic gate of the logic gates, wherein each gate-encoding Hamiltonian encodes an input-output relation of a logic gate of the logic gates and is a sum of summand Hamiltonians. The quantum computational method includes providing a quantum system comprising constituents, wherein each summand Hamiltonian of each gate-encoding Hamiltonian of the gate-encoding Hamiltonians is associated with a respective constituent of the quantum system. The quantum computational method includes determining a first set of short-range quantum interactions of the constituents based on the logic gates of the logic gate circuit. The quantum computational method includes determining a second set of short-range quantum interactions of the constituents based on the integer. The quantum computational method includes evolving the quantum system, including implementing the first set of short-range quantum interactions and the second set of short-range quantum interactions. The quantum computational method includes measuring at least a portion of the quantum system to obtain a read-out. The quantum computational method includes determining a prime factor of the integer based on the read-out.

Embodiments provide the advantage that the quantum computational method involves short-range quantum interactions only. This is an improvement over other approaches to factoring that require long-range interactions, since the latter may be experimentally unfeasible. In particular, according to some embodiments, the constituents of the quantum system may be arranged on the vertices of a portion of a 3-dimensional body-centered lattice (specifically, the portion may involve a pair of two-dimensional lattices that are stacked on top of each other), where interactions are only present between pairs of adjacent unit cells of the lattice.

Another advantage is that the number of constituents of the quantum system scales as (log N)², where N is the size (number of digits) of the integer to be factorized. Accordingly, as compared, for example, to QUBO approaches to factoring, which have a (log N)⁴ scaling, the exponent is improved by a factor 2.

Another advantage is that the present method provides a scalable approach which is made up of elementary building blocks that can be joined together in a flexible manner. This means that, as the size of the integer to be factored grows larger, the corresponding quantum system can be enlarged in a modular way, by adding further elementary groups of constituents (called herein local subsystems) while leaving the initial quantum system generally unchanged. Likewise, the required short-range quantum interactions are also modular, i.e. increasing the size of the integer can be accounted for by adding new quantum interactions between the additional local subsystems, while the initial short-range interactions can remain in place.

Another advantage is that the magnitudes (strengths) of the short-range quantum interactions are bounded by a constant, denoted mathematically as O(1). That is to say, the magnitudes of the interactions do not increase as the integer to be factorized grows larger but are independent of the size of the integer. This is in contrast to other approaches, where interactions of magnitude O(N) or even larger are needed, i.e. magnitudes that scale as the number of digits of the integer. Such large magnitudes are experimentally very challenging since they need, for example, the application of very strong electromagnetic fields.

### Quantum System

A quantum system as described herein is a physical system exhibiting quantum effects. That means, the quantum system is a real-world object. The quantum system includes constituents. The constituents of the quantum system are physical quantum entities themselves, and can be regarded as smaller d-level quantum systems that jointly form the quantum system. Specifically, the constituents of the quantum system can be qubits. A qubit shall be understood as a physical entity that realizes a two-level quantum system. The constituents may be d-level quantum systems (“qudits”) with d>2, wherein only two levels of the d levels might be used.

The quantum system can be in different quantum states, such as an initial quantum state (in which it may be prepared at the beginning of a quantum computation) and a final quantum (in which it may end up due to the quantum computation). The final quantum state can be a ground state of a final quantum Hamiltonian of the quantum system. A quantum Hamiltonian is an observable (i.e., a measurable quantity) of a quantum system whose eigenvalues represent the possible energies of the quantum system. The quantum system can be evolved from an initial quantum state to a ground state of a final quantum Hamiltonian of the quantum system. Such an evolution is a real-world process, and particularly a controlled technical process (quantum computation) which brings the quantum system from an initial quantum state to an a priori unknown final quantum state that contains information about the solution to a computational problem. This information can be revealed by measuring the quantum system or a part thereof, i.e., at least some of its constituents. The act of measuring is a physical/technical process. Measurements allow to obtain a read-out of the quantum system. A read-out of a quantum system is a set of measurement values obtained by measurements of constituents of the quantum system, involving physical interactions with the constituents.

The quantum system may include K qubits, wherein K may be at least 100, at least 1.000 or at least 10.000. K may be from 100 and 10.000, or from 100 to 100.000, but K may be larger than 100.000. It shall be understood that the quantum systems shown in the figures and described in examples may be much smaller for illustrative and explanatory purposes, but shall not be understood to provide any limitation.

As described in EP 3 113 084 B1, joint quantum interactions between a group of constituents of the quantum system may only realizable if the constituents of that group are close to each other. A short-range quantum Hamiltonian may refer to a Hamiltonian representing joint interactions within groups of constituents, wherein no interactions occur between constituents which are distanced from each other by a distance greater than an interaction cut-off distance D_{SR}. The interaction cut-off distance D_{SR} may be a constant distance. The interaction cut-off distance D_{SR} may be much smaller compared to a maximal constituent distance between constituents in the particular arrangement of the constituents of the quantum system. For example, the interaction cut-off distance may be 30% or below of the maximal constituent distance, in particular 20% or below, more particularly 10% or below. If the constituents are arranged in a lattice having an elementary distance (lattice constant), a short-range quantum Hamiltonian may be such that no interactions occur between constituents distanced from each other by a distance greater than r times the elementary distance (lattice constant) of the lattice. Therein, r may be from 1 to 5, e.g. r=√2, 2, 3, 4 or 5.

The quantum interactions represented by a short-range quantum Hamiltonian are said to be short-range quantum interactions. A quantum interaction between a group of constituents of the quantum system is a short-range quantum interaction if the maximum distance of constituents in said group is smaller than or equal to the interaction cut-off distance D_{SR}.

Herein, the term “classical” is used to distinguish over “quantum”. The term “classical” can be understood as “not quantum”.

For example, a classical information carrier, such as a classical bit, is distinguished from a quantum information carrier, such as a qubit. A classical bit is an information carrier that can assume two possible values 0 and 1. A quantum bit (or qubit) is a quantum system having two levels (quantum states) |0> and |1>, wherein the state space of a quantum bit includes a continuum of quantum states of the form a |0>+b|1> (with a and b complex coefficients). The constituents of the quantum system as described herein serve as quantum information carriers.

As another example, a classical computing system is distinguished from a quantum computing system. A classical computing system can be understood as a computing system that stores and processes information using only classical information carriers, such as classical bits. A classical computing system can include a personal computer or a network of personal computers. A classical computing system may not use quantum information carriers for processing information. A quantum computing system uses constituents of a quantum system as quantum information carriers for storing and processing information. Information may be stored in the constituents and may be processed by performing operations on the constituents (e.g. by providing interactions between the constituents, by performing measurements of one or more constituents, and the like). A quantum computing system may be a hybrid system that uses both classical and quantum information carriers. For example, a quantum computing system may include constituents of a quantum system (e.g. qubits) that serve as quantum information carriers, a quantum processing unit (e.g. a system including a laser) for processing the information stored in the constituents, and a classical computing system coupled to the quantum processing unit for instructing the quantum processing unit as to which operations to perform.

As yet another example, a classical Hamiltonian is distinguished from a quantum Hamiltonian. A classical Hamiltonian is a function that describes interactions between classical entities, such as classical spins. A classical spin can be understood as a variable or quantity having as its state space a finite, or at least countable, set. For example, a classical spin can be a variable z that can take two possible states, such as +1 and −1. A classical Hamiltonian of a system of classical spins z₁, z₂, . . . can be a function H(z₁, z₂, . . . ) representing interactions in the system of classical spins. A quantum Hamiltonian is an observable (represented mathematically by a Hermitian operator acting on a Hilbert space) that represents quantum interactions between constituents of a quantum system. Examples of classical Hamiltonians and quantum Hamiltonians are provided below.

### Logic Gate Circuits

A logic gate is an elementary component of a logic gate circuit. Examples of logic gates are the AND, OR, NOT, NAND, FA and AND.FA gates, and the like. A logic gate has logical variables including one or more input variables and one or more output variables. A logical variable may be a variable which can take two possible values, such as 0 or 1 (or, equivalently, 1 and −1, and the like) i.e. a binary variable.

The truth table of a logic gate is a table, matrix, list, sequence, set or the like, that enumerates all possible configurations of the values of the input variable(s) of the logic gate and that provides, for each such configuration, the corresponding value(s) of the output variable(s) of the logic gate. A truth table of a logic gate may have rows. If the logic gate has k input variables and m output variables (where k and m can be any non-zero natural number, including the case where k and/or m is equal to 1), a row of the truth table can be understood as a sequence of the form a₁ . . . aₖ b₁ . . . bₘ, with a₁, . . . aₖ being a possible configuration of the values of the k input variables and b₁, . . . , bₘ the corresponding values of the m output variables under the action of the logic gate in question. If each input variable of the logic gate can take two possible values 0 and 1, the truth table has 2^{k} rows in total. A truth table of a logic gate may have k+m columns. Each of the first k columns may be associated with one of the k input variables. Each of the last m columns may be associated with one of the m output variables.

For example, an AND gate is a logic gate that has two input variables u and v and one output variable s, wherein u, v and s can each assume the values 0 or 1, and wherein s=u·v (thus s is equal to 1 if and only if both u and v are equal to 1). The truth table of the AND gate can be given by the table

| | | |
|---|---|---|
| 0 | 0 | 0 |
| 0 | 1 | 0 |
| 1 | 0 | 0 |
| 1 | 1 | 1. |

The first, second and third column of the above truth table correspond to the input variable u, the input variable v and the output variable s, respectively, of the AND gate. Each row of the truth table includes a configuration of the possible values for the input variables u and v in the first two positions of the row, and the associated value of the output variable s in the third position of the row. The truth table of an arbitrary logic gate can be constructed in an analogous manner.

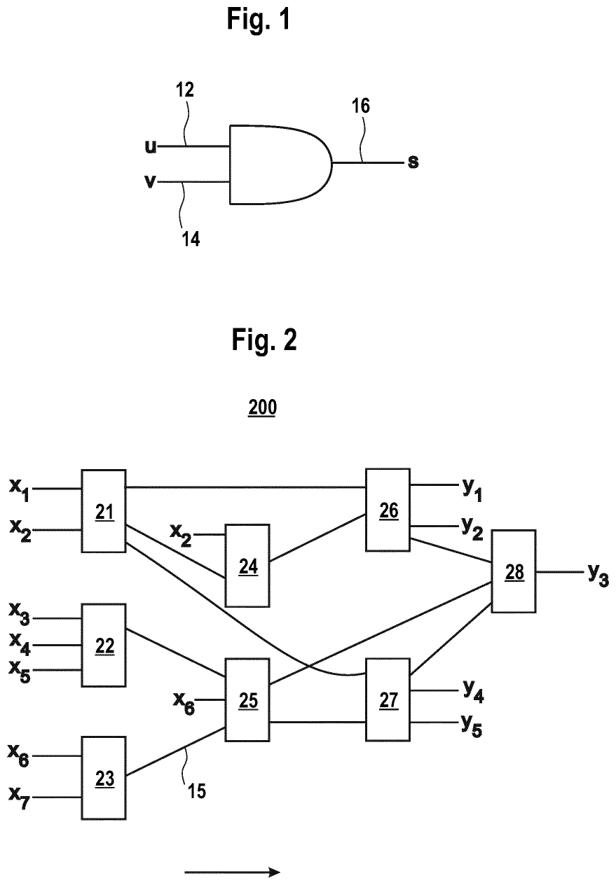

A logic gate can be depicted schematically by a box or other shape having legs, one leg for each logical variable of the logic gate. For example, a schematic representation of the AND gate as a shape having three legs is shown in FIG. 1. FIG. 1 shows an AND gate with a first leg 12 representing the input variable u, a second leg 14 representing the input variable v and a third leg 16 representing the output variable s of the AND gate.

A logic gate circuit includes a set of logic gates which act on an input x to yield an output y. The input x may be a string of the form x=(x₁, x₂, . . . , x_{K}) where, for example, each component xᵢ of the input is a bit. Likewise, the output y may be a string of the form y=(y₁, y₂, . . . , y_{M}) where each component yⱼ is a bit. The length K of the input x (number of components xᵢ) may be equal to or different from the length L of the output y (number of components yⱼ). Some of the logic gates of the logic gate circuit may be applied in a concatenated manner, in the sense that an output variable of a logic gate may be used as an input variable of another logic gate (such logic gates are said to be (inter)connected). A logic gate circuit can be represented schematically by a collection of boxes, one for each logic gate of the logic gate circuit, with legs connecting some of the boxes to indicate that the output variables of some gates serve as input variables of other gates.

FIG. 2 shows an example of a logic gate circuit 200 including logic gates 21 through 28. The logic gate circuit maps an input x=(x₁, x₂, x₃, x₄, x₅, x₆, x₇) to an output y=(y₁, y₂, y₃, y₄, y₅), where each x₁ and each yⱼ may be a bit. In the illustrative logic circuit 200 shown in FIG. 2, the computation proceeds from left to right as indicated by the arrow, so that the logic gates 21, 22, and 23 are applied first and the logic gate 28 is applied last. Each logic gate has one or more legs on the left side of the gate, which represent the input variable(s) of the logic gate, and one or more legs on the right side of the logic gate, which represent the output variable(s) of the logic gate. The left-right division of legs as corresponding to input and output variables, respectively, as shown in FIG. 2, is just an example and the disclosure shall not be limited thereto. Some of the legs connect different gates to each other. For example, logic gate 23 and logic gate 25 are connected to each other by leg 15, indicating that the output variable of logic gate 23 serves as input variable of logic gate 25. Some of the logic gates have a common input variable. For example, x₂ is an input variable of logic gate 21 and also of logic gate 24.

A logic gate circuit maps each input x of the logic gate circuit to an output y. The function f given by y=f(x) is the function computed by the logic gate circuit. Given an input x, the corresponding output y=f(x) can be determined by applying the logic gate circuit to the input x. Embodiments described herein are concerned with the converse problem of inverting the logic gate circuit—namely, given an output y that corresponds to an unknown input x, the task is to determine the input x. Inverting a logic gate circuit is considered to be computationally difficult task even for relatively simple logic gate circuits. For example, considering a logic gate circuit that computes a multiplication of two integers (multiplication being a computationally easy task), inverting such a logic gate circuit amounts to the task of prime factorization, which is known to be a difficult problem, as described above. The difficulty of inverting a logic gate circuit relates to the fact that the logic gates of the logic gate circuit can be irreversible gates. A logic gate is irreversible if several inputs of the logic gate are mapped to a same output, so that it is impossible to retrieve the input based on the output alone. For example, the output 0 of an AND gate can correspond to 3 possible configurations of input variables, namely (0, 0), (0, 1) and (1,0). Based on the output 0 alone, it is not possible to determine whether the input was (0, 0), (0, 1) and (1,0).

Embodiments described herein relate to a quantum computational method of inverting a logic gate circuit. Some embodiments described herein relate to a quantum computational method of performing prime factorization of an integer—namely, by considering a logic gate circuit that is configured for computing a multiplication function (multiplication circuit).

The quantum computational method described herein includes providing an output y of the logic gate circuit that corresponds to an unknown input x of the logic gate circuit. The task undertaken by the method is to determine the unknown input x from the output y. For example, the output can be an integer n that is a multiplication of two unknown primes p and q, i.e. n=p·q, and the aim is the compute at least one of the unknown prime factors. That the output y is “provided” can be understood in the sense that the output is made available to a user or apparatus, so that the subsequent operations of the quantum computational method can be performed. Providing the output may include, for example, retrieving the output from a memory where the output may have been stored, receiving the output, e.g. if the output is communicated to the user or apparatus from a different location, or determining the output, e.g. by performing certain pre-processing operations to determine what the output shall be.

### Gate-Encoding Hamiltonians H_{G}

The logic gate circuit that is to be inverted includes logic gates. According to embodiments, for each logic gate G of the logic gates, a gate-encoding Hamiltonian H_{G} is determined from the logic gate. The notion of a gate-encoding Hamiltonian involves several aspects, discussed in the following.

A gate-encoding Hamiltonian can be a quantum Hamiltonian or a classical Hamiltonian. A gate-encoding Hamiltonian can be a quantum Hamiltonian representing interactions that may occur in a quantum system, for example a quantum system including a number of qubits. Alternatively, a gate-encoding Hamiltonian can be a classical Hamiltonian representing interactions that may occur in a classical system including a number of classical spins.

Further, a gate-encoding Hamiltonian (irrespective of whether it is a quantum Hamiltonian or a classical Hamiltonian) encodes an input-output relation of a logic gate. The case according to which a gate-encoding Hamiltonian is a quantum Hamiltonian will be described next; classical gate-encoding Hamiltonians will be described later.

If a logic gate G has k input variables and m output variables (where k and m can be any non-zero natural number, including the case where k and/or m is equal to 1), the corresponding gate-encoding Hamiltonian H_{G} may be a quantum Hamiltonian of k+m qubits having a ground space which encodes the truth table of the logic gate. The ground space may have a basis consisting of all 2^{k} quantum states (basis states) of the form |a₁, . . . , aₖ, b₁, . . . , bₘ>. Each such quantum state is a state of k+m qubits. Therein, a₁, . . . aₖ range over all possible configurations of the values of the k input variables (where, for example, each value may be 0 or 1, so that there are 2^{k} configurations in total) and b₁, . . . , bₘ are the corresponding values of the m output variables under the action of the logic gate G. In other words, each quantum state |a₁, . . . , aₖ, b₁, . . . , bₘ> may correspond to a row of the truth table of the logic gate G.

Thus, a gate-encoding Hamiltonian H_{G} for a logic gate G having k input variables and m output variables may be a quantum Hamiltonian representing quantum interactions in a system of k+m qubits. For short, it is said that k+m is “the number of qubits of the gate-encoding Hamiltonian” or that the gate-encoding Hamiltonian is “a Hamiltonian of k+m qubits”. As described above, the first k qubits each correspond to an input variable of G and the last m qubits each correspond to an output variable of G.

The ground space of a gate-encoding Hamiltonian H_{G} provides a reversible encoding of the action of the logic gate G, even when the logic gates as such may be irreversible gates. A reversible encoding can be understood as an encoding which “remembers” which values of the input variables of G are mapped to which values of the output variables. Accordingly, the ground space of H_{G} contains information that allows to determine, for any given configuration of values of the output variables of G (output configuration), which configuration or configurations of values of the input variables is mapped to said output configuration under the action of the logic gate G. In other words, the information contained in the ground space of H_{G} allows the logic gate G to be inverted.

For example, a gate-encoding Hamiltonian for the AND gate may be a quantum Hamiltonian of 3 qubits having a ground space that has a basis consisting of the four quantum states

$$\vert 000 〉 , \vert 010 〉 , \vert 100 〉 and \vert 111 〉 ,$$

wherein each of the above quantum states corresponds to one row of the above-shown truth table of the AND gate. Denoting the input variables of the AND gate by u and v and the output variable by s, the first two qubits of each of the above four quantum states correspond to the input variables u and v and the third qubit corresponds to the output variable s.

A gate-encoding Hamiltonian H_{G} may be constructed by considering the truth table of the logic gate G and subsequently determining a quantum Hamiltonian having a ground space that corresponds to the truth table in the sense described above, i.e. a ground space with basis states |a₁, . . . , aₖ, b₁, . . . , bₘ>. Given such a ground space that encodes a truth table, the corresponding gate-encoding Hamiltonian may not be not unique, since there may be several Hamiltonians all having the same ground space. Possible forms for the gate-encoding Hamiltonians are described in the following.

A gate-encoding Hamiltonian H_{G} associated with a logic gate G may be a sum of summand Hamiltonians H₁, H₂ . . . , in other words H_{G}=H₁+H₂+ . . . . According to some embodiments, a gate-encoding Hamiltonian may be a quantum Hamiltonian H_{G}^{q}(where the superscript q indicates that this is a quantum Hamiltonian) having the form

$${H}_{G}^{q} = {\sum }_{i} {c}_{i} {Z}_{i} + {\sum }_{i , j} {c}_{ij} {Z}_{i} {Z}_{j} + {\sum }_{i , j , k} {c}_{ijk} {Z}_{i} {Z}_{j} {Z}_{k} + …$$

Therein, Zᵢ denotes a Pauli σ_{Z} operator (quantum spin-1/2 observable) acting on the i-th qubit. Products (tensor products) of up to n Pauli σ_{Z} operators may be included in the above expression, wherein n is the number of qubits of the gate-encoding Hamiltonian (where the number n of qubits may, in turn, be equal to the number of logical variables k+m of the logic gate G associated with the gate-encoding Hamiltonian, as described above). Further, cᵢ, cᵢⱼ, cᵢⱼₖ, . . . are non-zero coefficients which may be zero or non-zero. A term of the form cI may be added, with I being the identity operator and c another coefficient, but such term corresponds merely to a global shift of the energy levels and may hence be omitted, as is the case in the expression shown above. The coefficients cᵢ, cᵢⱼ, cᵢⱼₖ that are non-zero are referred to herein as the interaction coefficients of the gate-encoding Hamiltonian H_{G}^{q}. Each term in the above sum where the coefficient in question is nonzero is a summand Hamiltonian of the gate-encoding Hamiltonian H_{G}^{q}. In other words, a gate-encoding Hamiltonian H_{G}^{q} may be a sum of summand Hamiltonians, each summand Hamiltonian being a product of Pauli σ_{Z} operators (or a single Pauli σ_{Z} operator) provided with a respective interaction coefficient.

The above-shown form of a gate-encoding Hamiltonian involving only Pauli σ_{Z} operators and products thereof is an illustrative example and the disclosure shall not be limited thereto. For example, by applying a unitary transformation (change of basis) to some or all of the qubits, the above-shown gate-encoding Hamiltonian H_{G}^{q} can be transformed into a gate-encoding Hamiltonian having a different form, involving for example Pauli σ_{X} and/or σ_{Y} operators (which may be denoted by X and Z, respectively). Such a transformed gate-encoding Hamiltonian encodes the same information as the initial gate-encoding Hamiltonian—namely the input-output relation of a logic gate—and can hence also be used for the purposes of the present method. Further, whereas the above examples refer to Hamiltonians of qubit systems, other quantum systems may be used, e.g. d-level systems where only two of the levels are occupied.

Returning to the illustrative example of the AND gate, a corresponding gate-encoding Hamiltonian is the quantum Hamiltonian

$$\\ {H}_{AND}^{{}_{} q} = - {Z}_{s} - {Z}_{u} {Z}_{s} - {Z}_{v} {Z}_{s} + {Z}_{u} {Z}_{v} {Z}_{s} ,$$

which is a quantum Hamiltonian (again indicated by the superscript q) of three qubits. Therein, Zᵤ, Zᵥ, and Zₛ are Pauli σ_{Z} operators acting on the respective qubits that are associated with the logical variables u, v and s of the AND gate. The Hamiltonian H_{AND}^{q} has four summand Hamiltonians, namely −Zₛ, −Zᵤ Zₛ, −Zᵥ, Zₛ, and Zᵤ Zᵥ Zₛ where −1, −1, −1 and 1 are the respective interaction coefficients. The ground space of H_{AND} has an orthonormal basis consisting of the four 3-qubit quantum states |0 0 0>, |0 1 0>, |0 0> and |1 1 1> corresponding to the rows of the truth table of the AND gate as described above, wherein the first qubit is associated with the input variable u, the second qubit is associated with the input variable v and the third qubit is associated with the output variable s.

As describe above, a gate-encoding Hamiltonian may be a quantum Hamiltonian or a classical Hamiltonian. The case of classical gate-encoding Hamiltonians is described next. In this respect, it is noted that the aforementioned examples of quantum gate-encoding Hamiltonians involve Pauli σ_{z} operators only. Such operators mutually commute (i.e. they are diagonal in a common basis) and can therefore be identified with a corresponding classical Hamiltonian. The classical Hamiltonian in question can be obtained by replacing each Pauli operator Zᵢ by a classical spin zᵢ that can assume two possible states, such as zᵢ Σ{1, −1}. For example, a classical gate-encoding Hamiltonian H_{AND}^{c} corresponding to the quantum Hamiltonian H_{AND}^{q} is given by

$$\\ {H}_{AND}^{{}_{} c} = - {z}_{s} - {z}_{u} {z}_{s} - {z}_{v} {z}_{s} + {z}_{u} {z}_{v} {z}_{s} ,$$

which is a classical Hamiltonian (indicated by the superscript c) of three classical spins. Therein, zᵤ, zᵥ and zₛ are classical spins associated with the logical variables u, v and s of the AND gate, with zᵤ, zᵥ, zₛ ∈{1, −1}. The Hamiltonian H_{AND}^{c} has four summand Hamiltonians, namely −zₛ, −zᵤ zₛ, −zᵥ zₛ, and zᵤ zᵥ zₛ where −1, −1, −1 and 1 are the respective interaction coefficients, as in the quantum case. The ground space of H_{AND}^{c} consists of the four spin configurations (1, 1, 1), (1, −1, 1), (−1, 1, 1) and (−1, −1, −1), wherein the first classical spin in each configuration is associated with the input variable u, the second classical spin is associated with the input variable v and the third classical spin is associated with the output variable s. A classical spin z∈{1, −1} can be identified with a corresponding bit b_{z} ∈{0, 1} by way of the correspondence b_{z}=0 if z=1 and b_{z}=1 if z=−1. Accordingly, the four spin configurations (1, 1, 1), (1, −1, 1), (−1, 1, 1) and (−1, −1, −1) forming the ground space of H_{AND}^{c} correspond to bit configurations (0, 0, 0), (0, 1, 0), (1, 0, 0) and (1, 1, 1), respectively. The latter are the rows in the above-shown truth table of the AND gate. Thus, each of the four spin configurations in the ground space of H_{AND}^{c} corresponds to a row in the truth table of the AND gate, just like in the quantum case.

More generally, in analogy with the quantum case, a classical gate-encoding Hamiltonian He for a logic gate G having k input variables and m output variables may be a classical Hamiltonian representing interactions in a system of k+m classical spins—it is said that k+m is “the number of classical spins of the gate-encoding Hamiltonian” or that the gate-encoding Hamiltonian is “a Hamiltonian of k+m classical spins”. A classical gate-encoding Hamiltonian can have the form

$$\\ {H}_{G}^{{}_{} c} = {\sum }_{i} {c}_{i} {z}_{i} + {\sum }_{i , j} {c}_{ij} {z}_{i} {z}_{j} + {\sum }_{i , j , k} {c}_{ijk} {z}_{i} {z}_{j} {z}_{k} + …$$

in analogy with the above-described quantum Hamiltonian H_{AND}^{q}, but where each Pauli operator Zᵢ is replaced by a classical spin zᵢ∈{1, −1}. Products of up to n classical spins may be included in the above expression, wherein n=k+m is the number of classical spins of the gate-encoding Hamiltonian H°. Further, cᵢ, cᵢⱼ, cᵢⱼₖ, . . . are coefficients which may be zero or non-zero, and the coefficients cᵢ, cᵢⱼ, cᵢⱼₖ that are non-zero are referred to herein as the interaction coefficients of the gate-encoding Hamiltonian H_{G}^{c}, as in the quantum case. Each term in the above sum where the coefficient in question is nonzero is a summand Hamiltonian of the gate-encoding Hamiltonian H_{G}^{c}. In other words, a classical gate-encoding Hamiltonian H_{G}^{c} may be a sum of summand Hamiltonians, each summand Hamiltonian being a product of classical spins (or a single classical spin) provided with a respective interaction coefficient.

In the present disclosure the following notation will be used. A gate-encoding Hamiltonian H may be denoted by an expression of the form

$$\\ {H}_{G} = {\sum }_{i} {c}_{i} {σ}_{i} + {\sum }_{i , j} {c}_{ij} {σ}_{i} {σ}_{j} + {\sum }_{i , j , k} {c}_{ijk} {σ}_{i} {σ}_{j} {σ}_{k} + …$$

Therein, σᵢ, σⱼ, σₖ, . . . are spin observables which may represent either Pauli operators Zᵢ, Zⱼ, Zₖ, . . . acting on respective qubits i, j, k, . . . or classical spins zᵢ, zⱼ, zₖ, . . . , respectively. In other words, the above expression encompasses both a classical gate-encoding Hamiltonian H_{G}^{c} and a quantum gate-encoding Hamiltonian H_{G}^{q} as described above, depending on how the σᵢ, σⱼ, σₖ, are understood. For example, returning to the illustrative example of the AND gate, the expression

$$\\ {H}_{AND} = - {σ}_{s} - {σ}_{u} {σ}_{s} - {σ}_{v} {σ}_{s} + {σ}_{u} {σ}_{v} {σ}_{s}$$

for the corresponding gate-encoding Hamiltonian can be understood as the quantum Hamiltonian H_{AND}^{q} when setting the spin observables σᵤ, σᵥ and σₛ to be Pauli operators Zᵤ, Zᵥ and Zₛ, respectively, or as the classical Hamiltonian H_{AND}^{c} when setting σᵤ, σᵥ and as to be classical spins zᵤ, zᵥ and zₛ, respectively.

According to embodiments described herein, the gate-encoding Hamiltonians (irrespective of whether they are classical or quantum Hamiltonians) are determined from the respective logic gates of the logic gate circuit. The act of determining a gate-encoding Hamiltonian can be understood as a classical procedure that is undertaken, for example, by a classical computing system as described herein. Determining a gate-encoding Hamiltonian can be understood as determining a description (i.e. a classical description) of the gate-encoding Hamiltonian. Determining the gate-encoding Hamiltonian can be understood as determining classical information that allows identifying the gate-encoding Hamiltonian, and in particular each of the summand Hamiltonians of the gate-encoding Hamiltonian. For example, determining the gate-encoding Hamiltonian can include: determining a mathematical formula for the gate-encoding Hamiltonian; determining a mathematical formula for each of the summand Hamiltonians individually; determining which Pauli operators (in the quantum case) or which classical spins (in the classical case) are included in the gate-encoding Hamiltonian and/or in each summand Hamiltonian; determining on which qubits (in the quantum case) or which classical spins (in the classical case) each of the summand Hamiltonians is configured to act; determining the interaction coefficient of each summand Hamiltonian; and the like. The term “determining” can be understood as “calculating” (e.g. by a classical computing system) but also as “reading” (e.g. reading from a memory where a description of the gate-encoding Hamiltonian and/or of each summand Hamiltonians is stored) or “receiving” (e.g. receiving a description of the gate-encoding Hamiltonian in case such description has been calculated at a different location and is thereafter communicated for performing the present method).

A further aspect relating to the gate-encoding Hamiltonians regards the question whether the interactions represented by the gate-encoding Hamiltonians are physically implemented. According to some approaches to quantum computation, the gate-encoding Hamiltonians can be quantum Hamiltonians, and these quantum Hamiltonians may be physically implemented as part of a quantum computational method for inverting a logic gate circuit. That is, a quantum system (e.g. a system of qubits) can be provided, and the quantum interactions represented by the quantum gate-encoding Hamiltonians can be physically realized within the quantum system to encode the logic gate circuit into the quantum system. However, such approaches which physically implement the gate-encoding Hamiltonians have the disadvantage that they may involve long-range interactions between the qubits. Long-range interactions will typically arise, for example, in cases where a logic gate has input variables that are far apart from each other in the logic gate circuit. Realizing such long-range interactions in practice may be difficult, if not unfeasible.

According to embodiments described herein, the gate-encoding Hamiltonians H_{G} (irrespective of whether they are classical Hamiltonians or quantum Hamiltonians) need not be physically implemented in an actual physical system. That is, neither the qubits (in the quantum case) or classical spins (in the classical case) of a gate-encoding Hamiltonian, nor the interactions represented by the gate-encoding Hamiltonian need to be physically realized. The gate-encoding Hamiltonians H_{G} are determined as an intermediate classical operation. The classical description of each gate-encoding Hamiltonian H_{G} is used to determine a short-range quantum Hamiltonian H_{G}^{SR}, and it is the latter Hamiltonian H_{G}^{SR} that will be implemented physically as a part of the quantum computational method for inverting the logic gate circuit. The short-range quantum Hamiltonian H_{G}^{SR} represents short-range quantum interactions between constituents of a quantum system. These short-range quantum interactions are different from the interactions represented by the corresponding gate-encoding Hamiltonian H_{G}. In fact, also the quantum system as such may be completely different from the system to which the gate-encoding Hamiltonian relates, as will become apparent below. After the short-range quantum Hamiltonian H_{G}^{SR} has been determined, the corresponding short-range quantum interactions are physically implemented in the quantum system as a part of the quantum computational method described herein.

### Local Subsystems

According to embodiments described herein, a quantum system including constituents is provided. The quantum system may include local subsystems that may each consist of a subset of the constituents of the quantum system. The local subsystems can be mutually disjoint from each other (each constituent of the quantum system may belong to at most one local subsystem).

A local subsystem can be a small subsystem of the quantum system. The number of constituents in a local subsystem may be 30% or less of the total number of constituents of the quantum system, in particular 20% or less, more particularly 10% or less. A local subsystem may include 20 constituents or less, more particularly 10 constituents or less.

A local subsystem can be a subset of constituents, wherein the distance between any two constituents in the subset is not greater than a locality diameter D_{local} of the quantum system The locality diameter D_{local} may be much smaller than a maximal constituent distance between constituents in the particular arrangement of the constituents of the quantum system. The locality diameter D_{local} may be a constant distance. For example, the locality diameter D_{local} may be 30% or below of the maximal constituent distance, in particular 20% or below, more particularly 10% or below. If the constituents are arranged in a lattice having an elementary distance (lattice constant), the locality diameter D_{local} may be r times the elementary distance of the lattice. Therein, r may be from 1 to 5, e.g. r=√2, 2, 3, 4 or 5. The locality diameter D_{local} can depend on the spatial arrangement of the constituents (e.g. whether the constituents are arranged according to a two-dimensional or a three-dimensional lattice, whether the lattice is a square, triangular or hexagonal lattice or another geometrical structure that is not even a lattice, and so on). Additionally or alternatively, the locality diameter D_{local} may be a function of the maximum range of the available physical interactions between the constituents. In other words, depending on the type of available interactions, it may be possible to physically couple constituents that are at most a given distance apart from each other. The locality diameter D_{local} may be a function of the latter distance.

For example, if a quantum system is formed by constituents that are arranged according to a two-dimensional square lattice, a subset of four constituents that form a plaquette (elementary square) of the lattice can be considered a local subsystem of the quantum system. Likewise, if the constituents are arranged according to a three-dimensional square lattice, a subsystem consisting of an elementary cube of the lattice (having eight constituents) can be understood as a local subsystem of the quantum system in question. These examples are merely illustrations and the disclosure shall not be limited thereto. For example, in the case of a two-dimensional square lattice, a subsystem consisting of two neighboring plaquettes, or one plaquette plus one extra constituent that is adjacent to the plaquette, and the like, may just as well be local subsystems, depending on the specific locality diameter D_{local} for the quantum system in question.

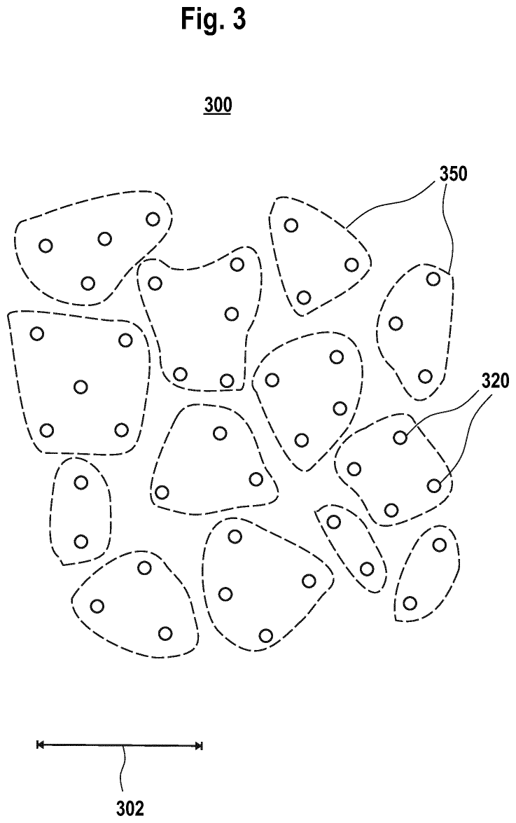

FIG. 3 shows a quantum system 300 having local subsystems 350. Each local subsystem 350 includes constituents 320 of the quantum system 300. The number of constituents in each local subsystem 350 is small as compared to the total number of constituents of the quantum system 300 (in FIG. 3, each local subsystem includes 5 or less constituents). A locality diameter D_{local} is provided, indicated at 302. The maximum distance of constituents in each local subsystem 350 is not greater than the locality diameter D_{local}.

Short-Range Quantum Hamiltonians H_{G}^{SR}

According to embodiments described herein, each gate-encoding Hamiltonian H_{G}(where G is a logic gate of the logic gate circuit) is mapped onto a short-range quantum Hamiltonian H_{G}^{SR} that represents quantum interactions occurring inside a local subsystem S_{G} of the quantum system, wherein the local subsystem S_{G} is associated with the logic gate G. A possible mapping is described in the following.

According to the mapping in question, each summand Hamiltonian Hᵢ of a gate-encoding Hamiltonian H_{G}=Σᵢ Hᵤ is associated with (or assigned to) a respective constituent of the local subsystem S_{G}. In other words, for each summand Hamiltonian Hᵢ of the gate-encoding Hamiltonian H_{G}, a corresponding constituent in the subsystem S_{G} is provided.

For example, with regard to the gate-encoding Hamiltonian H_{AND}=−σₛ−σᵤ σₛ−σᵥ σₛ+σᵤ σᵥ σₛ for the AND gate, as described above, this Hamiltonian has four summand Hamiltonians, and hence the associated local subsystem S_{AND} includes four constituents, one for each summand Hamiltonian. The four constituents may be labelled by (s), (u, s), (v, s) and (u, v, s), respectively, in correspondence with the indices appearing in each summand Hamiltonian. FIG. 4 illustrates the local subsystem S_{AND} associated with the AND gate (see FIG. 1), and the four constituents (s), (u, s), (v, s) and (u, v, s) of S_{AND}, indicated at 401, 402, 403 and 404, respectively. The constituents in question are arranged according to an elementary square (plaquette).

It is thus noted that the number of constituents that are associated with a gate-encoding Hamiltonian H_{G} according to the mapping described above depends on the number of summand Hamiltonians of H_{G}. Said number of summand Hamiltonians may be different from—and in particular larger than—the number of qubits (in the quantum case) or classical spins (in the classical case) of H_{G}. For example, as described above, the gate-encoding Hamiltonian H_{AND} is mapped to a set of four constituents since H_{AND} has four summand Hamiltonians. In contrast, the Hamiltonian H_{AND} itself is a Hamiltonian of three qubits/classical spins.

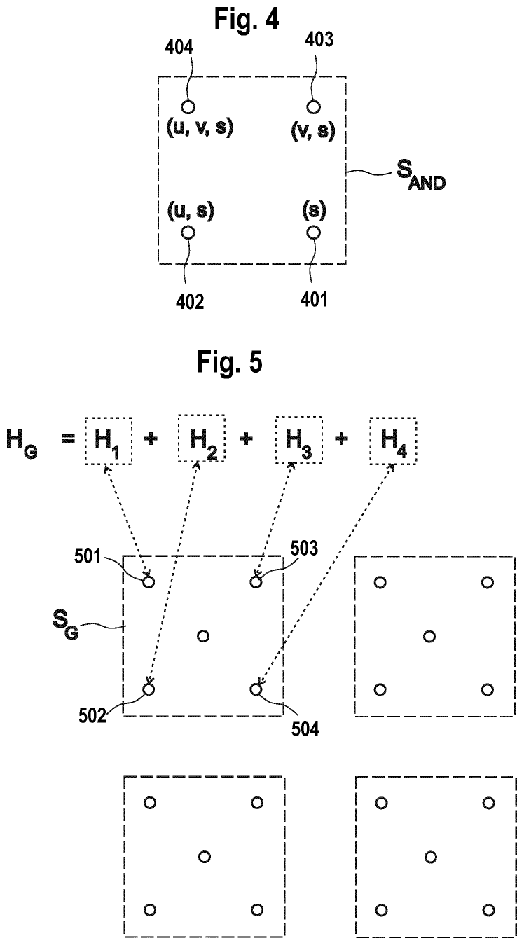

FIG. 5 illustrates the mapping from a gate-encoding Hamiltonian H_{G} to constituents of a local subsystem S_{G}. For the sake of concreteness (but without limiting the scope), the gate-encoding Hamiltonian H_{G} shown in FIG. 5, has four summand Hamiltonians H₁, so that H_{G}=H₁+H₂+H₃+H₄. For example, the gate-encoding Hamiltonian H_{G} can be the Hamiltonian H_{AND} associated with the AND gate. The quantum system includes a local subsystem S_{G} associated with the gate-encoding Hamiltonian H_{G}. The local subsystem S_{G} includes four constituents 501, 502, 503 and 504, each of these four constituents being associated with one of the summand Hamiltonians Hᵢ. The short-range quantum Hamiltonian H_{G}^{SR} (not shown) acts inside the local subsystem S_{G}. The aforementioned four constituents are the primary constituents of the local subsystem S_{G}. As shown, the local subsystem S_{G} may include a further constituent (secondary constituent, located at the center of the subsystem S_{G}) that is not associated with any summand Hamiltonian of H_{G}.

A constituent associated with a summand Hamiltonian Hᵢ of H_{G} may encode the parity of the summand Hamiltonian Hᵢ. If the summand Hamiltonian Hiis a Pauli operator or a (tensor) product of Pauli operators (such as an operator of the form Zᵢ Zⱼ Zₖ . . . that may occur in the gate-encoding Hamiltonian, as described above), a correspondence between the summand Hamiltonian Hᵢ and the associated constituent can be defined, wherein the eigenspace of Hᵢ with eigenvalue +1 is mapped to (the basis state |0> of the constituent and the eigenspace of Hᵢ with eigenvalue −1 is mapped to the basis state |1> of the constituent. According to this correspondence, it is said that the constituent in question encodes the parity of the summand Hamiltonian Hᵢ. By applying this mapping to each summand Hamiltonian, the gate-encoding Hamiltonian H_{G} is associated to a subset of constituents that encode the parities of the respective summand Hamiltonians of H_{G}.

It is noted that the local subsystem S_{G} may include further constituents additional to the above-described constituents associated with the summand Hamiltonians of H_{G}. This will be described later.

The mapping further involves determining the short-range quantum Hamiltonian H_{G}^{SR} from the gate-encoding Hamiltonian H_{G}. The short-range quantum Hamiltonian H_{G}^{SR} represents short-range quantum interactions inside the local subsystem S_{G}. The mapping from H_{G} to H_{G}^{SR} may be configured such that there is a correspondence between the ground spaces of both Hamiltonians. If H_{G} is a quantum Hamiltonian, then the ground spaces of H_{G} and H_{G}^{SR} each have a basis of quantum states, wherein the quantum basis states in the ground space of H_{G} correspond to the quantum basis states in the ground space of H_{G}^{SR}. The correspondence may be a one-to-one correspondence. Likewise, if H_{G} is a classical Hamiltonian, then H_{G}^{SR} has a basis of quantum states which are in correspondence with the ground states (classical spin configurations) of H_{G}. Accordingly, the ground spaces of H_{G} and H_{G}^{SR} both encode the input-output relation of the corresponding logic gate G, albeit using different encodings. The ground space of H_{G} encodes the rows of the truth table of G in a direct manner, as described above, whereas the ground space of H_{G}^{SR} encodes the same truth table in an indirect way, via the encoding of the parities of the summand Hamiltonians into the associated constituents. Still, the information contained in the ground space of the short-range quantum Hamiltonian H_{G}^{SR} allows deriving the ground space of the gate-encoding Hamiltonian H_{G}, and hence the input-output relation of G, by inverting the mapping in question. Thus, if the ground space of H_{G}^{SR} is known (e.g. at the end of the quantum computation), the truth table of G can be determined based thereon.

A possible form of the short-range quantum Hamiltonian H_{G}^{SR} is described in the following. The short-range quantum Hamiltonian H_{G}^{SR} may be a sum of two Hamiltonians, namely a single-body Hamiltonian H_{1-body} and a constraint Hamiltonian H_{cons}, so that H_{G}^{SR}=H_{1-body}+H_{cons}.

A single-body Hamiltonian can be understood as a Hamiltonian being a sum of single-body summand Hamiltonians, wherein each single-body summand Hamiltonian acts on a single constituent of the quantum system. A single-body Hamiltonian may have the from H_{1-body}=A₁+A₂+A₃+ . . . where each single-body summand Hamiltonian Aᵢ acts solely on an αᵢ-th constituent of the quantum system. For example, a Hamiltonian of the form H=a₁ Z₁+a₂ Z₂+a₃ Z₃+ . . . where each aᵢ is a coefficient and each Zᵢ is a Pauli σ_{z} operator acting on the i-th constituent, is a single-body Hamiltonian. A single-body Hamiltonian is a d-body Hamiltonian with d=1.

The function of the single-body Hamiltonian H_{1-body} that forms part of the short-range quantum Hamiltonian H_{G}^{SR} is to encode the information contained in the gate-encoding Hamiltonian H_{G}, and specifically the information contained in the interaction coefficients thereof. The single-body Hamiltonian H_{1-body} may be a sum of single-body summand Hamiltonians, wherein each single-body summand Hamiltonian acts on a constituent of S_{G} that is associated with a respective summand Hamiltonian of H_{G}, and wherein the single-body summand Hamiltonian is a function of the summand Hamiltonian in question. For example, denoting the gate-encoding Hamiltonian H_{G}=Σᵢ Hᵢ as a sum of summand Hamiltonians Hᵢ, the single-body Hamiltonian H_{1-body} may be obtained by replacing each summand Hamiltonian Hᵢ by a term of the form aᵢZᵢ. Therein, aᵢ is a coefficient and Zᵢ is a Pauli σ_{Z} operator acting on the constituent of the local subsystem S_{G} that is associated with the summand Hamiltonian Hᵢ. Accordingly, if H_{G} has the form H_{G}=Σᵢ H₁, then H_{1-body} may have the form H_{1-body}=Σᵢ aᵢ Zᵢ. According to some embodiments, each coefficient aᵢ in H_{1-body} may be equal to, or more generally a function of, an interaction coefficient of the corresponding summand Hamiltonian Hᵢ. It shall be understood that the form H_{1-body}=Σᵢ aᵢ Zᵢ of the single-body Hamiltonian as involving only Pauli σ_{Z} operators is just an example and the disclosure shall not be limited hereto. For example, by applying a change of basis for at least some of the constituents, the single-body Hamiltonian can involve operators other than Pauli σ_{Z} operators, such as X and Y operators, and even other (non-Pauli) operators.

In relation to the example shown in FIG. 5, the gate-encoding Hamiltonian H_{G} is mapped to a short-range quantum Hamiltonian H_{G}^{SR}=H_{1-body}+H_{cons}. The single-body Hamiltonian H_{1-body} has the form H_{1-body}=A₁+A₂+A₃+A₄ where the single-body summand Hamiltonians A₁, A₂, A₃ and A₄ act on the constituents 501, 502, 503 and 504, respectively.

For each ground state of H_{G}, there may be a corresponding ground state in the ground space of the single-body Hamiltonian H_{1-body} by virtue of the mapping described above. Yet, as described above, the number of constituents that are associated with H_{G} depends on the number of summand Hamiltonians of H_{G} and may hence be larger than the number of qubits/classical spins of H_{G}. In other words, the association of a gate-encoding Hamiltonian H_{G} with a set of constituents of the quantum system may involve an increase of the number of degrees of freedom. Further, there may be dependencies between the summand Hamiltonians of H_{G} (for example, as discussed in more detail below, the product of all summand Hamiltonians of H_{G} may be equal to 1, so that one of the summand Hamiltonians may be written as a product of the remaining summand Hamiltonians), which may not be reflected in the ground states of H_{1-body}. Accordingly, the ground space of the single-body Hamiltonian H_{1-body} may include ground states that have no counterpart ground state in the ground space of H_{G}. The function of the constraint Hamiltonian H_{cons} is to remove this inconsistency. The constraint Hamiltonian imposes a further constraint, or several further constraints, to the ground space of H_{1-body}, thereby reducing the dimension of the ground space, and thus ensuring that the mapping is consistent i.e. that there is a correspondence between the ground space of the gate-encoding Hamiltonian H_{G} and the ground space of the short-range Hamiltonian H_{G}^{SR}=H_{1-body}+H_{cons}.

For example, according to some embodiments, the product of all summand Hamiltonians of a gate-encoding Hamiltonian H_{G} may be proportional to the identity. In the case of a quantum gate-encoding Hamiltonian, this means that the product of all summand Hamiltonians is equal to cI where I is the identity operator and c is a coefficient. In the case of a classical gate-encoding Hamiltonian, this means that the product of all summand Hamiltonians is equal to a constant c i.e. a coefficient that is independent of the classical spins zᵢ, zⱼ, . . . of the gate-encoding Hamiltonian. For example, if H_{G} is a classical or quantum Hamiltonian given by an expression of the form

$$\\ {H}_{G} = {\sum }_{i} {c}_{i} {σ}_{i} + {\sum }_{i , j} {c}_{ij} {σ}_{i} {σ}_{j} + {\sum }_{i , j , k} {c}_{ijk} {σ}_{i} {σ}_{j} {σ}_{k} + …$$

as described above, then the product of all summand Hamiltonians of H_{G} is proportional to the identity if, for each index i, j, k, . . . in the above sum, the number of summand Hamiltonians (i.e. the number of nonzero terms in the above sum) in which the index in question appears is even. The property that the product of the gate-encoding Hamiltonians is proportional to the identity can be enforced in the local subsystem S_{G} by adding a constraint Hamiltonian H_{cons} which is a (tensor) product of K Pauli σ_{z} operators the form H_{cons}=−k ZZZ . . . acting on the K constituents associated with the K summand Hamiltonians of H_{G} (where k is a coefficient). The ground space of H_{G}^{SR}=H_{1-body}+H_{cons} thereby only contains quantum states that are consistent with the condition that the product of all summand Hamiltonians of H_{G} are equal to one.

More generally, according to some embodiments, the product of a subset of summand Hamiltonians of a gate-encoding Hamiltonian H_{G} may be proportional to the identity. The subset may consist of some or all of the summand Hamiltonians of H_{G}. This property can be enforced in the local subsystem S_{G} by adding a suitable constraint Hamiltonian H_{cons}, for example a constraint Hamiltonian that is a (tensor) product of Pauli σ_{Z} operators acting on all constituents that are associated with the summand Hamiltonians in the subset in question.

A d-body Hamiltonian, where d is a natural number, may be understood as a Hamiltonian that represents interactions within groups of d or less constituents of the quantum system. A Hamiltonian that is a sum of summand Hamiltonians may be a d-body Hamiltonian when each summand Hamiltonian represents a joint interaction within a group of d or less constituents. A d-body interaction of constituents is an interaction that is representable by a d-body Hamiltonian.

A constraint Hamiltonian may be a d-body Hamiltonian. Therein, d is a natural number, wherein d may be 2, 3, 4, 5, 6, 7, 8, 9, 10, 11 or 12. The number d may be smaller than or equal to 4. The number d may be larger than or equal to 3. The number d may be a constant. A constraint Hamiltonian H_{cons} may be a sum of summand Hamiltonians Bᵢ, in other words H_{cons}=Σᵢ Bᵢ. Each summand Hamiltonian of the constraint Hamiltonian may be a Pauli operator (possibly with a coefficient). Each summand Hamiltonian may involve Z operators acting on at most d constituents. Each summand Hamiltonian may have the form C Z . . . Z, wherein each summand Hamiltonian may act with a constraint strength C on at most d constituents. Alternatively, a constraint Hamiltonian may be a single term e.g. a single Pauli operator, rather than a sum of multiple summand Hamiltonians. For example, with reference to FIG. 5, a constraint Hamiltonian may be a 4-body Hamiltonian of the form H_{cons}=C ZZZZ (a single term) acting on the constituents 501, 502, 503 and 504. It shall be understood that a constraint Hamiltonian need not involve Pauli σ_{Z} operators (denoted herein by Z) only. For example, by applying a unitary transformation (change of basis) to some or all of the constituents, a constraint Hamiltonian having a different form, involving for example Pauli σ_{X} and/or σ_{Y} operators or even other (non-Pauli) operators, can be obtained.

As described herein, the single-body Hamiltonian and the constraint Hamiltonian of a short-range quantum Hamiltonian H_{G}^{SR} may involve Pauli σ_{Z} operators only. The single-body Hamiltonian and the constraint Hamiltonian may be commuting Hamiltonians. All short-range quantum Hamiltonians H_{G}^{SR} associated with a logic gate circuit may pairwise commute with each other.

In the example of the AND gate and the corresponding gate-encoding Hamiltonian

$$\\ {H}_{AND} = - {σ}_{s} - {σ}_{u} {σ}_{s} - {σ}_{v} {σ}_{s} + {σ}_{u} {σ}_{v} {σ}_{s} ,$$

it was described above that the associated local subsystem includes four constituents labelled by (s), (u, s), (v, s) and (u, v, s). These four constituents may be arranged on the vertices of a plaquette of a rectangular lattice. Hence, the constituents can form, or at least belong to, a local subsystem of a quantum system. An associated short-range quantum Hamiltonian H_{AND}^{SR} can have the form

$$\\ {H}_{AND}^{{}_{} SR} = {H}_{1 ‐ body} + {H}_{cons} ,$$

wherein

$$\\ {H}_{1 ‐ body} = - {Z}_{( s )} - {Z}_{( u , s )} - {Z}_{( v , s )} + {Z}_{( u , v , s )} , and$$

$$\\ {H}_{cons} = - {kZ}_{s} {Z}_{( u , s )} {Z}_{( v , s )} {Z}_{( u , v , s )} .$$

Therein, −Z₍ₛ₎−Z_{(u,s)}−Z_{(v,s)}+Z_{(u,v,s)} is a single-body Hamiltonian where Z₍ₛ₎, Z_{(u,s)}, Z_{(v,s)} and Z_{(u,v,s)} are Pauli operators acting on qubit s, (u, s), (v, s) and (u, v, s), respectively. Moreover, the respective coefficients −1, −1, −1 and 1 provided with each of these Pauli operators are the same as the interaction coefficients in the gate-encoding Hamiltonian H_{AND}. Further,−k Z₍ₛ₎ Z_{(u,s)} Z_{(v,s)} Z_{(u,v,s)} is a constraint Hamiltonian (d-body Hamiltonian with d=4 in the present example) involving a product of the four Pauli operators in question, and where k is a positive coefficient. The ground space of the Hamiltonian H_{AND}^{SR} has a basis consisting of four-qubit quantum states, wherein each of the basis states corresponds to a ground state of the gate-encoding Hamiltonian H_{AND}. It is noted that, in the gate-encoding Hamiltonian H_{AND}, each of the indices u, v and s occurs an even number of times, so that the product of the summand Hamiltonians (−σₛ)(−σᵤσₛ)(−σᵥσₛ) (σᵤσᵥσₛ) is proportional to the identity. This is reflected by the presence of the constraint Hamiltonian H_{cons}=−k Zₛ Z_{(u,s)} Z_{(v,s)} Z_{(u,v,s)} which ensures that the ground space of H_{AND}^{SR} is consistent with this condition. Further technical details regarding the mapping from H_{AND} to H_{AND}^{SR} and the correspondence between the two ground spaces are provided below in the section “Further aspects”.

Thus, according to the present method, each logic gate G may be associated with a gate-encoding Hamiltonian H_{G} having a ground space encoding the truth table of the logic gate in question. In turn, each gate-encoding Hamiltonian H_{G} is mapped to a short-range-quantum Hamiltonian H_{G}^{SR}=H_{1-body}+H_{cons} representing short-range quantum interactions between constituents inside the local subsystem S_{G}, so that the information contained in the ground space of H_{G}^{SR} allows determining the ground states of H_{G} and, hence, the input-output relation of the logic gate G. Mapping the gate-encoding Hamiltonian H_{G} to a short-range quantum Hamiltonian H_{G}^{SR} has the advantage that any long-range interactions that may be present in the gate-encoding Hamiltonian H_{G} are removed, since H_{G}^{SR} only involves short-range interactions.

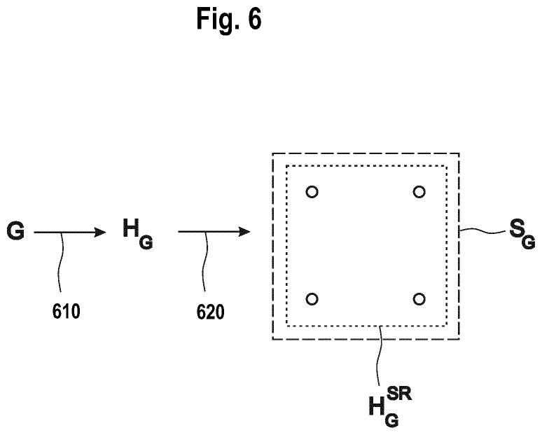

FIG. 6 illustrates the mapping described above. A logic gate G is mapped, 610, to a gate-encoding Hamiltonian H_{G}. The gate-encoding Hamiltonian H_{G} is in turn mapped, 620, to a local subsystem S_{G} of the quantum system. The short-range quantum Hamiltonian H_{G}^{SR}=H_{1-body}+H_{cons} acts inside the local subsystem S_{G} and has a ground space corresponding to the ground space of H_{G}.

### Gate Interconnection Hamiltonians, Common Variable Hamiltonians

As described above, according to embodiments described herein, a plurality of mutually disjoint local subsystems S_{G} are provided, each local subsystem being associated with a logic gate G of the logic gate circuit. The logic gates of a logic gate circuit are not independent of each other. Interconnections may exist between logic gates, and/or it may be the case that different logic gates have common input variables. According to embodiments described herein, such dependencies between the logic gates can be reflected in the quantum system by coupling the corresponding local subsystems to each other.

That a first logic gate G₁ and a second logic gate G₂ are connected to each other (or, stated differently, that an interconnection exists between the two logic gates) can be understood in the sense that an output variable of the first logic gate G₁ is inputted into the second logic gate G₂, so that the output variable of G₁ is also an input variable of G₂. The first logic gate G₁ may be associated with a first local subsystem S_{G}_{₁} and a first short-range quantum Hamiltonian H_{G}_{₁}^{SR}, by virtue of the mapping described above. The ground space of the first short-range quantum Hamiltonian H_{G}_{₁}^{SR} may have a basis consisting of states that (indirectly, as described above) encode the input-output relation of the first logic gate G₁. Likewise, the second logic gate G₂ may be associated with a second local subsystem S_{G}_{₂} and a second short-range quantum Hamiltonian H_{G}_{₂}^{SR}. The ground space of the second short-range quantum Hamiltonian H_{G}_{₂}^{SR} may have a basis that (again, indirectly) encodes the truth table of the second logic gate G₂. A priori, the respective ground spaces of H_{G}_{₁}^{SR} and H_{G}_{₂}^{SR} are independent of each other. That an output variable of G₁ is also an input variable of G₂ can be viewed as a side condition, or constraint, that is imposed on the logical variables of the two logic gates in question (namely a constraint of the form aᵢ=bⱼ where aᵢ is said input variable of G₁ and bⱼ is said output variable of G₂). This side condition can be enforced correspondingly in the quantum system, by introducing a gate interconnection Hamiltonian H₁₂^{conn} that couples the first local subsystem S_{G}_{₁} to the second local subsystem S_{G}_{₂}. The gate interconnection Hamiltonian H₁₂^{conn} is a quantum Hamiltonian that represents a quantum interaction (called herein gate interconnection interaction) between these two local subsystems. More specifically, the gate interconnection Hamiltonian may couple the two local subsystems in a manner such that the ground space of the Hamiltonian H_{G}_{₁}^{SR}+H_{G}_{₂}^{SR}+H₁₂^{conn} only includes basis states that obey this side condition. Each basis state of the Hamiltonian H_{G}_{₁}^{SR}+H_{G}_{₂}^{SR}+H₁₂^{conn} may correspond (by inverting the mapping from the gate-encoding Hamiltonians H_{G}_{₁} and H_{G}_{₁} to the short-range quantum Hamiltonians H_{G}_{₁}^{SR}+H_{G}_{₂}^{SR}) to a “valid” configuration of the logical variables of the two logic gates, i.e. a configuration wherein the aforementioned output variable of the first logic gate G₁ is also an input variable of the second logic gate G₂. The gate interconnection Hamiltonian thus energetically favors (i.e. assigns a low energy to) quantum states that correspond to valid configurations of the logical variables. Further examples and technical details regarding the construction of gate interconnection Hamiltonians are provided below in the section “Further aspects”.

Additionally or alternatively, two logic gates may have a common input variable. That is to say, a same logical variable may be an input variable of a first logic gate G₁ and a second logic gate G₂. Similar to what was described above for gate interconnections, that two logic gates have a common input variable can be viewed as a side condition that can be enforced in the quantum system by a corresponding Hamiltonian, referred to herein as a common variable Hamiltonian H₁₂^{com-var}. A common variable Hamiltonian is a quantum Hamiltonian that may couple the first and second local subsystem in a manner such that the ground space of the Hamiltonian H_{G}_{₁}^{SR}+H_{G}_{₂}^{SR}+H₁₂^{com-var} only includes basis states that obey this side condition. Each basis state of the Hamiltonian H_{G}_{₁}^{SR}+H_{G}_{₂}^{SR}+H₁₂^{com-var} may correspond (by inverting the mapping from the gate-encoding Hamiltonians to the first/second short-range quantum Hamiltonians) to a “valid” configuration of the logical variables of the two logic gates, i.e. a configuration wherein the input variable in question is a common input variable of the first logic gate G₁ and the second logic gate G₂. Further examples and technical details regarding the construction of common variable Hamiltonians are provided below in the section “Further aspects”.

In case two gates are connected to each other and also have a common input variable, a combination of a gate interconnection Hamiltonian and a common variable Hamiltonian can be provided, such as a Hamiltonian of the form H_{G}_{₁}^{SR}+H_{G}_{₂}^{SR}+H₁₂^{conn}+H₁₂^{com-var}.

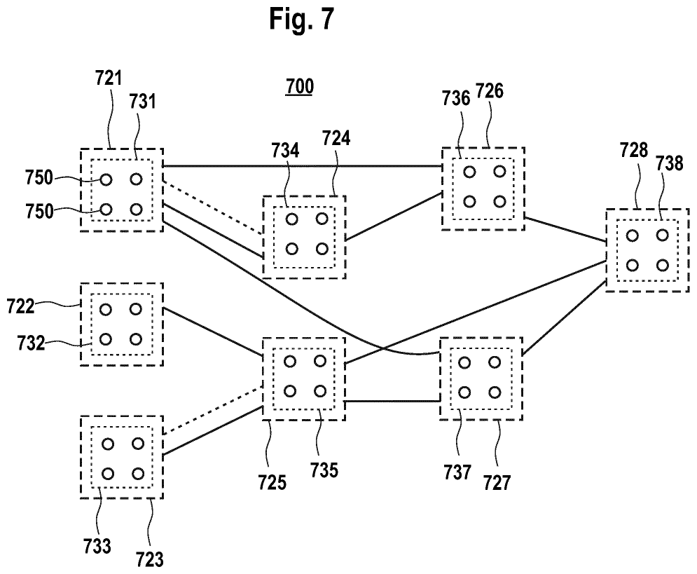

FIG. 7 shows a quantum system 700 that is associated with the logic gate circuit 200 shown in FIG. 2. The quantum system includes constituents 750 indicated by the circles (for ease of presentation, only two constituents are explicitly referenced by reference numeral 750, but it shall be understood that each circle in FIG. 7 represents a constituent of the quantum system). The quantum system includes local subsystems 721 through 728 that are associated with the logic gates 21 through 28, respectively, of the logic gate circuit 200 shown in FIG. 2. Each local subsystem includes a set of constituents. (For the sake of concreteness, each local subsystem is shown to include four constituents, but the disclosure is not limited thereto). A respective short-range quantum Hamiltonian H_{G}^{SR} acts on each local subsystem, as indicated by the boxes 731 through 738. Some of the local subsystems are connected by solid lines, representing gate interconnection Hamiltonians that couple the local subsystems in question. For example, a gate interconnection Hamiltonian couples local subsystem 721 with local subsystem 724, indicated by a solid line connecting these two subsystems, since the logic gate circuit 200 in FIG. 2 includes a connection between the logic gates 21 and 24. Some of the local subsystems are connected by dashed lines, representing common variable Hamiltonians that couple the local subsystems in question. For example, a common variable Hamiltonian couples local subsystem 723 with local subsystem 725, indicated by a dashed line connecting these two subsystems, since the logic gates 23 and 25 shown in FIG. 2 have a common input variable (namely the variable x₆).

In the following, the term “gate coupling Hamiltonian” shall be used to refer to either a gate interconnection Hamiltonian or a common variable Hamiltonian.

As described above, a local subsystem S_{G} can include constituents that are associated with summand Hamiltonians Hᵢ of a gate-encoding Hamiltonian H_{G}. Such constituents are herein called primary constituents of the local subsystem S_{G}. In addition to the primary constituents, a local subsystem can include one or more secondary constituents. A secondary constituent of a local subsystem may not be associated with a summand Hamiltonian of a gate-encoding Hamiltonian, but may be “extra” constituent of the local subsystem. As regards a gate coupling Hamiltonian that couples a first local subsystem S_{G}_{₁} associated with a first logic gate G₁ to a second local subsystem S_{G}_{₂} associated with a second logic gate G₂ (irrespective of whether the gate coupling Hamiltonian is a gate interconnection Hamiltonian or a common variable Hamiltonian), the gate coupling Hamiltonian can act jointly on one or more constituents of the first local subsystem and one or more constituents of the second local subsystem. The one or more constituents of the first local subsystem can include one or more primary constituents and/or one or more secondary constituents of the first local subsystem. The one or more constituents of the second local subsystem can include one or more primary constituents and/or one or more secondary constituents of the second local subsystem.

A gate coupling Hamiltonian may be a k-body Hamiltonian. Therein, k is a natural number, wherein k may be 2, 3, 4, 5, 6, 7, 8, 9, 10, 11 or 12. The number k may be smaller than or equal to 4. The number k may be larger than or equal to 3. The number k may be a constant.

A gate coupling Hamiltonian may be a sum of summand Hamiltonians. Each summand Hamiltonian of the gate coupling Hamiltonian may be a Pauli operator (possibly with a coefficient). Each summand Hamiltonian may involve Z operators acting on at most k constituents. Each summand Hamiltonian may have the form K Z . . . Z, wherein each summand Hamiltonian may act with a coupling strength K on at most k constituents. Alternatively, a gate coupling Hamiltonian may be a single term e.g. a single Pauli operator, rather than a sum of multiple summand Hamiltonians. It shall be understood that a gate coupling Hamiltonian need not involve Pauli σ_{Z} operators only. For example, by applying a unitary transformation (change of basis) to some or all of the constituents, a gate coupling Hamiltonian having a different form, involving for example Pauli σ_{X} and/or σ_{V} operators or even other (non-Pauli) operators, can be obtained.

### Output-Encoding Hamiltonian, Total Hamiltonian, Inverting the Logic Gate Circuit

Given a logic gate circuit having logic gates (e.g. a multiplication circuit), a first Hamiltonian Hᵢ may be considered which is the sum of all short-range quantum Hamiltonians H_{G}^{SR} (i.e. ranging over all logic gates G of the logic gate circuit) and all gate coupling Hamiltonians (i.e. all gate interconnection Hamiltonians and all common variable Hamiltonians). The first Hamiltonian H₁ is a quantum Hamiltonian that may act on the primary and secondary constituents of the quantum system. The first Hamiltonian H₁ has a ground space having basis states that encode valid input-output configurations of the logic gate circuit, i.e. configurations of the logical variables that are in accordance with the respective action of each logic gate and that obey the side conditions arising from the gate interconnections and the common variables (if any).

As described above, the aim of the method described herein is to invert the logic gate circuit. That is, given an output y of the logic gate circuit, the task is to determine an input x corresponding to the output y. That the output of the logic gate circuit is equal to y can be regarded as another side condition that is imposed on the logic gate circuit. As in the case of the gate coupling Hamiltonians, this side condition can also be enforced in the quantum system by introducing a second quantum Hamiltonian H₂, called herein output-encoding Hamiltonian, which is added to the first Hamiltonian H₁ and which energetically favors only the basis state (or basis states, if there are several) that correspond(s) to the output y in question. The output-encoding Hamiltonian may involve one or more primary constituents and/or one or more secondary constituents.

An output-encoding Hamiltonian may be an r-body Hamiltonian. Therein, r is a natural number, wherein r may be 2, 3, 4, 5, 6, 7, 8, 9, 10, 11 or 12. The number r may be smaller than or equal to 4. The number r may be larger than or equal to 2. For example, the number r may be equal to 2. The number r may be a constant. An output-encoding Hamiltonian may be a sum of summand Hamiltonians. Each summand Hamiltonian of the output-encoding Hamiltonian may be a Pauli operator (possibly with a coefficient). Each summand Hamiltonian may involve Pauli σ_{Z} operators (denoted herein by Z) acting on at most r constituents. Each summand Hamiltonian may have the form R Z . . . Z, wherein each summand Hamiltonian may act with a coupling strength R on at most r constituents. Alternatively, an output-encoding Hamiltonian may be a single term e.g. a single Pauli operator, rather than a sum of multiple summand Hamiltonians. It shall be understood that an output-encoding Hamiltonian need not involve Pauli σ_{Z} operators only. For example, by applying a unitary transformation (change of basis) to some or all of the constituents, an output-encoding Hamiltonian having a different form, involving for example Pauli σ_{X} and/or σ_{Y} operators or even other (non-Pauli) operators, can be obtained. Further examples and technical details regarding the construction of the output-encoding Hamiltonian are provided below in the section “Further aspects”.

In light of the above, a total Hamiltonian H^{TOTAL} may be considered, which is a quantum Hamiltonian given by the sum of the first Hamiltonian H₁ and the output-encoding Hamiltonian H₂ (second Hamiltonian) Thus,

$$\\ {H}^{{}_{} TOTAL} = {H}_{1} + {H}_{2}$$

where

H₁=Σ(all short-range quantum Hamiltonians H_{G}^{SR})+Σ(all gate coupling Hamiltonians),

where the first sum and the second sum in the above expression for H₁ schematically represent the sum of all short-range quantum Hamiltonians H_{G}^{SR} and the sum over all gate coupling Hamiltonians, respectively, that are associated with the logic gate circuit. By virtue of the output-encoding Hamiltonian H₂, the ground space of H^{TOTAL} has a basis of quantum states that involve only the configuration (or configurations) of the logical variables that correspond to the output y, in other words the configuration(s) that encode the unknown input x. Accordingly, the unknown input x can be determined by evolving the quantum system to a quantum state which is equal to (or close to) a ground state of the total Hamiltonian H^{TOTAL} and subsequently measuring at least a portion of the quantum system.

For example, if the logic gate circuit is such that a single input x corresponds to the output y, the total Hamiltonian H^{TOTAL} may have a single ground state. This ground state encodes, via the mapping from the gate-encoding Hamiltonians to the short-range quantum Hamiltonians H_{G}^{SR}, the unknown input x. That is to say, the ground state contains information which allows to determine the unknown input x. Accordingly, by performing a measurement of at least some of the constituents when the quantum system is in or near the ground state of H^{TOTAL}, and by subsequently inverting the aforementioned mapping, the unknown input x of the logic gate circuit can be determined. Likewise, if the total Hamiltonian H^{TOTAL} has a degenerate ground space (multiple ground states), there may be several inputs x that correspond to the same output y (i.e. the logic gate circuit may compute a many-to-one function). In such case, the same procedure can be applied for determining at least one of the unknown inputs x, again by performing a measurement and subsequently inverting the mapping.

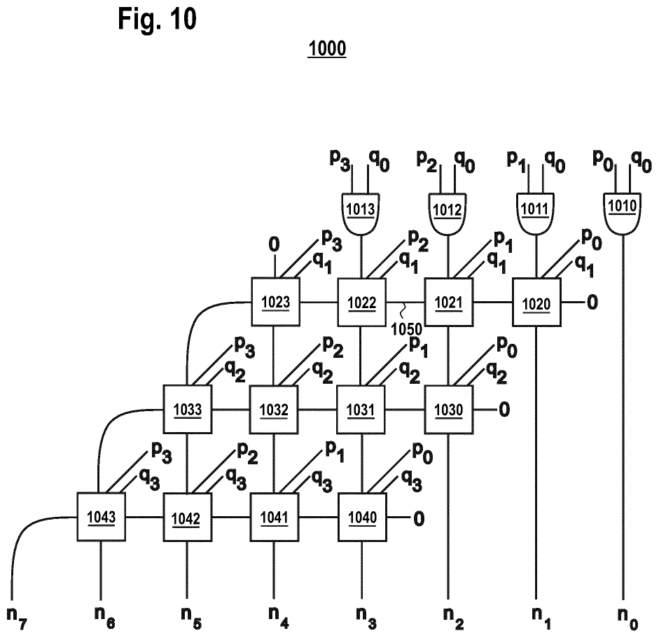

As regards the measurement, all constituents that are associated with a summand Hamiltonian of one of the gate-encoding Hamiltonians H_{G} associated with the logic gate circuit (that is to say, all primary constituents of the quantum system) may be measured, for example in the standard basis {|0>, |1>}. Based on the read-out obtained from these measurements, the mapping described herein can be inverted to determine the unknown input x (e.g. the prime factors of the integer to be factorized). Specifically, the measurement outcomes obtained from measuring the primary constituents of each local subsystem S_{G} can be used to determine, for each logic gate G of the logic gate circuit, a configuration (or several configurations) of the value(s) of the input variable(s) of G that is/are consistent with the fact that the output of the logic gate circuit is y. Doing this in particular for the subset of all logic gates G that act directly on the input of the logic gate circuit (for example, in FIG. 2 these are the logic gates 21, 22, 23, 24 and 25; in FIG. 10, all logic gates act directly on the input of the logic gate circuit) allows to determine an input x that corresponds to the output y, by inverting the mapping for this particular subset of logic gates.

Alternatively, for determining the unknown input x, it may be sufficient to measure only a subset of the primary constituents. For example, it may be sufficient to measure only the primary constituents of the local subsystems S_{G} that correspond to the aforementioned subset of local gates that act directly on the input of the logic gate circuit. Further, even within this subset of local subsystems it may not be necessary to measure all primary constituents. For example, within a same local subsystem S_{G} there may be dependencies between its primary constituents, in the sense that the quantum state of one or more primary constituents in S_{G} is determined by the quantum states of the remaining primary constituents in S_{G}. In such case it may suffice to measure only a subset of the constituents of S_{G}.

According to some embodiments, at least some of the secondary constituents may be measured, for example for performing consistency checks.

As described herein, all Hamiltonians appearing in the total Hamiltonian (i.e. the short-range quantum Hamiltonians H_{G}^{SR}, the gate interconnection Hamiltonians, the common variable Hamiltonians, the output-encoding Hamiltonian) may involve Z operators only. Accordingly, the total Hamiltonian may be a sum consisting of mutually commuting Hamiltonians.

Further, the interactions represented by the total Hamiltonian may have respective magnitudes (represented by the coefficients appearing in the total Hamiltonian) that are upper bounded by a constant independent of the size (number of constituents) of the quantum system. This means that, as larger logic gate circuits are considered, and hence larger quantum systems, the magnitudes of the required interactions (interaction strengths) for realizing the quantum computational method do not increase accordingly but can remain within a small, constant range.

### AND.FA Gates

A logic gate circuit can include one or more AND.FA gates (where “FA” stands for “full adder”). An AND.FA gate has four input variables u, v, s, and c and two output variables s′ and c′, each of which can take the values 0 and 1. The action of the AND.FA gate on its input variables is defined by the relation

$$\\ 2 {c}^{{}_{} ′} + {s}^{{}_{} ′} = s + c + u \cdot v .$$

The above formula uniquely defines the values of the output variables as a function of the input variables (for example, if u=v=s=c=1 then the above expression implies that c′=s′=1).

A possible gate-encoding Hamiltonian for the AND.FA gate is given by

$$\\ {H}_{AND . FA} = - {σ}_{s} {σ}_{c} {σ}_{{s}^{{}_{} ′}} - {σ}_{u} {σ}_{s} {σ}_{c} {σ}_{{s}^{{}_{} ′}} - {σ}_{v} {σ}_{s} {σ}_{c} {σ}_{{s}^{{}_{} ′}} + {σ}_{u} {σ}_{v} {σ}_{s} {σ}_{c} {σ}_{{s}^{{}_{} ′}} - {σ}_{s} {σ}_{c} {σ}_{{s}^{{}_{} ′}} {σ}_{{c}^{{}_{} ′}} - {σ}_{s} {σ}_{{c}^{{}_{} ′}} - {σ}_{c} {σ}_{{c}^{{}_{} ′}} + {σ}_{{s}^{{}_{} ′}} {σ}_{{c}^{{}_{} ′}} ,$$

wherein σᵤ, σᵥ, σₛ, σ_{c}, σₛ′ and σ_{c}′ are spin observables associated with the logical variables u, v, s, c, s′ and c′, respectively. These spin observables may represent Pauli operators Zᵤ, Zᵥ, Zₛ, Z_{c}, Z_{s′} and Z_{c′} acting on respective qubits or classical spins zᵤ, zᵥ, zₛ, z_{c}, z_{s′} and z_{c′}. In other words, in accordance with was described above, H_{AND.FA} may be a classical gate-encoding Hamiltonian or a quantum gate-encoding Hamiltonian. The gate-encoding Hamiltonian H_{AND.FA} has eight summand Hamiltonians. Accordingly, the local subsystem S_{AND.FA} associated with H_{AND.FA} includes eight (primary) constituents. The constituents in question may be labelled by (s, c, s′), (u, s, c, s′), (v, s, c, s′), (u, v, s, c, s′), (s, c, s′, c′), (s, c′), (c, c′), (s′, c′) in correspondence with the indices appearing in the respective summand Hamiltonians. The associated short-range Hamiltonian may have the form H_{AND.FA}^{SR}=G_{AND.FA}^{1-body}+H_{AND.FA}^{cons}, i.e. a sum of a single-body Hamiltonian and a constraint Hamiltonian, wherein

$$\\ {H}_{AND . FA}^{{}_{} 1 ‐ body} = - {Z}_{( s , c , {s}^{{}_{} ′} )} - {Z}_{( u , s , c , {s}^{{}_{} ′} )} - {Z}_{( v , s , c , {s}^{{}_{} ′} )} + {Z}_{( u , v , s , c , {s}^{{}_{} ′} )} - {Z}_{( s , c , {s}^{{}_{} ′} , {c}^{{}_{} ′} )} - {Z}_{( s , {c}^{{}_{} ′} )} - {Z}_{( c , {c}^{{}_{} ′} )} + {Z}_{( {s}^{{}_{} ′} , {c}^{{}_{} ′} )}$$

$$\\ {H}_{AND . FA}^{{}_{} cons} = - {k}_{1} {Z}_{( s , c , {s}^{{}_{} ′} )} {Z}_{( u , s , c , {s}^{{}_{} ′} )} {Z}_{( v , s , c , {s}^{{}_{} ′} )} {Z}_{( u , v , s , c , {s}^{{}_{} ′} )} - {k}_{2} {Z}_{( s , c , {s}^{{}_{} ′} , {c}^{{}_{} ′} )} {Z}_{( s , {c}^{{}_{} ′} )} {Z}_{( c , {c}^{{}_{} ′} )} {Z}_{( {s}^{{}_{} ′} , {c}^{{}_{} ′} )}$$

In the single-body Hamiltonian H_{AND.FA}^{1-body}, each Z operator has a coefficient which is equal to the interaction coefficient of the corresponding summand Hamiltonian of H_{AND.FA}. Thus, there is a direct correspondence between the summand Hamiltonians of H_{AND.FA} and the summand Hamiltonians of H_{AND.FA}^{1-body}. The constraint Hamiltonian H_{AND.FA}^{cons}, in this example a 4-body Hamiltonian, is a sum including two Pauli operators, each being a (tensor) product of four Z operators, and where k₁ and k₂ are positive coefficients.

The ground space of the Hamiltonian H_{AND.FA}^{SR} has a basis consisting of 8-qubit quantum states, wherein each of the basis states corresponds to a ground state of the gate-encoding Hamiltonian H_{AND.FA}. It is noted that, in the gate-encoding Hamiltonian H_{AND.FA}, the product (−σₛσ_{c}σ_{s′})(−σᵤσₛσ_{c}σ_{s′})(−σᵥσₛσ_{c}σ_{s′})(σᵤ σᵥσₛσ_{c}σ_{s′}) of the first four summand Hamiltonians is proportional to the identity (each index appears an even number of times). This is reflected by the presence of the first term −k₁Z_{(s,c,s′)}Z_{(u,s,c,s′)}Z_{(v,s,c,s′)}Z_{(u,v,s,c,s′)} in the constraint Hamiltonian H_{cons} which ensures that the ground space of H_{AND.FA}^{SR} is consistent with this condition. Likewise, in the gate-encoding Hamiltonian H_{AND.FA}, the product of the second set of four summand Hamiltonians (−σₛσ_{c}σ_{s′}σ_{c′})(−σₛσ_{c′})(−σ_{c}σ_{c′})(σ_{s′}σ_{c′}) is proportional to the identity. This is reflected by the presence of the second term −k₂ Z_{(s,c,s′,c′)} Z_{(s,c′)}Z_{(c,c′)} Z_{(s′,c′)} of the constraint Hamiltonian H_{cons} which ensures that the ground space of H_{AND.FA}^{SR} is consistent with this condition as well.

The eight (primary) constituents can be arranged according to the vertices of a cube, wherein (s, c, s′), (u, s, c, s′), (v, s, c, s′) and (u, v, s, c, s′) are located at the four lower vertices of the cube (forming a first plaquette of the cube, called herein a “sum plaquette”) and (s, c, s′, c′), (s, c′), (c, c′) and (s′, c′) are arranged at the four upper vertices of the cube (forming a second plaquette of the cube, called herein a “carry plaquette”). Accordingly, the first term of H_{AND.FA}^{cons} acts on a first plaquette formed by the four lower vertices of the cube, and the second term acts on a second plaquette formed by the four upper vertices. Apart from these eight primary constituents, the local subsystem S_{AND.FA} may include a secondary constituent. The secondary constituent may be acted upon by a gate interconnection Hamiltonian and/or a common variable Hamiltonian, in case the AND.FA gate is connected to and/or shares a common variable with another logic gate of the logic gate circuit. The secondary constituent may be arranged, for example, at the center of the cube made up by the eight primary constituents (body-centered cube).

Further technical details regarding the Hamiltonians H_{AND.FA} and H_{AND.FA}^{SR} and the possible form of associated gate coupling Hamiltonians are provided in the section “Further aspects”.

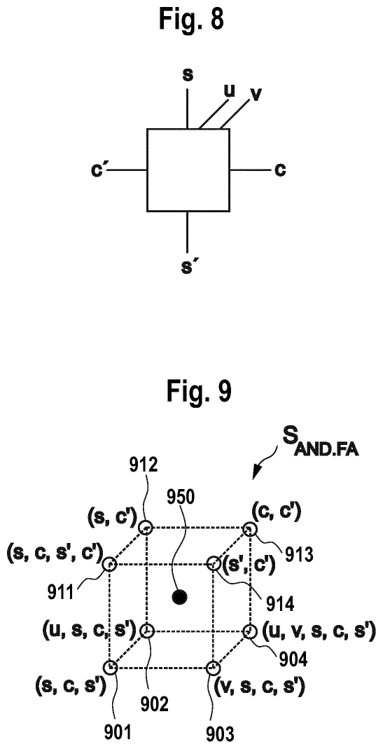

FIG. 8 shows a schematic representation of an AND.FA gate. The input variables u, v, s, c and output variables s′ and s′ each correspond to a respective leg (solid line) of the AND.FA gate.

FIG. 9 shows a local subsystem S_{AND.FA} associated with the AND.FA gate shown in FIG. 8. The local subsystem S_{AND.FA} includes eight primary constituents (s, c, s′), (u, s, c, s′), (v, s, c, s′), (u, v, s, c, s′), (s, c, s′, c′), (s, c′), (c, c′) and (s′, c′) arranged at the corners of a cube. The constituents (s, c, s′), (u, s, c, s′), (v, s, c, s′) and (u, v, s, c, s′), indicated by 901, 902, 903, and 904, respectively, are located at the four lower vertices of the cube forming a first plaquette (“sum plaquette”). The constituents (s, c, s′, c′), (s, c′), (c, c′) and (s′, c′), indicated by 911, 912, 913, and 914, respectively, are arranged at the four upper vertices forming a second plaquette (“carry plaquette”). The local subsystem S_{AND.FA} includes a secondary constituent 950 arranged at the center of the cube.

According to some embodiments, the logic gates of a logic gate circuit as described herein include, and particularly consist of, one or more AND gates and one or more AND.FA gates. Each logic gate of the logic gates may be an AND gate or an AND.FA gate. Such circuits may be of interest, for example, in the context of a quantum computational method for factoring integers, as described in the following.

### Integer Factorization

According to embodiments, a logic gate circuit may compute a multiplication function (multiplication circuit). Particularly, the logic gate circuit may compute the product of two integers p and q. The input x of the circuit may include a binary representation of the two integers p and q, and the output y may include a binary representation of the product n=p·q. The task of inverting the logic gate circuit thus amounts to providing an integer n and determining integers p and q such that n=p·q. If p and q are prime numbers, the number n is said to be a biprime. The task of inverting the logic gate circuit (multiplication circuit) thus includes the problem of determining the prime factors of an integer n. Accordingly, embodiments described herein include a quantum computational method for prime factorization.

According to embodiments, a multiplication circuit may be such that each logic gate is an AND gate or an AND.FA gate. FIG. 10 shows a logic gate circuit 1000 that computes a multiplication function, in other words a multiplication circuit. Each logic gate of the logic gate circuit is either an AND gate or an AND.FA gate. The AND gates are indicated at 1010, 1011, 1012, and 1013. The AND.FA gates are indicated at 1020, 1021, 1022, and 1023 (first row of AND.FA gates), 1030, 1031, 1032, and 1033 (second row of AND.FA gates) and 1040, 1041, 1042, and 1043 (third row of AND.FA gates). The input of the logic gate circuit 1000 is constituted by two integers p and q, which are provided in their binary representation p=p₀2⁰+p₁2¹+p₂2²+ . . . and q=q₀2⁰+q₁2¹+q₂2²+ . . . where pᵢ and qᵢ are bits. In the simple illustrative example shown in FIG. 10, p and q are 4-bit integers but the generalization of the multiplication circuit to arbitrary integers is immediate. The output of the multiplication circuit is an integer n=n₀2⁰+n₁2¹+n₂2²+ . . . , wherein n=p·q. In FIG. 10, the computation proceeds from top to bottom.

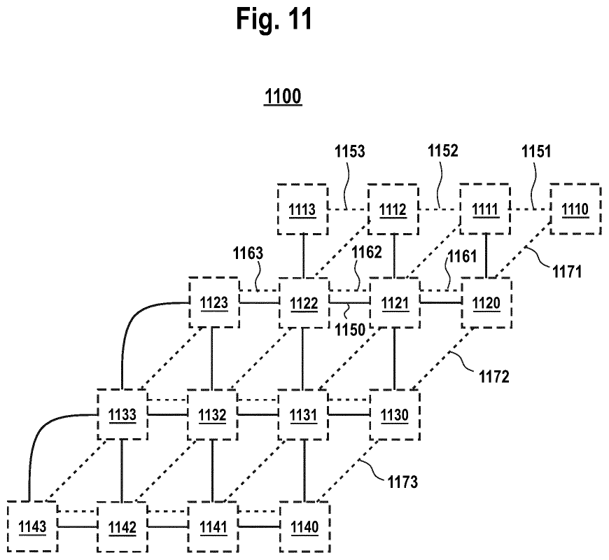

FIG. 11 shows a quantum system 1100 associated with the logic gate circuit 100 of FIG. 10. The quantum system 1100 includes local subsystems 1110, 1111, 1112, and 1113 associated with the AND gates of the multiplication circuit shown in FIG. 10, and local subsystems 1120, 1121, 1122, and 1123; 1130, 1131, 1132, and 1133; and 1140, 1141, 1142, and 1143 associated with the AND.FA gates of the multiplication circuit of FIG. 10. The local subsystems of FIG. 11 may be the local subsystems S_{AND} and S_{AND.FA}, respectively, as described above and may be constructed according to the mappings described herein. Specifically, each of the local subsystems 1110, 1111, 1112, and 1113 that is associated to an AND gate may consist of four constituents arranged according to a plaquette, as shown for example in FIG. 4. Each of the local subsystems 1120, 1121, 1122, 1123, 1130, 1131, 1132, 1133, 1140, 1141, 1142, and 1143 that is associated to an AND.FA gate may consist of eight primary constituents arranged according to a cube and a secondary constituent arranged at the center of the cube, as shown for example in FIG. 9. Accordingly, the quantum system may include two layers of constituents (primary constituents) that are stacked vertically, each layer being a two-dimensional square lattice, with the secondary constituents being arranged in between the two layers. This form of the quantum system is further illustrated in FIG. 14.

For each connection between two logic gates, represented in FIG. 10 by the solid lines between the logic gates, a corresponding gate interconnection Hamiltonian may be provided to couple the corresponding local subsystems, indicated by the corresponding solid lines in FIG. 11. An exemplary connection between logic gates is indicated in FIG. 10 at 1050, and the corresponding gate interconnection Hamiltonian is indicated in FIG. 11 at 1150. Since in the multiplication circuit of FIG. 10 connections only exist between neighboring logic gates (in other words, in the multiplication circuit there are no long-range connections between distant gates), all gate interconnection Hamiltonians are short-range Hamiltonians.

Further, common variable Hamiltonians, indicated in FIG. 11 by dashed lines connecting the local subsystems, may be provided to couple local subsystems where the corresponding logic gates have a common input variable. For example, it can be seen in FIG. 10 that the variable q₀ is common to all AND gates of the logic gate circuit, the AND gates forming the top row of gates 1010, 1011, 1012, and 1013 in the multiplication circuit. As described above, that a logical variable is common to a pair of logic gates can be understood as a side condition that is imposed on the logic gate circuit. Accordingly, for each pair of AND gates in the multiplication circuit of FIG. 10, a corresponding side condition may be provided to impose that the variable q₀ is a common input variable for the pair of AND gates in question. However, the resulting side conditions are not all independent of each other, in other words the set of all such side conditions includes redundancies. For example, requiring that q₀ is a common variable of a first AND gate 1010 and a second AND gate 1011, and further requiring that q₀ is a common variable of the second AND gate 1011 and a third AND gate 1012 implies that q₀ is also a common variable of the first and third AND gates 1010 and 1012. Therefore, the latter side condition relating the first and third AND gates 1010 and 1012 does not need to be enforced explicitly in the quantum system by a corresponding common variable Hamiltonian. Accordingly, as shown in FIG. 11, it suffices to provide a set of common variable Hamiltonians 1151, 1152 and 1153 that are arranged according to a chain along the row of local subsystems 1110, 1111, 1112 and 1113 that corresponds to the row of AND gates to impose all side conditions relating to the common variable q₀. Notably, the chain of common variable Hamiltonians 1151, 1152 and 1153 involves only short-range Hamiltonians, since each of these common variable Hamiltonians couples local subsystems that are adjacent to each other. Similar considerations hold for the remaining common variables. For example, q₁ is a common variable of the top row of AND.FA gates in the multiplication circuit (gates 1020, 1021, 1022 and 1023), which is enforced by a set of common variable Hamiltonians 1161, 1162 and 1163 arranged in a chain along the corresponding row of local subsystems 1120, 1121, 1122 and 1123. Again, the resulting chain of common variable Hamiltonians involves short-range Hamiltonians only, since only pairs of adjacent local subsystems are coupled. As yet another illustrative example, p₀ is a common variable of the diagonally arranged set of gates at the right-hand side of the multiplication circuit (namely gates 1010, 1020, 1030 and 1040), which is enforced by common variable Hamiltonians 1171, 1172 and 1173 arranged in a chain along the corresponding diagonally arranged local subsystems 1110, 1120, 1130 and 1140. Again, the resulting chain of common variable Hamiltonians involves short-range Hamiltonians only, since only pairs of adjacent local subsystems are coupled.

In light of the above, when applying the mappings described herein to the multiplication circuit shown in FIG. 10, the resulting gate coupling Hamiltonians may all be short-range Hamiltonians.

The mappings described herein for constructing the short-range quantum Hamiltonians H_{AND}^{SR} and H_{AND.FA}^{SR}, and the constructions of the gate coupling Hamiltonians reflecting the gate interconnections and common variables of the logic gates, can be applied to the multiplication circuit described above. Likewise, the integer n that is to be factorized can be encoded into the quantum system by virtue of an output-encoding Hamiltonian. The output-encoding Hamiltonian can in this case be a 2-body Hamiltonian. The quantum system can be evolved to (or at least towards) a ground state of the total Hamiltonian H^{TOTAL}, which is a sum of all short-range quantum Hamiltonians H_{AND}^{SR} and H_{AND.FA}^{SR}, all gate coupling Hamiltonians and the output-encoding Hamiltonian. Subsequently, a measurement can be performed to provide a read-out, based on which the unknown input—that is, the unknown prime factors of n—can be determined. This yields a quantum computational method that, based on an integer n (the output of the multiplication circuit), computes the prime factors p and q (the unknown input).

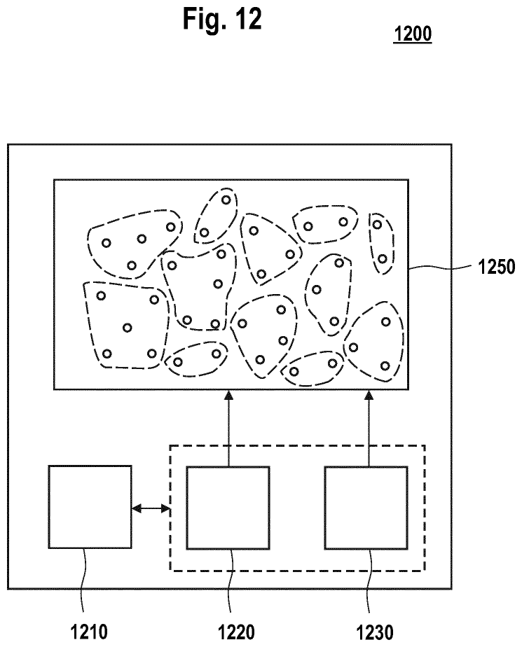

FIG. 12 shows an apparatus 1200 for performing prime factorization of an integer. The apparatus 1200 includes a classical computing system 1210, a quantum processing unit 1220, a measurement unit 1230 and a quantum system 1250 including constituents that may be grouped into local subsystems as indicated by the dashed lines. The quantum system 1250 may be any quantum system described herein, for example the quantum system 300 (see FIG. 3), the quantum system 700 (see FIG. 7) or the quantum system 1100 (see FIG. 11).

The classical computing system 1210 is connected to the quantum processing unit 1220 and the measurement unit 1230. The classical computing system 1210 may be configured to transmit instructions to the quantum processing unit 1220 and/or the measurement unit 1230. The classical computing system 1210 may be configured to receive information from the quantum processing unit 1220 and/or the measurement unit 1230. For example, measurement outcomes obtained by the measurement unit 1230 can be transmitted to the classical computing system 1210. The classical computing system 1210 may be configured for determining a logic gate circuit including logic gates. The logic gate circuit may be configured to compute a multiplication function having, as an output, the integer. The classical computing system 1210 may be configured for determining gate-encoding Hamiltonians from the logic gates, as described herein, wherein each summand Hamiltonian of each gate-encoding Hamiltonian of the gate-encoding Hamiltonians is associated with a respective constituent of the quantum system. The classical computing system 1210 may be configured for determining a first set of short-range quantum interactions of the constituents (for example, the interactions represented by the total Hamiltonian) based on the logic gates of the logic gate circuit. The classical computing system 1210 may be configured for determining a second set of short-range quantum interactions of the constituents (for example, the interactions represented by the output-encoding Hamiltonian) based on the integer.

The quantum processing unit 1220 and the measurement unit 1230 may be configured to act on the quantum system 1250. The quantum processing unit 1220 may be configured for evolving the quantum system 1250, including implementing the first set of short-range quantum interactions and the second set of short-range quantum interactions. The measurement unit 1230 may be configured for measuring at least a portion of the quantum system 1250 to obtain a read-out. The classical computing system 1210 may be configured for determining a prime factor of the integer based on the read-out.

The apparatus 1200 can more generally be an apparatus for inverting a logic gate circuit. The apparatus 1200 may be configured for performing a quantum computational method of inverting a logic gate circuit according to embodiments described herein.

### Spatial Arrangement of the Constituents

The local subsystems of the quantum system can be spatially arranged in a manner that reflects the spatial arrangement of the logic gates in the logic gate circuit. This is illustrated in FIGS. 7 and 11, where it can be seen that the geometrical structure according to which the local subsystems are arranged corresponds to the spatial arrangement of the logic gates in the associated logic gate circuits (see e.g. FIGS. 2 and 10). Accordingly, if a logic gate G₂ is located nearby to a logic gate G₁ in the logic gate circuit, then the associated local subsystems may also be located close to each other in the quantum system. A connection between two logic gates of a logic gate circuit (meaning that an output variable of a first logic gate serves as an input variable of a second logic gate, as explained herein) is said to be a short-range connection if the two logic gates are spaced apart from each other by a distance that is not greater than a cut-off distance D_{circuit} of the logic gate circuit. The cut-off distance D_{circuit} may be a constant distance. The cut-off distance D_{circuit} may be much smaller compared to a maximal gate distance between logic gates in the particular arrangement of the logic gates of the logic gate circuit. For example, the cut-off distance D_{circuit} may be 30% or below of the maximal gate distance, in particular 20% or below, more particularly 10% or below. A logic gate circuit is said to involve only short-range gate interconnections if all connections between logic gates in the logic gate circuit are short-range connections. A gate interconnection Hamiltonian corresponding to a short-range connection between gates in a logic gate circuit may be a short-range Hamiltonian. For a logic gate circuit that involves only short-range gate interconnections, all corresponding gate interconnection Hamiltonians acting on the associated quantum system may be short-range Hamiltonians. For example, the multiplication circuit described herein involves short-range connections only, and hence all associated gate interconnection Hamiltonians are short-range Hamiltonians.

Further, the structure of a logic gate circuit may be such that all common variable Hamiltonians acting on the associated quantum system are short-range Hamiltonians as well. For a logical variable v, consider the set of all logic gates of the logic gate circuit that have v as an input variable. Each pair of logic gates taken from this set gives rise to a side condition of the form “v is a common variable of logic gate X and logic gate Y”, called herein a common variable side condition. The set Comm-Var(v) consisting of all such common variable side conditions relating to the variable v includes redundancies, i.e. not all common variable side conditions in his set are independent of each other. For example, a first side condition stating that “v is a common variable of logic gate G₁ and logic gate G₂” and a second side condition stating that “v is a common variable of logic gate G₂ and logic gate G₃” implies a third side condition stating that “v is a common variable of logic gate G₁ and logic gate G₃”. A minimal subset of common variable side conditions for the variable v is a subset of common variable side conditions that implies all remaining common variable side conditions for the variable v. A logic gate circuit is said to involve only short-range common variable side conditions if, for each logical variable that is a common variable of logic gates in the logic gate circuit, all side conditions in a minimal subset of common variable side conditions for said logical variable involve logic gates that are spaced apart from each other by a distance not greater than the cut-off distance D_{circuit} of the logic gate circuit. If a logic gate circuit involves only short-range common variable side conditions, all corresponding common variable Hamiltonians may be short-range Hamiltonians. For example, as described above, the multiplication circuit described herein involves short-range common variable side conditions only, and hence the associated common variable Hamiltonians are all short-range Hamiltonians.

According to embodiments, a logic gate circuit may involve only short-range gate interconnections and/or may involve only short-range common variable side conditions. Specifically, a multiplication circuit may involve only short-range gate interconnections and/or may involve only short-range common variable side conditions.

### Evolving the Quantum System

The quantum computational method may include initializing the constituents of the quantum system in an initial state, evolving the quantum system, and measuring at least a portion of the constituents of the quantum system to obtain a read-out. The evolution of the quantum system may be from the initial state to a final state. The final state may be at least approximately equal to a ground state of the total Hamiltonian H^{TOTAL}. The measurement may be made on the at least a portion of the constituents when the quantum system is in the final state. An apparatus for performing the quantum computation may include a quantum processing unit for initializing the quantum system in the initial state and/or for controlling the evolution of the quantum system. The apparatus may include a measurement unit for performing measurements of the quantum system.

According to embodiments described herein, the quantum computational method includes evolving the quantum system towards a ground state of the total Hamiltonian H^{TOTAL} Evolving the quantum system may include implementing the quantum interactions (specifically, the first set of short-range quantum interactions and the second set of short-range quantum interactions as described herein) that are represented by the total Hamiltonian. The act of implementing a quantum interaction can be understood as performing one or more operations to physically realize, or engineer, the quantum interaction in the quantum system. The one or more operations may be performed by a quantum processing unit (including e.g. a laser) that is coupled to the quantum system.

The evolution of the quantum system during the quantum computation may be controlled by analog driving, in particular by an adiabatic evolution (quantum annealing). Background on adiabatic driving (quantum annealing) is described in EP 3 113 084 B1. Analog driving may alternatively be counter-diabatic driving using a Hamiltonian with an additional counter-diabatic part, with background on this technique being described in WO 2020/259813 A1. The documents EP 3 113 084 B1 and WO 2020/259813 A1 are incorporated by reference.

Evolving the quantum system may include initializing the quantum system in an initial quantum state, which may be a ground state of an initial Hamiltonian Hᵢₙᵢₜ of the quantum system (or which may at least be close to such ground state). The initial Hamiltonian Hᵢₙᵢₜ, also called driver Hamiltonian, may be a Hamiltonian with a known ground state, such as for example (but without limiting the scope thereto) the Hamiltonian Σᵢ Xᵢ, where Xᵢ is a Pauli σ_{X} operator acting on the i-th constituent of the quantum system. The initial Hamiltonian and the total Hamiltonian may not commute with each other. For example, the initial Hamiltonian may involve σ_{X} operators only and the total Hamiltonian may involve σ_{Z} operators only.

Evolving the quantum system may include gradually passing from the initial Hamiltonian to the total Hamiltonian H^{TOTAL} via an intermediate Hamiltonian. A family of quantum Hamiltonians H(t) may be considered, where t is a time parameter ranging from an initial time tᵢₙᵢₜ to a final time t_{fin}, such that H(t) is equal to Hᵢₙᵢₜ when t=tᵢₙᵢₜ and H(t) is equal to H^{TOTAL} when t=t_{fin}. For a time t between tᵢₙᵢₜ and t_{fin}, the Hamiltonian H(t) is an intermediate Hamiltonian. The Hamiltonian H(t) may be a linear combination of the initial Hamiltonian Hᵢₙᵢₜ and the total Hamiltonian H^{TOTAL} More generally, the Hamiltonian H(t) may be a linear combination including: the initial Hamiltonian Hᵢₙᵢₜ; the short-range quantum Hamiltonians H_{G}^{SR} associated with the logic gate circuit; the gate interconnection Hamiltonians associated with the logic gate circuit; the common variable Hamiltonians associated with the logic gate circuit; and the output-encoding Hamiltonian. Each Hamiltonian in the linear combination may be provided with a coefficient. The coefficients of the Hamiltonians in the linear combination may be time-dependent functions. Each time-dependent function may describe the strength of the respective Hamiltonian. The time-dependent functions may describe the relative strength of said Hamiltonians over time. In an illustrative example (but without limiting the scope thereto), we may have tᵢₙᵢₜ=0 and t_{fin}=1 and the Hamiltonian H(t) may have the form

$$\\ H ( t ) = ( 1 - t ) {H}_{init} + {tH}^{{}_{} TOTAL}$$

which is such that H(t) is equal to Hᵢₙᵢₜ when t=0 and H(t) is equal to H^{TOTAL} when t=1.

Passing from the initial Hamiltonian to the total Hamiltonian may include fading out the initial Hamiltonian and fading in the total Hamiltonian. Fading out may involve tuning the strength of a corresponding Hamiltonian down, described by a time-dependent function decreasing over time. Conversely, fading in may involve tuning the strength of a corresponding Hamiltonian up, described by a time-dependent function increasing over time.

Evolving the quantum system may include performing an adiabatic evolution of the quantum system (quantum annealing). The gradual passing from the initial Hamiltonian to the total Hamiltonian may be performed adiabatically. In view of e.g. the adiabatic theorem of quantum mechanics, but without wishing to be bound to any particular theory, the quantum state of the quantum system will be a ground state or at least be well-approximated by a ground state of the Hamiltonian H(t) for all values of the time parameter t ranging from the initial time to the final time if the passage from the initial Hamiltonian to the total Hamiltonian is performed slowly enough. Accordingly, an adiabatic evolution (quantum annealing) evolves the initial quantum state at the initial time to a final quantum state at the final time, wherein the final quantum state is a ground state of the total Hamiltonian or at least is well-approximated by a ground state of the total Hamiltonian.

According to some embodiments, an intermediate Hamiltonian H(t) may be a linear combination of the initial Hamiltonian Hᵢₙᵢₜ, the total Hamiltonian H^{TOTAL} and an additional Hamiltonian H_{count} (counter-diabatic Hamiltonian). The Hamiltonian H(t) may be a linear combination including: the initial Hamiltonian Hᵢₙᵢₜ; the short-range quantum Hamiltonians H_{G}^{SR} associated with the logic gate circuit; the gate interconnection Hamiltonians associated with the logic gate circuit; the common variable Hamiltonians associated with the logic gate circuit; the output-encoding Hamiltonian; and the counter-diabatic Hamiltonian H_{count}. Each Hamiltonian in said linear combination may be provided with a coefficient. The coefficients of the Hamiltonians in the linear combination may be time-dependent functions, as described above. In an illustrative example (but without limiting the scope thereto), the Hamiltonian H(t) may have the form

$$\\ H ( t ) = A ( t ) {H}_{init} + B ( t ) {H}^{{}_{} TOTAL} + C ( t ) {H}_{count}$$

where A(t), B(t) and C(t) are time-dependent coefficients such that A(tᵢₙᵢₜ)=1=B(t_{fin}) and A(t_{fin})=C(t_{fin})=B(tᵢₙᵢₜ)=C(tᵢₙᵢₜ)=0. The counter-diabatic Hamiltonian H_{count} may not commute with the initial Hamiltonian Hᵢₙᵢₜ and/or may not commute with the total Hamiltonian H^{TOTAL} For example, the initial Hamiltonian may involve σ_{X} operators only, the total Hamiltonian may involve σ_{Z} operators only, and the counter-diabatic Hamiltonian H_{count} may involve σ_{Y} operators only. For example, the counter-diabatic Hamiltonian H_{count} may have the form Σᵢ bᵢ Yᵢ, where Yᵢ is a Pauli σ_{Y} operator acting on the i-th constituent of the quantum system and each b₁ is a coefficient. By having an intermediate Hamiltonian that includes the counter-diabatic Hamiltonian H_{count}, a larger space of possible “paths” for evolving the initial Hamiltonian into the total Hamiltonian becomes available. This larger space can be exploited to decrease the time needed for evolving the initial Hamiltonian into the Total Hamiltonian. Accordingly, a faster runtime for solving the computational problem can be provided. In particular, by passing via an intermediate Hamiltonian which includes a counter-diabatic Hamiltonian, it is possible to evolve the initial Hamiltonian into the total Hamiltonian according to a diabatic process (or non-adiabatic process, or counter-diabatic process) while staying sufficiently close to the ground state of the quantum system throughout the evolution. By passing via an intermediate Hamiltonian that includes a counter-diabatic Hamiltonian, the evolution from the initial Hamiltonian to the total Hamiltonian can be carried out diabatically, i.e. faster than the speed allowed by the adiabatic theorem, while still reaching a ground state which is close to the ground state of the total Hamiltonian.

The evolution of the quantum system during the quantum computation may be controlled by digital driving, particularly by gate-based quantum computation. In gate-based quantum computing the quantum computation is driven by applying sequences of unitary operators on an initial state of the quantum system. The sequence of unitary operators and their parameters can be optimized in N rounds of operation by reading out (measuring) the quantum system in at least one previous round and using a classical feed-forward to apply an optimized sequence in a later round. Background on the technique of gate-based quantum computation is described in WO 2020/156680 A1. The document WO 2020/156680 A1 is incorporated by reference.

The aim of the gate-based quantum computation is to first minimize the energy Eₘᵢₙ=min (ψ|^{TOTAL}|ψ) in a quantum approximate optimization algorithm (QAOA). Once the minimal (or acceptably low) energy is determined, the constituents are read out by measurement when they are in the quantum state that has the minimal (acceptably low) energy. The quantum state in question is close to a ground state of the total Hamiltonian H^{TOTAL}, so that the read-out contains information about the prime factors of the integer y that is to be factorized (or more generally, in case the logic gat circuit is not a multiplication circuit, the read-out contains information about the unknown input that corresponds to the output y). Therein,

$$\vert ψ 〉 = {U}_{{H}_{init}} ( {α}_{1} ) {U}_{{H}^{TOTAL}} ( {β}_{1} ) … {U}_{{H}_{init}} ( {α}_{m} ) {U}_{{H}^{TOTAL}} ( {β}_{m} ) \vert init 〉 ,$$

wherein the unitary operators are propagators of the respective Hamiltonians and |init) is an initial state. That means, U_{H}_{ᵢₙᵢₜ}(α)=exp(−iαHᵢₙᵢₜ) and U_{H}_{^{TOTAL}}(β)=exp(−iβH^{TOTAL}). The minimization is over all parameters α₁ . . . αₘ, β₁ . . . , βₘ (variational parameters). Instead of the operator U_{H}_{^{TOTAL}} (β) which assigns one “global” variational parameter p to the total Hamiltonian, it is also possible to consider a different variational parameter for each of the terms of the total Hamiltonian, resulting in an operator U_{H}_{^{TOTAL}} that depends on multiple parameters, denoted as U_{H}_{^{TOTAL}} (β⁽¹⁾, β⁽²⁾, β⁽³⁾, . . . ). The operator U_{H}_{^{TOTAL}} (β⁽¹⁾, β⁽²⁾, β⁽³⁾, . . . ) may be a product of operators, wherein each operator in the product is a propagator of the form exp(−iβ^{(j)}A), having its own individual variational parameter β^{(j)}, wherein A is (i) a short-range quantum Hamiltonians H_{G}^{SR}; (ii) a gate interconnection Hamiltonian; a common variable Hamiltonians; or the output-encoding Hamiltonian. The initial state | init) may, for example, be the ground state of the initial Hamiltonian Hᵢₙᵢₜ described herein.

The minimization may be done by a variational method, in which the variational parameters, such as α₁ . . . αₘ, β₁ . . . βₘ are individually varied in different rounds of operation. Comparison of the energies obtained in different rounds of operation allows to select the sequence of unitary operators that led to the lower energy, and to use the selected sequence to further vary the parameters by small perturbations. In this way, the next round of optimization may depend on classical information of a previous round or of previous rounds that is/are fed forward, and the energy is always lowered or at least non-increasing. Details of such a variational method are described in WO 2020/156680 A1

The unitary operator U_{H}_{^{init}} is local, and can be realized by single-qubit rotations and phase rotations. The unitary operator U_{H}_{^{TOTAL}}, and more specifically the propagators of each of the Hamiltonians occurring as a term in the total Hamiltonian, can be realized by CNOT gates and a single-qubit rotations (R_{z}), as described in WO 2020/156680 A1.

The quantum computational method described herein may include determining a sequence of unitary operators. The unitary operators in the sequence may be taken from the following set of unitary operators: a unitary operator being a function of the initial Hamiltonian, a unitary operator being a function of a short-range quantum Hamiltonians H_{G}^{SR}, a unitary operator being a function of a gate interconnection Hamiltonian, a unitary operator being a function of a common variable Hamiltonian, and a unitary operator being a function of the output-encoding Hamiltonian. The functions may be exponential functions. The unitary operators may be propagators of the aforementioned Hamiltonians. The functions may include variational parameters. Each unitary operator in the sequence of unitary operators may come with its own variational parameter.

Evolving the quantum system may include applying the sequence of unitary operators to the quantum system, specifically to the initial state of the quantum system. The initial state may be the ground state of the initial Hamiltonian. In applying the sequence of unitary operators, parameters of unitary operators may be in a first configuration. The method may include measuring at least a portion of the constituents of the quantum system after application of the sequence of unitary operators to obtain a first read-out. The method may include deriving a first energy from the first read-out, wherein the first energy may be the energy of the total Hamiltonian in the quantum state resulting from the application of the sequence of unitary operators to the initial state.

The method may include applying a second sequence of unitary operators to the quantum system, specifically to the initial state of the quantum system. In applying the second sequence of unitary operators, the parameters of the unitary operators may be in a second configuration, different from the first configuration. The method may include measuring at least a portion of the constituents of the quantum system after application of the second sequence of unitary operators to obtain a second read-out. The method may include deriving a second energy from the second read-out, wherein the second energy may be the energy of the total Hamiltonian in the quantum state resulting from the application of the second sequence of unitary operators to the initial state. The method may include selecting the first or the second sequence in dependence of the first and second read-outs, particularly selecting the first sequence if the first energy is lower than the second energy, and selecting the second sequence if the second energy is lower than the first energy.

The method may include applying a third sequence of unitary operators to the quantum system, specifically to the initial state of the quantum system. In applying the third sequence of unitary operators, the parameters of the unitary operators may be in a third configuration, wherein the third configuration is a variation of the first configuration if the first sequence was selected and wherein the third configuration is a variation of the second configuration if the second sequence was selected. The method may include N rounds of operations, wherein N≥2, wherein each round of the N rounds of operations includes the application of an i-th sequence of unitary operators with the parameters being in an i-th configuration, and measuring at least a portion of the constituents of the quantum system to obtain an i-th read-out. The method may include deriving an i-th energy from the i-th read-out, wherein the i-th energy may be the energy of the total Hamiltonian in the quantum state resulting from the application of the i-th sequence of unitary operators to the initial state. The i-th configuration of the parameters may be determined based on one or more read-outs (or one or more energies) of (a) previous round(s) of operation. The i-th configuration may be determined such that the energies of the quantum states corresponding to the selected configurations is decreasing (or at least non-increasing).

The method may include, after an N-th round of operations, applying a final sequence of unitary operators to the quantum system, specifically to the initial state, to evolve the quantum system to a final state. The final sequence may be chosen such that its configuration of the parameters provides the minimum of the N energies determined in the N rounds of operations. The method may include measuring the quantum system, or at least a portion thereof, when the quantum system is in the final state. The method may include determining a prime factor of the integer to be factorized (or, more generally, an unknown input x that corresponds to a known output y of the logic gate circuit) from the read-out of this measurement.

Evolving the quantum system may include cooling the quantum system towards a ground state of the total Hamiltonian, which may be performed by a cooling unit. A ground state of a quantum Hamiltonian is a quantum state of zero temperature. Accordingly, by cooling the quantum system to a sufficiently low temperature, a ground state of the total Hamiltonian can be prepared, at least approximately. The cooling process as such may bring the quantum system in (or near) a ground state of the total Hamiltonian, without the need for, for example, additionally performing an adiabatic, counter-diabatic or gate-based evolution.

### Exemplary Implementations of the Quantum System

The quantum system and its constituents (such as qubits) are physical entities, as explained herein. Hereinafter, specific implementations of the quantum system/the constituents and of the interactions involved in the quantum computational method are described. However, the method can be carried out on any other specific implementation of said physical entities and of their interactions, and the exemplary implementations shall not be considered as limiting.

The constituents may be superconducting qubits, e.g. transmon or flux qubits. A superconducting qubit may include a primary and a secondary superconducting loop. Superconducting currents propagating clockwise and counter-clockwise, respectively, in the primary superconducting loop can form the quantum basis states |1> and |0> of the superconducting qubit. Further, a magnetic flux bias through the secondary superconducting loop can couple the quantum basis states |0> and |1>.

A single-body Hamiltonian can be realized by a plurality of magnetic fluxes interacting with the superconducting qubits. A magnetic flux or magnetic flux bias may extend through the primary superconducting loop and through the secondary superconducting loop of a superconducting qubit. The parameters of a single-body Hamiltonian can be adjusted by adjusting the plurality of magnetic fluxes or magnetic flux biases. Alternatively, a single-body Hamiltonian can be realized by a plurality of charges interacting with the plurality of superconducting qubits. The parameters of the problem Hamiltonian can be adjusted by adjusting a plurality of charge bias fields. For realizing a single-body driver Hamiltonian (e.g. in the context of an adiabatic evolution), a magnetic flux bias through the primary superconducting loop of the superconducting qubit may be set such that the basis states |0> and |1> have the same energy, i.e. the energy difference for these basis states is zero. Further, a magnetic flux bias through the secondary superconducting loop can couple the basis states |0> and |1>. Accordingly, a summand Hamiltonian of the driver Hamiltonian of the form hσₓ^{(k)}, and therefore also the driver Hamiltonian of the form H_{drive}=h Σₖ σₓ^{(k)} can be realized for a plurality of superconducting qubits.

A d-body Hamiltonian (gate interconnection Hamiltonian, common variable Hamiltonian, output-encoding Hamiltonian) acting on a group of d qubits (e.g. a plaquette) can be realized using an ancillary qubit, wherein the ancillary qubit may be arranged inside the group of d qubits (e.g., at the center of a plaquette). Interactions between qubits of the form cₖₘσ_{z}^{(k)}σ_{Z}^{(m)} can be realized by a coupling unit, e.g. an inductive coupling unit. The coupling unit includes a superconducting quantum interference device. Applying an adjustable magnetic flux bias to the superconducting quantum interference device allows tuning the coefficient cₖₘ. A d-body Hamiltonian can then be realized by C(σ_{z}⁽¹⁾+σ_{z}⁽²⁾+ . . . +σ_{z}^{(d)}−2σ_{z}^{(p)}−1)², which includes only pairwise interactions of the form σ_{z}^{(k)}σ_{Z}^{(m)} and single-body σ_{z} (terms corresponding to imposed energy differences between the |0> and |1> quantum basis states. Here, σ_{z}^{(p)} represents the ancilla qubit. Alternatively, a d-body Hamiltonian such as a plaquette Hamiltonian can be realized without ancillary qubits, e.g., using three-island superconducting devices as transmon qubits. By integrating two additional superconducting quantum interference devices in the coupling unit and by coupling four qubits of a plaquette capacitively to a coplanar resonator, a constraint Hamiltonian of the form −Cσ_{z}⁽¹⁾α_{z}⁽²⁾σ_{z}⁽⁴⁾ can be realized. The coupling coefficient C can be tuned by time-dependent magnetic flux biases through the two additional superconducting quantum interference devices.

The qubit states |0> and |1> of the superconducting qubits can be measured with high fidelity using a measurement unit including a plurality of superconducting quantum interference devices, in particular N hysteretic DC superconducting quantum interference devices and N RF superconducting quantum interference device latches controlled by bias lines, wherein the number of bias lines scales according to √N.

Alternatively, the quantum system may be realized using a system of trapped ions as qubits. In this case, the quantum basis states |0> and |1> of a qubit are formed by two levels of a Zeeman- or hyperfine manifold or across a forbidden optical transition of alkaline earth, or alkaline earth-like positively charged ions, such as Ca40+. Individual ions can be addressed by spatial separation or separation in energy. The case of spatial separation involves using a laser beam that has passed through and/or has been reflected from an acousto-optical deflector, an acousto-optical modulator, micromirror devices, or the like. The case of separation in energy involves using a magnetic field gradient that changes internal transition frequencies, allowing selection through energy differences, i.e., detunings of the applied fields. A single-body Hamiltonian can be realized by laser fields or microwaves that are resonant or off-resonant with the internal transition, or by spatial magnetic field differences. Interactions between ions can be transmitted via a phonon bus. To this end, lasers or microwaves can be used which are detuned with respect to the blue-side and/or red-side band transition of the phonons. The strength of the laser and detuning allow an adjustment of the interaction strength. Direct interactions through Rydberg excitations can also be used. The ions can be initialized (prepared in an initial state) by optical pumping using a laser that deterministically transfers the ions into one the two quantum basis states. Since this process reduces entropy it can be viewed as a cooling on the internal states of the ions. Single-body unitary operators exp(itσₓ) or exp(itσ_{z}) can be realized via controlled magnetic dipole transitions or controlled Raman transitions. A measurement of the ion-based quantum system can be performed by fluorescence spectroscopy. Therein, ions are driven on a transition with short lifetime if they are in one of the two spin states. As a result, the ions in the driven state emit many photons, while the other ions remain dark. The emitted photons can be registered by commercial CCD cameras. Measurement in any of the directions on the Bloch sphere is achieved by appropriate single-qubit pulses prior to the fluorescence spectroscopy.

As yet a further alternative, the quantum system may be realized using ultracold atoms, e.g. ultracold neutral Alkali atoms, which are trapped in an optical lattice or large spacing lattices from laser fields. The atoms can be evolved towards a ground state using laser cooling. The quantum basis states of a qubit can be formed by the ground state of an atom and a high-lying Rydberg state. The qubits can be addressed by laser light. A single-body Hamiltonian can be realized by variation of the detuning of the electronic transition frequency with respect to the laser frequency. Interactions between qubits can be controlled by detuning of a laser that excites d atoms. In this case, the Hamiltonian is a d-body Hamiltonian. d-body Hamiltonians may either be implemented from d-body interactions or from ancillary qubits with two-body interactions. An initial state may be prepared by exciting atoms being in their ground state to a Rydberg state with a large detuning. Single-body unitary operators exp(itσₓ) or exp(itσ_{z}) can be realized with detuned laser driving of Rydberg transitions. The qubits can be measured by performing a selective sweep of ground state atoms and fluorescence imaging with single site resolutions.

As yet a further alternative, the quantum system may be realized with quantum dots. Quantum dot qubits may be fabricated from GaAs/AlGaAs heterostructures. The qubits are encoded in spin states, which may be prepared by adiabatically tuning the potential from a single well to a double well potential. A single-body Hamiltonian can be realized with electric fields. In the initial state, each qubit is prepared either in the state |0> or |1>, which is implemented by adiabatically switching from a single well to a double well with a strong additional magnetic field. An interaction between two qubits can be regulated by an electric field gradient and a magnetic field. A d-body Hamiltonian may be realized by using an additional ancillary qubit and interactions realized with pulse sequences and magnetic fields. Single-body unitary operators exp(itσₓ) or exp(itσ_{z}) can be realized with electric pulse sequences and magnetic fields. The quantum dot qubits can be read out from a pulse sequence by rapid adiabatic passage.

As yet a further alternative, the quantum system may be realized with impurities in solid-state crystals, such as NV Centers, which are point defects in diamond crystals. Other impurities might be used, e.g., color centers tied to chromium impurities, rare-earth ions in solid-state crystals, or defect centers in silicon carbide. NV Centers have two unpaired electrons, which provides a spin-1 ground state that allows the identification of two sharp defect levels with large life times that can be used to realize a qubit, possibly in conjunction with the surrounding nuclear spins. Using magnetic resonance through the application of microwave pulses, qubit states can be coherently manipulated on nano-second timescales. Selective single-qubit manipulation can also be achieved conditional on the state of the close-by nuclear spins. Interactions between NV centers for realizing the short-range Hamiltonian can be transmitted by coupling the NV centers to light fields. For a quantum system realized with NV Centers, the NV Centers may be addressed individually by using standard optical confocal microscopy techniques. Initialization (preparation of the initial state) and measurements can be performed by off-resonant or resonant optical excitation. Single qubit operations are implemented by coupling the nuclear spin to the electronic spin and microwave driving of the electronic spin.

### EMBODIMENTS

According to an embodiment, a quantum computational method of performing prime factorization of an integer is provided. The quantum computational method includes determining a logic gate circuit including logic gates, the logic gate circuit being configured to compute a multiplication function having, as an output, the integer. The quantum computational method includes determining gate-encoding Hamiltonians, one for each logic gate of the logic gates, wherein each gate-encoding Hamiltonian encodes an input-output relation of a logic gate of the logic gates and is a sum of summand Hamiltonians. The quantum computational method includes providing a quantum system comprising constituents, wherein each summand Hamiltonian of each gate-encoding Hamiltonian of the gate-encoding Hamiltonians is associated with a respective constituent of the quantum system. The quantum computational method includes determining a first set of short-range quantum interactions of the constituents based on the logic gates of the logic gate circuit. The quantum computational method includes determining a second set of short-range quantum interactions of the constituents based on the integer. The quantum computational method includes evolving the quantum system, including implementing the first set of short-range quantum interactions and the second set of short-range quantum interactions. The quantum computational method includes measuring at least a portion of the quantum system to obtain a read-out. The quantum computational method includes determining a prime factor of the integer based on the read-out.

That the logic gate circuit is “determined” can be understood in the sense that a description of the logic gate circuit is made available to a user or apparatus, so that the subsequent operations of the quantum computational method can be performed. Determining the logic gate circuit may include, for example, retrieving a description of the logic gate circuit from a memory where said description may have been stored, receiving the description of the logic gate circuit, e.g. if said description is communicated to the user or apparatus from a different location, or calculating the description of the logic gate circuit, e.g. by performing certain pre-processing operations to determine what said description shall be.

The term “one” in the wording “determining gate-encoding Hamiltonians, one for each logic gate of the logic gates” shall be understood in the sense that, for each logic gate of the logic gates, “a” gate-encoding Hamiltonian is determined. The wording in question does not exclude that several, i.e. more than one, gate-encoding Hamiltonians are determined for a given logic gate. That is to say, the term “one” in the aforementioned wording shall not be understood in the limited sense of “only one” but in the sense of “at least one” or, in other words, “one, and possibly more”.

Each gate-encoding Hamiltonian of the gate-encoding Hamiltonians may be a classical Hamiltonian or a quantum Hamiltonian. Each gate-encoding Hamiltonian of the gate-encoding Hamiltonians may have a ground space which encodes an input-output relation of a logic gate of the logic gates. The ground space may encode a truth table of the logic gate. Each gate-encoding Hamiltonian of the gate-encoding Hamiltonians may encode an input-output relation of a logic gate having logical variables, the logical variables including one or more input variables (e.g. u, v, . . . ) and one or more output variables (e.g. s′, c′, . . . ) of the logic gate. The gate-encoding Hamiltonian may include spin observables (e.g. σᵤ, σᵥ, σ_{s′}, σ_{c′}, . . . ), one for each logical variable of the logic gate. Each spin observable may be a classical spin or a quantum observable.

A quantum system as described herein may include local subsystems (e.g. 10, 20, 50, 100 or more local subsystems) each including a subset of the constituents. The local subsystems may be mutually disjoint subsystems of the quantum system. Each gate-encoding Hamiltonian of the gate-encoding Hamiltonians may be associated with a local subsystem. The local subsystem associated with a gate-encoding Hamiltonian may include the constituents associated with the summand Hamiltonians of the gate-encoding Hamiltonian. Each local subsystem may include L constituents or less, wherein L may be 20, 15 or 10.

Determining the first set of short-range quantum interactions may include, for each gate-encoding Hamiltonian of the gate-encoding Hamiltonians, determining short-range quantum interactions from the gate-encoding Hamiltonian. The short-range quantum interactions may be interactions represented by a short-range quantum Hamiltonian H_{G}^{SR} as described herein. The determined short-range quantum interactions may be included in the first set of short-range quantum interactions. The determined short-range quantum interactions may act inside the local subsystem associated with the gate-encoding Hamiltonian. Implementing the first set of short-range quantum interactions, as described herein, may include implementing the determined short-range quantum interactions. The short-range quantum interactions and/or the short-range quantum Hamiltonian H_{G}^{SR} associated with a gate-encoding Hamiltonian H_{G} may be configured for encoding an input-output relation of the logic gate G into the local subsystem associated with the gate-encoding Hamiltonian H_{G}. A single-body interaction can be understood as an interaction representable by a single-body Hamiltonian of the quantum system. A single-body interaction can be realized, for example, by letting a single constituent of the quantum system interact with an external field.

Determining the first set of short-range quantum interactions, as described herein, may include, for each gate-encoding Hamiltonian of the gate-encoding Hamiltonians, determining single-body interactions from the gate-encoding Hamiltonian. The determined single-body interactions may be included in the first set of short-range quantum interactions. Implementing the first set of short-range quantum interactions may include implementing the determined single-body interactions. The determined single-body interactions may be representable by a single-body Hamiltonian H_{1-body} acting inside the local subsystem associated with the gate-encoding Hamiltonian. Each summand Hamiltonian of each gate-encoding Hamiltonian of the gate-encoding Hamiltonians may have an interaction coefficient. The interaction coefficient may be mapped to a single-body interaction of the single-body interactions. The single-body interaction may be a function of the interaction coefficient.

Determining the first set of short-range quantum interactions, as described herein, may include, for each gate-encoding Hamiltonian of the gate-encoding Hamiltonians, determining one or more constraint interactions from the gate-encoding Hamiltonian. The one or more constraint interactions may be included in the first set of short-range quantum interactions. Implementing the first set of short-range quantum interactions may include implementing the determined one or more constraint interactions. The one or more constraint interactions may be representable by a constraint Hamiltonian H_{cons} acting inside the local subsystem associated with the gate-encoding Hamiltonian. The constraint interactions and/or the constraint Hamiltonian determined from a gate-encoding Hamiltonian may be configured for providing a consistency between the qubits or classical spins of the gate-Hamiltonian and the constituents that are associated with the summand Hamiltonians of the gate-encoding Hamiltonian. The constraint interactions and/or the constraint Hamiltonian may be configured for rendering the ground space of the short-range quantum Hamiltonian H_{G}^{SR} consistent with one or more properties of the gate-encoding Hamiltonian H_{G}. Each of the one or more properties may provide that a product of a subset of the summand Hamiltonians of the gate-encoding Hamiltonian H_{G} is proportional to the identity, or that the product of all of the summand Hamiltonians of H_{G} is proportional to the identity.

A logic gate circuit as described herein may include gate interconnections between pairs of logic gates. A gate interconnection exists between a first logic gate and a second logic if a same logical variable is both an output variable of the first logic gate and an input variable of the second logic gate. Determining the first set of short-range quantum interactions may include, for each gate interconnection of the gate interconnections, determining a gate interconnection interaction or a set of gate interconnection interactions from the gate interconnection. Each gate interconnection, or set of gate interconnection interactions, that is determined from a gate interconnection may be representable by a gate interconnection Hamiltonian coupling at least two local subsystems of the quantum system. The gate interconnection Hamiltonian may act jointly on a first local subsystem and a second local subsystem. The first local subsystem may be associated with a first gate-encoding Hamiltonian. The second local subsystem may be associated with a second gate-encoding Hamiltonian. The first gate-encoding Hamiltonian and the second gate-encoding Hamiltonian may be associated with a first logic gate and a second logic gate, respectively, of the logic gates. The first logic gate and the second logic gate may be connected to each other by a gate interconnection of the gate interconnections. A gate interconnection and/or gate interconnection Hamiltonian may be configured to encode a gate interconnection of the logic gate circuit in the quantum system.

The determined gate interconnection interactions may be included in the first set of short-range quantum interactions. Implementing the first set of short-range quantum interactions includes implementing the determined gate interconnection interactions.

A logic gate circuit as described herein may include common variables. A common variable is a same logical variable that is an input variable of each logic gate in a group of two or more logic gates. Determining the first set of short-range quantum interactions may include determining a common variable interaction or a set of common variable interactions from each common variable of a set of common variables. A common variable interaction, or a set of common variable interactions, that is determined from a common variable may be representable by a common variable Hamiltonian coupling at least two local subsystems of the quantum system. The common variable Hamiltonian may act jointly on a first local subsystem and a second local subsystem. The first local subsystem may be associated with a first gate-encoding Hamiltonian. The second local subsystem may be associated with a second gate-encoding Hamiltonian. The first gate-encoding Hamiltonian and the second gate-encoding Hamiltonian may be associated with a first logic gate and a second logic gate, respectively, of the logic gates.

The common variable in question may be an input variable of both the first logic gate and the second logic gate. A common variable interaction and/or a common variable Hamiltonian may be configured for encoding an occurrence of a common variable in the logic gate circuit into the quantum system.

The determined common variable interactions may be included in the first set of short-range quantum interactions. Implementing the first set of short-range quantum interactions includes implementing the determined common variable interactions.

Determining the second set of short-range quantum interactions may include determining a set of output-encoding interactions from the integer to be factorized, or more generally from the output of the logic gate circuit (in case the logic gate circuit is not a multiplication circuit). The set of output-encoding interactions may be representable by an output-encoding Hamiltonian. The output-encoding Hamiltonian may be a 2-body Hamiltonian. The determined output-encoding interactions may be included in the second set of short-range quantum interactions. Implementing the second set of short-range quantum interactions includes implementing the determined output-encoding interactions. The output-encoding interactions and/or the output-encoding Hamiltonian may be configured for encoding the integer to be factorized, or more generally an output of a logic gate circuit, into the quantum system.

Evolving the quantum system, as described herein, may include evolving the quantum system towards a ground state of a total Hamiltonian, for example the total Hamiltonian H^{TOTAL} as described herein. The total Hamiltonian may be a sum including a first Hamiltonian and a second Hamiltonian. The first Hamiltonian may represent the first set of short-range quantum interactions, as described herein. The first Hamiltonian may be a sum including: the single-body Hamiltonians corresponding to the determined single-body interactions; the constraint Hamiltonians corresponding to the determined constraint interactions; the gate interconnection Hamiltonians corresponding to the determined gate interconnection interactions; the common variable Hamiltonians corresponding to the determined common variable interactions; or any combination thereof. The second quantum Hamiltonian may represent the second set of short-range quantum interactions, as described herein. The second Hamiltonian may be the gate-encoding Hamiltonian as described herein. The ground state of the total Hamiltonian may encode at least one prime factor of the integer to be factorized, or more generally an unknown input of the logic gate circuit in question (if the logic gate circuit is not a multiplication circuit), or may at least encode information allowing the prime factor/unknown input to be determined. Measuring at least a portion of the quantum system to obtain a read-out, as described herein, may include performing a measurement when the quantum system is in a quantum state that is equal to or approximately equal to a ground state of the total Hamiltonian.

Evolving the quantum system, as described herein, may include: cooling the quantum system; performing an adiabatic evolution of the quantum system; performing a counter-diabatic evolution of the quantum system; performing a gate-based evolution of the quantum system; or any combination thereof.

The logic gates of a logic gate circuit as described herein may include AND gates and/or AND.FA gates. Particularly, each logic gate of the logic gates may be one of an AND gate and an AND.FA gate.

For each logic gate of the logic gates that is an AND gate, the gate-encoding Hamiltonian associated with the logic gate may have the form

$${H}_{AND} = - {σ}_{s} - {σ}_{u} {σ}_{s} - {σ}_{v} {σ}_{s} + {σ}_{u} {σ}_{v} {σ}_{s} .$$

Therein, σᵤ, σᵥ and σₛ may be spin observables associated with logical variables u, v and s, respectively. The spin observables may be classical spins or quantum observables. The logical variables u and v may be input variables of the AND gate and the logical variable s may be an output variable of the AND gate.

For each logic gate of the logic gates that is an AND.FA gate, the gate-encoding Hamiltonian associated with the logic gate may have the form

$${H}_{AND . FA} = - {σ}_{s} {σ}_{c} {σ}_{{s}^{′}} - {σ}_{u} {σ}_{s} {σ}_{c} {σ}_{{s}^{′}} - {σ}_{v} {σ}_{s} {σ}_{c} {σ}_{{s}^{′}} + {σ}_{u} {σ}_{v} {σ}_{s} {σ}_{c} {σ}_{{s}^{′}} - {σ}_{s} {σ}_{c} {σ}_{{s}^{′}} {σ}_{{c}^{′}} - {σ}_{s} {σ}_{{c}^{′}} - {σ}_{c} {σ}_{{c}^{′}} + {σ}_{{s}^{′}} {σ}_{{c}^{′}} .$$

Therein, σᵤ, σᵥ, σₛ, σ_{c}, σ_{s′} and σ_{c′} may be spin observables associated with logical variables u, v, s, c, s′ and c′, respectively. The spin observables may be classical spins or quantum observables. The logical variables u, v, s and c may be input variables of the AND.FA gate and the logical variables s′ and c′ may be output variables of the AND.FA gate.

According to a further embodiment, a quantum computational method of performing prime factorization of an integer is provided. The quantum computational method includes determining a logic gate circuit including logic gates, the logic gate circuit being configured to compute a multiplication function having, as an output, the integer. The quantum computational method includes providing a quantum system comprising constituents. The quantum computational method includes determining a first set of short-range quantum interactions of the constituents based on the logic gates. The determining comprises, for each logic gate of the logic gates, determining a subset of constituents associated with the logic gate and encoding the logic gate in short-range quantum interactions of the subset of constituents. The quantum computational method includes determining a second set of short-range quantum interactions of the constituents based on the integer. The quantum computational method includes evolving the quantum system, including implementing the first set of short-range quantum interactions and the second set of short-range quantum interactions. The quantum computational method includes measuring at least a portion of the quantum system to obtain a read-out. The quantum computational method includes determining a prime factor of the integer based on the read-out. The quantum computational method of performing prime factorization of an integer may include any of the features or aspects described in relation to the quantum computational methods described herein.

The quantum computational method may include, for each logic gate of the logic gates, determining a gate-encoding Hamiltonian from the logic gate. The gate-encoding Hamiltonian may encode an input-output relation of the logic gate and may be a sum of summand Hamiltonians. Each summand Hamiltonian may be associated with a respective constituent of the subset of constituents associated with the logic gate.

The quantum system may include local subsystems each including a subset of the constituents, as described herein. For each logic gate of the logic gates, the gate-encoding Hamiltonian determined from the logic gate may be associated with a local subsystem. The local subsystem may include the subset of constituents associated with the logic gate.

For each logic gate of the logic gates, encoding the logic gate in short-range quantum interactions of the subset of constituents may include determining single-body interactions, as described herein, from the gate-encoding Hamiltonian determined from the logic gate. The determined single-body interactions may be representable by a single-body quantum Hamiltonian acting inside the subset of constituents associated with the logic gate.

For each logic gate of the logic gates, encoding the logic gate in short-range quantum interactions of the subset of constituents may include determining one or more constraint interactions, as described herein, from the gate-encoding Hamiltonian determined from the logic gate. The determined constraint interactions may be representable by a constraint Hamiltonian acting inside the subset of constituents associated with the logic gate.

According to a further embodiment, a fundamental subroutine of, or for, a quantum computation operating with a quantum system including constituents is provided. The fundamental subroutine includes determining an elementary subsystem of the quantum system including at least four of the constituents. Each summand Hamiltonian of the gate-encoding Hamiltonian H_{AND} defined by

$${H}_{AND} = - {σ}_{s} - {σ}_{u} {σ}_{s} - {σ}_{v} {σ}_{s} + {σ}_{u} {σ}_{v} {σ}_{s}$$

is associated with a respective constituent of the elementary subsystem. The gate-encoding Hamiltonian H_{AND} encodes an input-output relation of an AND gate having logical variables u and v as input variables and a logical variable s as an output variable. Therein, σᵤ, σᵥ and σₛ are spin observables associated with the logical variables u, v and s, respectively. The fundamental subroutine includes determining short-range quantum interactions for the elementary subsystem from the gate-encoding Hamiltonian H_{AND}. The fundamental subroutine includes evolving the quantum system, including implementing the determined short-range quantum interactions in the elementary subsystem. The fundamental subroutine may include, or be combined with, any of the features or aspects described in relation to the quantum computational methods described above.

The elementary subsystem may be a local subsystem as described herein. Determining the short-range quantum interactions for the elementary subsystem may include determining single-body interactions from the gate-encoding Hamiltonian H_{AND}. The determined single-body interactions may be representable by a single-body Hamiltonian acting inside the local subsystem. Each summand Hamiltonian of the gate-encoding Hamiltonian H_{AND} may have an interaction coefficient. The interaction coefficient may be mapped to a single-body interaction. The single body interaction may be a function of the interaction coefficient. Implementing the determined short-range quantum interactions in the elementary subsystem may include implementing the determined single-body interactions. Determining the short-range quantum interactions for the elementary subsystem may include determining one or more constraint interactions from the gate-encoding Hamiltonian H_{AND}. The determined one or more constraint interactions may be representable by a constraint Hamiltonian acting inside the local subsystem. Implementing the determined short-range quantum interactions in the elementary subsystem may include implementing the determined one or more constraint interactions.

According to a further embodiment, a fundamental subroutine of, or for, a quantum computation operating with a quantum system including constituents is provided. The fundamental subroutine includes determining an elementary subsystem of the quantum system including at least eight of the constituents. Each summand Hamiltonian of the gate-encoding Hamiltonian H_{AND.FA} defined by

$${H}_{AND . FA} = - {σ}_{s} {σ}_{c} {σ}_{{s}^{′}} - {σ}_{u} {σ}_{s} {σ}_{c} {σ}_{{s}^{′}} - {σ}_{v} {σ}_{s} {σ}_{c} {σ}_{{s}^{′}} + {σ}_{u} {σ}_{v} {σ}_{s} {σ}_{c} {σ}_{{s}^{′}} - {σ}_{s} {σ}_{c} {σ}_{{s}^{′}} {σ}_{{c}^{′}} - {σ}_{s} {σ}_{{c}^{′}} - {σ}_{c} {σ}_{{c}^{′}} + {σ}_{{s}^{′}} {σ}_{{c}^{′}} .$$

is associated with a respective constituent of the elementary subsystem. The gate-encoding Hamiltonian H_{AND.FA} encodes an input-output relation of an AND.FA gate having logical variables u, v, s and c as input variables and logical variables s′ and c′ as output variables. Therein, σᵤ, σᵥ, σₛ, σ_{c}, σₛ′ and σ_{c}′ are spin observables associated with the logical variables u, v, s, c, s′ and c′, respectively. The fundamental subroutine includes determining short-range quantum interactions for the elementary subsystem from the gate-encoding Hamiltonian H_{AND.FA}. The fundamental subroutine includes evolving the quantum system, including implementing the determined short-range quantum interactions in the elementary subsystem. The fundamental subroutine may include, or be combined with, any of the features or aspects described in relation to the quantum computational methods described above.

The elementary subsystem may be a local subsystem as described herein. Determining the short-range quantum interactions for the elementary subsystem may include determining single-body interactions from the gate-encoding Hamiltonian H_{AND.FA}. The determined single-body interactions may be representable by a single-body Hamiltonian acting inside the local subsystem. Each summand Hamiltonian of the gate-encoding Hamiltonian H_{AND.FA} may have an interaction coefficient. The interaction coefficient may be mapped to a single-body interaction. The single body interaction may be a function of the interaction coefficient. Implementing the determined short-range quantum interactions in the elementary subsystem may include implementing the determined single-body interactions. Determining the short-range quantum interactions for the elementary subsystem may include determining one or more constraint interactions from the gate-encoding Hamiltonian H_{AND.FA}. The determined one or more constraint interactions may be representable by a constraint Hamiltonian acting inside the local subsystem. Implementing the determined short-range quantum interactions in the elementary subsystem may include implementing the determined one or more constraint interactions.

According to a further embodiment, a method of performing a quantum computation is provided. The method includes providing a quantum system comprising constituents. The method includes performing one or more fundamental subroutines as described herein, for example one or more fundamental subroutines involving the AND gate and/or one or more fundamental subroutines involving the AND.FA gate. The method includes measuring at least a portion of the quantum system to obtain a read-out.

According to an embodiment, a quantum computational method of inverting a logic gate circuit including logic gates is provided. The quantum computational method includes providing an output of the logic gate circuit that corresponds to an unknown input of the logic gate circuit. The quantum computational method includes determining gate-encoding Hamiltonians, one for each logic gate of the logic gates, wherein each gate-encoding Hamiltonian encodes an input-output relation of a logic gate of the logic gates and is a sum of summand Hamiltonians. The quantum computational method includes providing a quantum system comprising constituents, wherein each summand Hamiltonian of each gate-encoding Hamiltonian of the gate-encoding Hamiltonians is associated with a respective constituent of the quantum system. The quantum computational method includes determining a first set of short-range quantum interactions of the constituents based on the logic gates of the logic gate circuit. The quantum computational method includes determining a second set of short-range quantum interactions of the constituents based on the output of the logic gate circuit. The quantum computational method includes evolving the quantum system, including implementing the first set of short-range quantum interactions and the second set of short-range quantum interactions. The quantum computational method includes measuring at least a portion of the quantum system to obtain a read-out. The quantum computational method includes determining the unknown input of the logic gate circuit based on the readout. The quantum computational method may include any of the features or aspects described in relation to the quantum computational methods described above. The quantum computational method may be a method of performing prime factorization of an integer. The logic gate circuit may be configured to compute a multiplication function having, as an output, the integer. Determining the unknown input based on the read-out, as described herein, may include determining a prime factor of the integer.

According to a further embodiment, an apparatus for performing prime factorization of an integer is provided. The apparatus includes a classical computing system. The apparatus includes a quantum system comprising constituents. The apparatus includes a quantum processing unit. The apparatus includes a measurement unit. The classical computing system is configured for determining a logic gate circuit including logic gates, the logic gate circuit being configured to compute a multiplication function having, as an output, the integer. The classical computing system is configured for determining gate-encoding Hamiltonians, one for each logic gate of the logic gates, wherein each gate-encoding Hamiltonian encodes an input-output relation of a logic gate of the logic gates and is a sum of summand Hamiltonians, wherein each summand Hamiltonian of each gate-encoding Hamiltonian of the gate-encoding Hamiltonians is associated with a respective constituent of the quantum system. The classical computing system is configured for determining a first set of short-range quantum interactions of the constituents based on the logic gates of the logic gate circuit. The classical computing system is configured for determining a second set of short-range quantum interactions of the constituents based on the integer. The quantum processing unit is configured for evolving the quantum system, including implementing the first set of short-range quantum interactions and the second set of short-range quantum interactions. The measurement unit is configured for measuring at least a portion of the quantum system to obtain a read-out. The classical computing system is further configured for determining a prime factor of the integer based on the read-out. The apparatus may be configured for performing a quantum computational method, or parts thereof, according to any of the embodiments described herein. The features and aspects described above in relation to the quantum computational methods are also applicable to embodiments of the apparatus.

A quantum processing unit as described herein may include a cooling system for cooling the quantum system. The quantum processing unit may be configured for performing an adiabatic evolution of the quantum system. The quantum processing unit may be configured for performing a counter-diabatic evolution of the quantum system. The quantum processing unit may be configured for performing a unitary evolution of the quantum system. The quantum processing unit may be configured for any combination of the preceding aspects.

According to a further embodiment, an apparatus for performing prime factorization of an integer is provided. The apparatus includes a classical computing system. The apparatus includes a quantum system comprising constituents. The apparatus includes a quantum processing unit. The apparatus includes a measurement unit. The classical computing system is configured for determining a logic gate circuit including logic gates, the logic gate circuit being configured to compute a multiplication function having, as an output, the integer. The classical computing system is configured for determining a first set of short-range quantum interactions of the constituents based on the logic gates. The determining comprises, for each logic gate of the logic gates, determining a subset of constituents associated with the logic gate and encoding the logic gate in short-range quantum interactions of the subset of constituents. The classical computing system is configured for determining a second set of short-range quantum interactions of the constituents based on the integer. The quantum processing unit is configured for evolving the quantum system, including implementing the first set of short-range quantum interactions and the second set of short-range quantum interactions. The measurement unit is configured for measuring at least a portion of the quantum system to obtain a read-out. The classical computing system is further configured for determining a prime factor of the integer based on the read-out. The apparatus may be configured for performing a quantum computational method, or parts thereof, according to any of the embodiments described herein. The features and aspects described above in relation to the quantum computational methods are also applicable to embodiments of the apparatus.

According to a further embodiment, a component for performing a fundamental subroutine of a quantum computation operating with a quantum system including constituents is provided. The component includes a classical computing system. The component includes an elementary subsystem of the quantum system including at least four of the constituents, wherein each summand Hamiltonian of the gate-encoding Hamiltonian H_{AND} defined by H_{AND}=−σₛ−σᵤ σₛ−σᵥ σₛ+σᵤ σᵥ σₛ is associated with a respective constituent of the elementary subsystem, wherein the gate-encoding Hamiltonian H_{AND} encodes an input-output relation of an AND gate having logical variables u and v as input variables and a logical variable s as an output variable, wherein σᵤ, σᵥ and σₛ are spin observables associated with the logical variables u, v and s, respectively. The component includes a quantum processing unit. The classical computing system is configured for determining short-range quantum interactions for the elementary subsystem from the gate-encoding Hamiltonian H_{AND}. The quantum processing unit is configured for evolving the quantum system, including implementing the determined short-range quantum interactions in the elementary subsystem. The component may be configured for performing a fundamental subroutine according to embodiments described herein.

According to a further embodiment, a component for performing a fundamental subroutine of a quantum computation operating with a quantum system including constituents is provided. The component includes a classical computing system. The component includes an elementary subsystem of the quantum system including at least eight of the constituents, wherein each summand Hamiltonian of the gate-encoding Hamiltonian H_{AND.FA} defined by

$${H}_{AND . FA} = - {σ}_{s} {σ}_{c} {σ}_{{s}^{′}} - {σ}_{u} {σ}_{s} {σ}_{c} {σ}_{{s}^{′}} - {σ}_{v} {σ}_{s} {σ}_{c} {σ}_{{s}^{′}} + {σ}_{u} {σ}_{v} {σ}_{s} {σ}_{c} {σ}_{{s}^{′}} - {σ}_{s} {σ}_{c} {σ}_{{s}^{′}} {σ}_{{c}^{′}} - {σ}_{s} {σ}_{{c}^{′}} - {σ}_{c} {σ}_{{c}^{′}} + {σ}_{{s}^{′}} {σ}_{{c}^{′}}$$

is associated with a respective constituent of the elementary subsystem, wherein the gate-encoding Hamiltonian H_{AND.FA} encodes an input-output relation of an AND.FA gate having logical variables u, v, s and c as input variables and logical variables s′ and c′ as output variables, wherein σᵤ, σᵥ, as, σ_{c}, σₛ′ and σ_{c}′ are spin observables associated with the logical variables u, v, s, c, s′ and c′, respectively. The component includes a quantum processing unit. The classical computing system is configured for determining short-range quantum interactions for the elementary subsystem from the gate-encoding Hamiltonian H_{AND.FA}. The quantum processing unit is configured for evolving the quantum system, including implementing the determined short-range quantum interactions in the elementary subsystem. The component may be configured for performing a fundamental subroutine according to embodiments described herein.

According to a further embodiment, an apparatus for inverting a logic gate circuit including logic gates is provided. The apparatus includes a classical computing system. The apparatus includes a quantum system comprising constituents. The apparatus includes a quantum processing unit. The apparatus includes a measurement unit. The classical computing system is configured for providing an output of the logic gate circuit that corresponds to an unknown input of the logic gate circuit. The classical computing system is configured for determining gate-encoding Hamiltonians, one for each logic gate of the logic gates, wherein each gate-encoding Hamiltonian encodes an input-output relation of a logic gate of the logic gates and is a sum of summand Hamiltonians, wherein each summand Hamiltonian of each gate-encoding Hamiltonian of the gate-encoding Hamiltonians is associated with a respective constituent of the quantum system. The classical computing system is configured for determining a first set of short-range quantum interactions of the constituents based on the logic gates of the logic gate circuit. The classical computing system is configured for determining a second set of short-range quantum interactions of the constituents based on the output of the logic gate circuit. The quantum processing unit is configured for evolving the quantum system, including implementing the first set of short-range quantum interactions and the second set of short-range quantum interactions. The measurement unit is configured for measuring at least a portion of the quantum system to obtain a read-out. The classical computing system is further configured for determining the unknown input of the logic gate circuit based on the readout. The apparatus may be configured for performing a quantum computational method, or parts thereof, according to any of the embodiments described herein. The features and aspects described above in relation to the quantum computational methods are also applicable to embodiments of the apparatus.

### Further Aspects

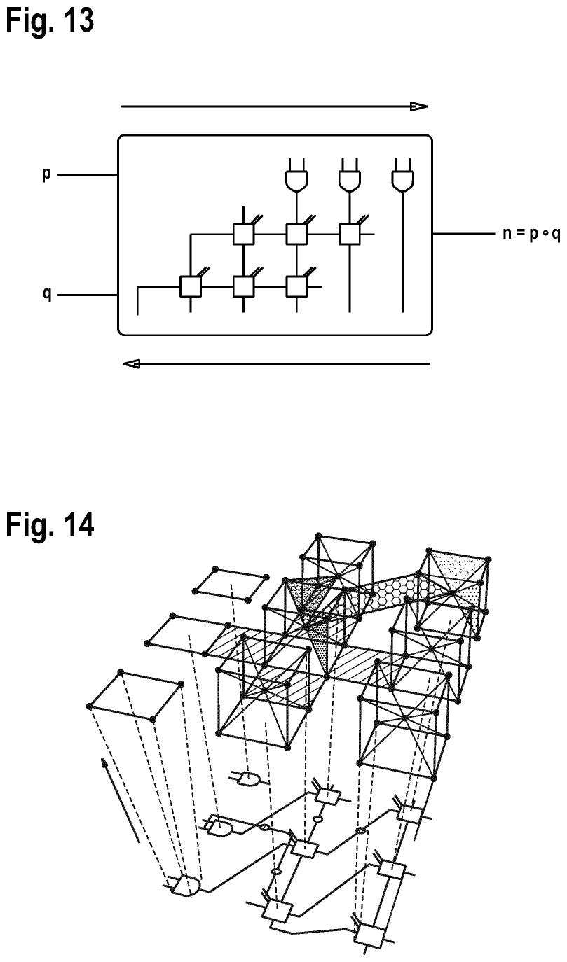

Further aspects are described in the following in relation to FIGS. 13 to 20.

FIG. 13 illustrates a multiplication circuit as described herein. Factoring (prime factorization) can be regarded as running the multiplication circuit in reverse. The arrow from left to right indicates multiplication, the reverse arrow indicates factoring. The logic gates (AND gates, AND.FA gates) of the multiplication circuit, which are irreversible gates, are mapped to the corresponding gate-encoding Hamiltonians. The latter Hamiltonians provide a reversible encoding of the logic gates, since the input-output relation (truth table) of each logic gate is encoded into the ground space of the corresponding gate-encoding Hamiltonian. The reversible encoding allows inverting the multiplication circuit.

FIG. 14 illustrates a method according to embodiments described herein. At the bottom of FIG. 14, a multiplication circuit consisting of AND gates and AND.FA gates is shown. The multiplication circuit is mapped to a quantum system shown at the top of the figure. Each AND gate is mapped to a local subsystem consisting of four qubits forming a plaquette. Each AND.FA gate is mapped to a local subsystem consisting of nine qubits forming a body-centered cube. A short-range quantum Hamiltonian H_{AND}^{SR} and H_{AND.FA}^{SR} acts on each local subsystem. The local subsystems are coupled using gate interconnection Hamiltonians and common variable Hamiltonians, some of which are illustrated in FIG. 14 by respective triangles and quadrangles.

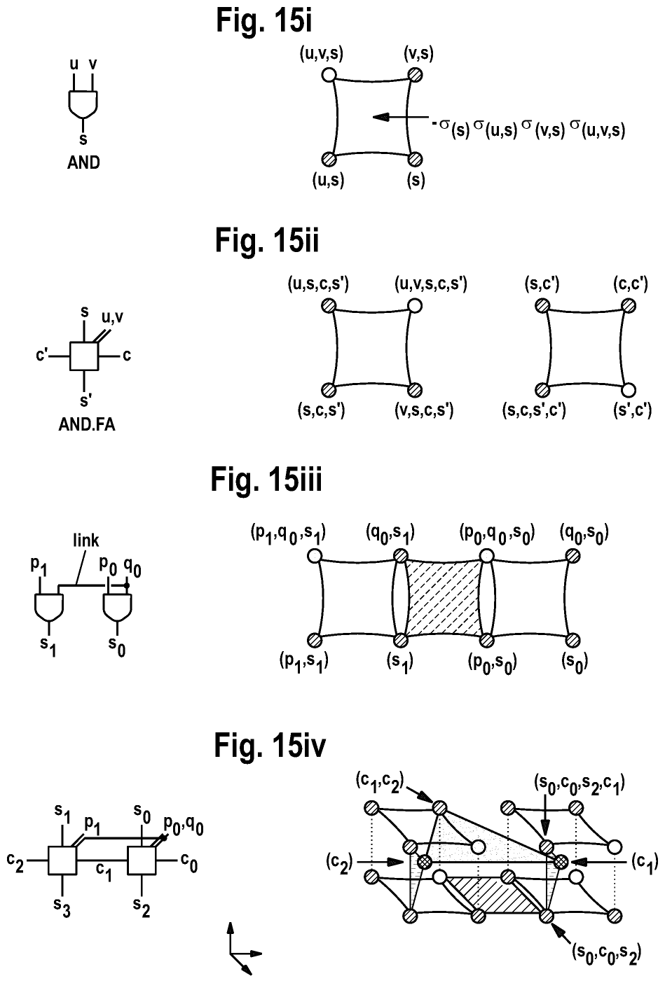

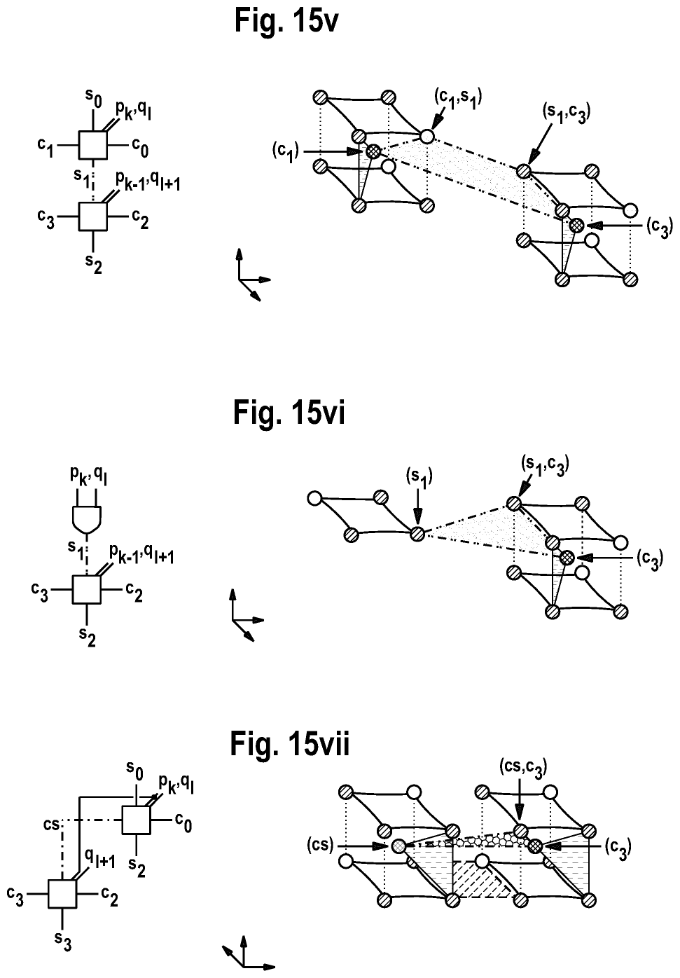

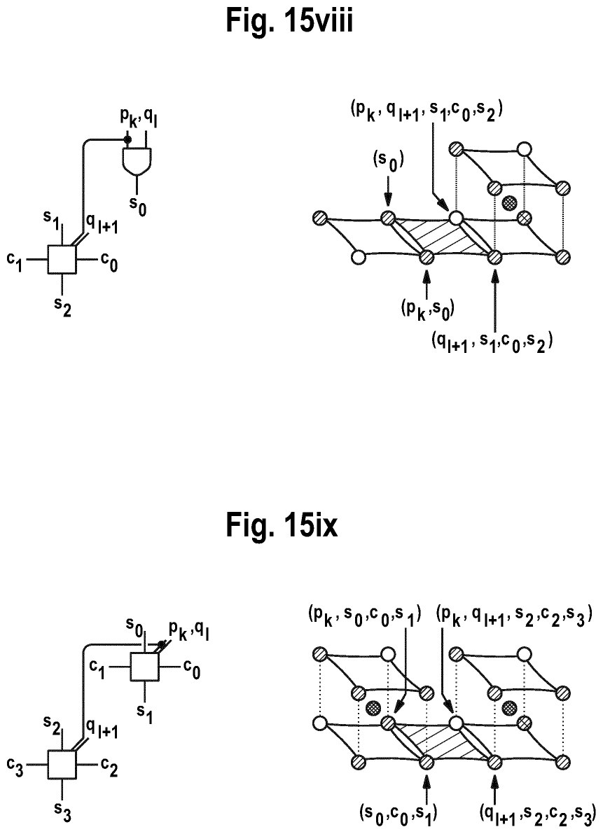

FIG. 15(i) shows an AND gate (left) and an associated local subsystem (right) of the quantum system. The local subsystem consists of four qubits arranged at the corners of a plaquette. A short-range quantum Hamiltonian H_{AND}^{SR} may act on the local subsystem. The Hamiltonian H_{AND}^{SR} is a sum of a single-body Hamiltonian and a constraint Hamiltonian. The single-body Hamiltonian is a sum of Pauli σ_{Z} operators with coefficients +1 or −1 (interaction coefficients). The coefficients +1 and −1 are indicated by white circles and dashed circles, respectively. The constraint Hamiltonian is a 4-body Hamiltonian that is given by a tensor product of Pauli σ_{Z} operators acting on the four qubits of the plaquette, provided with a coefficient (such as −k, with k a positive number). The constraint Hamiltonian is indicated by the shape formed by the four solid lines connecting the four qubits.

FIG. 15(ii) shows an AND.FA gate (left) and an associated local subsystem (right) of the quantum system. The local subsystem includes eight qubits (primary qubits). In FIG. 15(ii), two groups of four qubits are shown, each qubit of a group being arranged at the corners of a respective plaquette. The plaquette on the left is the “sum plaquette”, the plaquette on the right is the “carry plaquette”. The two plaquettes may be stacked on top of each other to form a cube, with the sum plaquette being the bottom plaquette of the cube. A short-range quantum Hamiltonian H_{AND.FA}^{SR} may act on the local subsystem. The Hamiltonian H_{AND.FA}^{SR} is a sum of a single-body Hamiltonian and a constraint Hamiltonian. The single-body Hamiltonian is a sum of Pauli σ_{Z} operators with coefficients +1 or −1 (interaction coefficients). The coefficients +1 and −1 are indicated by white circles and dashed circles, respectively. The constraint Hamiltonian is a 4-body Hamiltonian that is given by a sum of two terms, namely a first term that is tensor product of Pauli σ_{Z} operators acting on the sum plaquette (provided with a coefficient), and a second term that is tensor product of Pauli σ_{Z} operators acting on the carry plaquette (also provided with a coefficient). The first term of the constraint Hamiltonian is indicated by the lines connecting the four qubits of the sum plaquette. The second term is indicated by the lines connecting the four qubits of the carry plaquette.

FIG. 15(iii) shows two AND gates (left) and the two associated local subsystems (right), each local subsystem being shown as a group of four qubits arranged on a plaquette. The two AND gates have a common variable q₀, which reflected in the quantum system by the presence of a common variable Hamiltonian coupling the two local subsystems. The common variable Hamiltonian is indicated by the hatched region. The common variable Hamiltonian is a 4-body tensor product of Pauli σ_{Z} operators (possibly with a coefficient) that act on two qubits of the local subsystem associated with the first AND gate (plaquette on the left) and on two qubits of the local subsystem associated with the second AND gate (plaquette on the right).

FIG. 15(iv) shows two AND.FA gates that have a common variable q₀. Further, an interconnection exists between the two gates, namely the variable c₁ is both an output variable of one AND.FA gate and an input variable of the other AND.FA gate. FIG. 15(iv) further shows the two associated local subsystems, each local subsystem consisting of eight qubits (primary qubits) arranged at the corners of a cube and an additional qubit (secondary qubit, carry qubit) at the center of the cube, i.e. each local subsystem has the shape of a body-centered cube. The common variable q₀ is reflected by the presence of a common variable Hamiltonian coupling the two local subsystems. The common variable Hamiltonian is indicated by the hatched quadrangle. The common variable Hamiltonian is a 4-body tensor product of Pauli σ_{Z} operators (possibly with a coefficient) that act on two qubits of the sum plaquette of the local subsystem associated with the first AND.FA gate and on two qubits of the sum plaquette of the local subsystem associated with the second AND gate. The interconnection relating to the variable c₁ is reflected by a gate interconnection Hamiltonian coupling the two local subsystems. The gate interconnection Hamiltonian is a 3-body Hamiltonian that is a sum of three terms, i.e. a first term, a second term and a third term. The first term is a tensor product of three Pauli σ_{Z} operators (possibly with a coefficient) that act on the two secondary qubits (carry qubits) and on a primary qubit of a first local subsystem of the two local subsystems. The second term is a tensor product of three Pauli σ_{Z} operators (possibly with a coefficient) that act on two further primary qubits and on the secondary qubit of the first local system. The third term is analogous to the second term, but applied to the second local subsystem. The first, second and third term are indicated by respective triangles.

FIG. 15(v) shows two AND.FA gates between which an interconnection exists, wherein the variable s₁ is both an output variable of one AND.FA gate and an input variable of the other AND.FA gate. FIG. 15(v) further shows the two associated local subsystems, each local subsystem being a body-centered cube as described above. The gate interconnection relating to the variable s₁ is reflected by a gate interconnection Hamiltonian coupling the two local subsystems. The gate interconnection Hamiltonian is a 4-body Hamiltonian that is a sum of three terms, i.e. a first term, a second term and a third term. The first term is a tensor product of four Pauli σ_{Z} operators (possibly with a coefficient) that acts on the respective secondary qubit (carry qubit) and on one respective primary qubit of each of the two local subsystems. The second term is a tensor product of three Pauli σ_{Z} operators (possibly with a coefficient) that act on two further primary qubits and the secondary qubit of the first local system. The third term is analogous to the second term, but applied to the second local subsystem. The first term is indicated by a quadrangle and the second and third terms are indicated by triangles.

FIG. 15(vi) shows an AND gate that is connected to an AND.FA gate, wherein the variable s₁ is both an output variable of the AND gate and an input variable of the AND.FA gate. FIG. 15(vi) further shows the two associated local subsystems, namely a plaquette associated with the AND gate and a body-centered cube associated with the AND.FA gate. The gate interconnection relating to the variable s₁ is reflected by a gate interconnection Hamiltonian coupling the two local subsystems. The gate interconnection Hamiltonian is a 3-body Hamiltonian that is a sum of a first term and a second term. The first term is a tensor product of three Pauli σ_{Z} operators (possibly with a coefficient) that act on a qubit of the local subsystem associated with the AND gate and on a primary qubit and the secondary qubit (carry qubit) of the local subsystem associated with the AND.FA gate. The second term is a tensor product of three Pauli σ_{Z} operators (possibly with a coefficient) that act on the secondary qubit and two further primary qubits of the body-centered cube. The first term and the second term are indicated by respective triangles.

FIG. 15(vii) shows two AND.FA gates between which a gate interconnection exists, wherein the variable cs is both an output variable of one AND.FA gate and an input variable of the other AND.FA gate. Further, pₖ is a common input variable of both AND.FA gates. FIG. 15(vii) further shows the two associated local subsystems, each local subsystem being a body-centered cube as described above. The gate interconnection is reflected by a gate interconnection Hamiltonian coupling the two local subsystems. The gate interconnection Hamiltonian is a 3-body Hamiltonian that is a sum of three terms, i.e. a first term, a second term and a third term. The first term is a tensor product of three Pauli σ_{Z} operators (possibly with a coefficient) that act on the two secondary qubits (carry qubits) and on one primary qubit of the second local subsystem. The second term is a tensor product of three Pauli σ_{Z} operators (possibly with a coefficient) that act on two primary qubits and the secondary qubit of the first local system. The third term is analogous to the second term, but applied to the second local subsystem. The first, second and third term are indicated by respective triangles. The common variable is reflected by a common variable Hamiltonian coupling the two local subsystems. The common variable Hamiltonian is a 4-body Hamiltonian consisting of a single term, namely a tensor product of four Pauli σ_{Z} operators (possibly with a coefficient) that act on two respective primary qubits of each local subsystem. The common variable Hamiltonian is indicated by a quadrangle.

FIG. 15(viii) shows an AND gate and an AND.FA gate that have a common variable pₖ. FIG. 15(viii) further shows the two associated local subsystems, namely a first local subsystem forming a plaquette and a second local subsystem forming a body centered cube. The common variable is reflected by a common variable Hamiltonian coupling the two local subsystems. The common variable Hamiltonian is a 4-body Hamiltonian, namely a tensor product of four Pauli σ_{z} operators (possibly with a coefficient) that act on two respective primary qubits of each local subsystem. The common variable Hamiltonian is indicated by a hatched quadrangle.

FIG. 15(ix) shows two AND.FA gates that have a common variable pₖ. FIG. 15(ix) further shows the two associated local subsystems, namely a first local subsystem and a second local subsystem each forming a body centered cube. The common variable is reflected by a common variable Hamiltonian coupling the two local subsystems. The common variable Hamiltonian is a 4-body Hamiltonian, namely a tensor product of four Pauli σ_{Z} operators (possibly with a coefficient) that act on two respective primary qubits of each local subsystem. The common variable Hamiltonian is indicated by a hatched quadrangle.

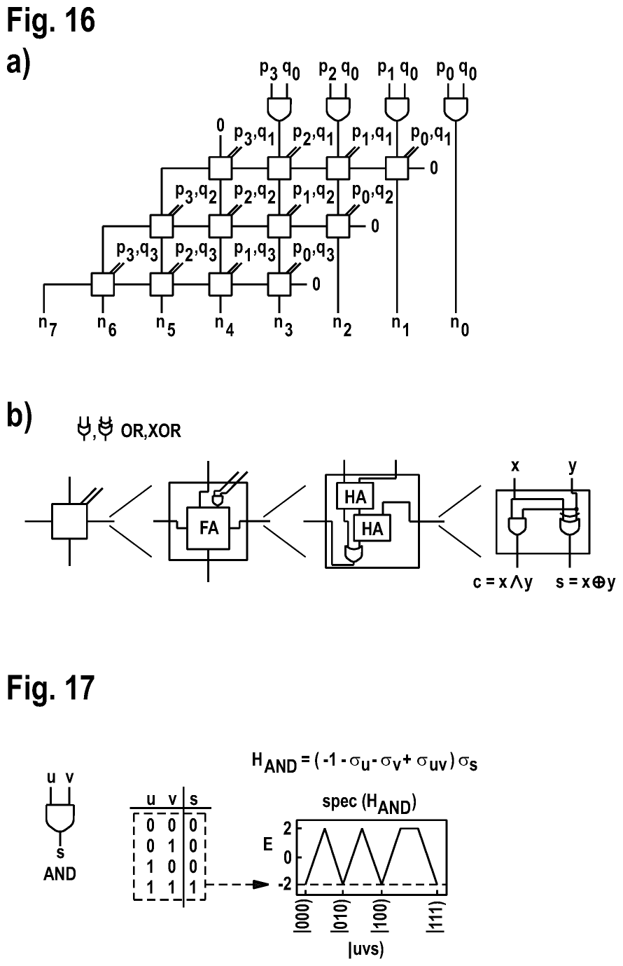

FIG. 16(a) illustrates a multiplication circuit consisting of AND gates and AND.FA gates as described herein. The lines between the gates represent gate interconnections as described herein. Specifically, lines emanating horizontally from the AND.FA gates represent carry operations of the multiplication. Vertical lines represent sum operations. Since pᵢqⱼ=pᵢ \hat{ } qⱼ, the partial products pᵢqⱼ can be formed by application of an AND gate. One way to sum them up, is to make use of Full-Adders arranged on a 2D array. The gates share common input variables, as the variables pᵢ and qⱼ repeat vertically or horizontally respectively.

FIG. 16(b) schematically shows the internal structure of an AND.FA gate with increasing level of detail from left to right. The first schematic in FIG. 16(b) is a representation of the AND.FA gate. The second schematic shows that an AND.FA gate can be formed as an elementary logic gate circuit involving an AND gate and a full adder (FA) gate. The third schematic shows that an FA gate can be formed as an elementary logic gate circuit involving an OR gate and a two half-adder (HA) gates. The fourth schematic shows that a HA gate can be formed as an elementary logic gate circuit involving an AND gate and an XOR gate.

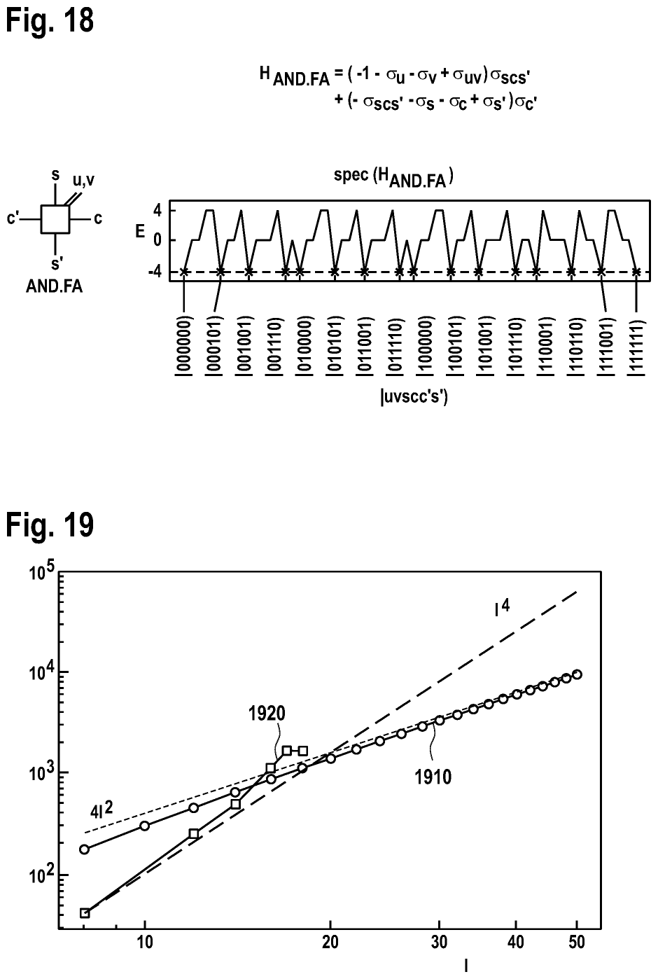

FIGS. 17 and 18 illustrate the gate-encoding Hamiltonians, and their spectrum, associated with the AND gate and the AND.FA gate, respectively.

FIG. 19 shows a comparison of the number of constituents (qubits) needed for performing prime factorization of an integer n by different quantum computing methods. The horizontal axis shows the size of the integer (number of bits) l=└ log₂(n)┘. The vertical axis shows the number of qubits that is needed by each method. Embodiments of the method described herein (graph 1910) use a number of qubits that scales quadratically in 1. In contrast, an approach based on a mapping of the factoring problem to a QUBO problem and thereafter mapping the latter problem onto an annealing hardware scales as O(l⁴) (graph 1920).

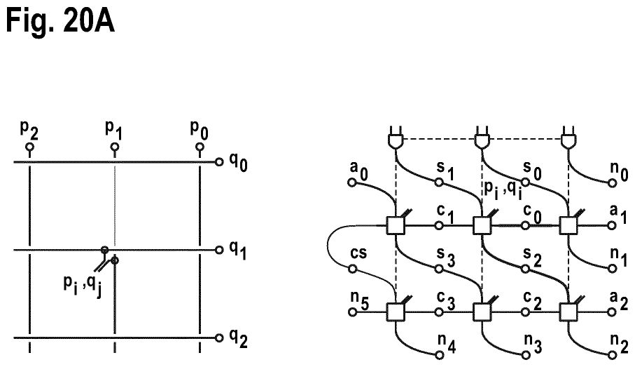

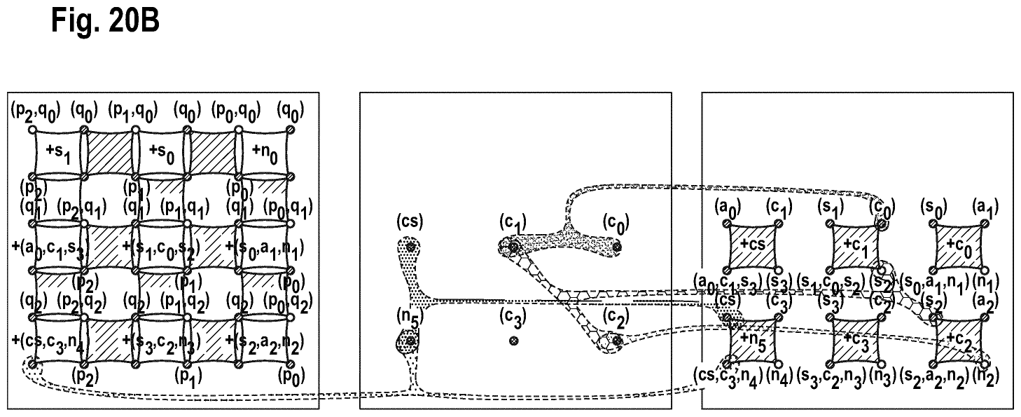

FIG. 20 illustrates the present method based on an example of a 3 bit×3 bit multiplication.

The fundamental asymmetry between the difficulty of integer multiplication and that of integer factorization has become a cornerstone of cryptography and forms the basis of famous protocols such as RSA. From the point of view of complexity theory, it is unlikely that the factoring problem is either NP-Complete or in P (where NP stands for “non-deterministic polynomial time” and P stands for “polynomial time”). Yet, it has been proven that the factoring problem is in the complexity classes NP and BQP (“bounder-error quantum polynomial time”). With Shor's quantum algorithm, it was shown that integer factorization can be performed in polynomial time on a quantum computer, thus providing a (quasi-)exponential speedup compared to all known classical factoring algorithms. Still, due to the extensive requirements as regards the number of qubits and the quality of the quantum gates, Shor's algorithm is still limited to proof-of-concept demonstrations, far away from factoring numbers of sizes used in real-world cryptosystems.

In the present disclosure, a quantum algorithm for integer factorization is provided that is based on a reduction of the factoring problem onto a parity-based spin model. The quantum algorithm uses ο(log²(n)) qubits and interaction strengths ο(1), where n is the integer to be factorized. This is a considerable improvement with respect to the required number of qubits as compared to previous quantum algorithms. In the present quantum algorithm, reversible versions of AND gates and AND.FA gates are constructed using a parity-based encoding. In this encoding, the truth table of each logic gate is encoded in the ground state of a Hamiltonian (the short-range quantum Hamiltonians HG described herein). This makes the gates reversible and the multiplication circuit can be quantum mechanically reversed e.g. by an adiabatic quantum computing protocol. Using intrinsic symmetries of the Hamiltonians HG, a quantum factoring device consisting of elementary building blocks that can be repeated and joined together is provided, and thus a scalable quantum architecture is obtained.

Previous approaches to perform integer factorization on a quantum computer are based on a quadratic unconstrained binary optimization (QUBO) problem involving ο(log²(n)) qubits. To solve the optimization problem using adiabaic quantum computing techniques, the structure of the 2-local Hamiltonian resulting from the QUBO approach, which is a long-range Hamiltonian, must be mapped onto a short-range connectivity graph on available hardware such as the D-WAVE system, e.g. via minor embedding. The latter mapping adds another quadratic overhead in the number of qubits. Accordingly, in such approaches based on a QUBO, ο(log⁴(n)) qubits are needed to perform factoring with a quantum system involving short-range interactions only.

In comparison, according to embodiments described herein, the logic of a binary multiplication circuit is implemented directly i.e. without mapping to a QUBO problem, so that factoring can be performed with short-range quantum interactions only using ο(log²(n)) qubits, which results in a quadratic improvement in the number of qubits needed.

A Boolean circuit (multiplication circuit) that takes as input the binary representations of two integers p, q and outputs a binary representation of their product n can be provided. As shown in FIG. 16, we can build up this circuit from AND gates and AND.FA gates. As described herein, short-range quantum Hamiltonians H_{G}^{SR} having a ground space that encodes valid input-output relations of these logic gates can be constructed. With this, the Hamiltonian (first Hamiltonian as described herein)

$${H}_{1} = \sum ( all short - range quantum Hamiltonians {H}_{G}^{SR} ) + \sum ( all gate coupling Hamiltonians ) \qquad ( 1 )$$

has a ground space spanned by quantum states obeying the correct multiplication logic. In order to single out one specific multiplication we may add an additional term Hᵢₙ(p, q) which gives an energy penalty to all quantum states not having p and q as the corresponding inputs. Hence, finding the ground space of the Hamiltonian H_{product}=H₁+Hᵢₙ(p,q) would solve the (easy) task of multiplying the numbers p and q. The same approach is applicable to factorization: the output η can be fixed by adding an additional term H_{out-enc}(n) (output-encoding Hamiltonian/second Hamiltonian as described herein) to the Hamiltonian H₁. This results in a total Hamiltonian H^{TOTAL}=H₁+H_{out-enc}(n) having a ground space that encodes the prime factors p and q of the integer n. These prime factors can be determined by evolving the quantum system to a ground state of H^{TOTAL} and subsequently measuring the quantum system.

The construction of the Hamiltonians H_{G}^{SR} is motivated by aspects relating to the number of resources needed, i.e. the number of qubits and the number of interactions, and by considering scalability. The construction of the Hamiltonians HR is based on a parity encoding which reduces the degree and amount of interactions needed. The resulting total Hamiltonian H^{TOTAL} is a short-range Hamiltonian. The quantum system on which the total Hamiltonian acts consists of unit cells (local subsystems) such that factoring bigger integers can be achieved by adding more of these unit cells. Each of the Hamiltonians H_{G}^{SR} consists of 2 parts: a single-body Hamiltonian (1-body fields) encoding the gate G, and 3- and 4-body terms (forming a constraint Hamiltonian as described herein) adding parity constraints to truncate the Hilbert space by penalizing subspaces. Finally, the desired integer n can be specified by defining H_{out-enc}(n) to be a 2-body nearest-neighbor Hamiltonian. The resulting architecture provides a scalable, short-range and programmable total Hamiltonian whose ground state encodes the prime factors p and q such that n=p·q.

Some notation is introduced. In the following we make repeated use of diagonal quantum Hamiltonians of the form

$$H = {\sum }_{i} {a}_{i} {Z}_{i} + {\sum }_{ij} {a}_{ij} {Z}_{i} {Z}_{j} + {\sum }_{ijk} {a}_{ijk} {Z}_{i} {Z}_{j} {Z}_{k} + \qquad ( 2 )$$

with the Pauli operator Z (or, equivalently, σ_{z}) defined by Z=|0 [symbol] 0|−|1 [symbol] 1| and Zᵢ denotes the operator Z acting on qubit i. Terms such as ZᵢZⱼ and even more compactly Zᵢⱼ, are used as a short hand notation for the tensor product Zᵢ ⊗Zⱼ, where the subscript indicate which spin the operator acts on. Notably, Hamiltonians of the form of Eq. (2) consist of mutually commuting observables and hence correspond to classical Hamiltonians. The corresponding classical Hamiltonians can be obtained by replacing each Pauli operator Zᵢ by a classical spin zᵢ ∈{−1, 1}. Natural numbers n (and similarly p and q) are represented in their binary representation as n=(nᵢ, . . . , n₀) via n=Σᵢnᵢ 2ⁱ and nᵢ ∈{0,1}.

The idea behind ground state spin logic involves embedding a set of bit strings [symbol] ⊆{0,1}^{m} into the ground space of a Hamiltonian [symbol] . Consider, for example, the AND gate which defines four valid bit configurations (u, v, s=u Λv) where u and v are the input variables and s is the output variable of the AND gate, where u, v, s ∈{0,1}. A corresponding Hamiltonian H_{AND} (gate-encoding Hamiltonian) encoding the input-output relation of the AND gate should have the following ground space:

$$ℒ ( {H}_{AND} ) = span \{ \vert 000 〉 , \vert 010 〉 , \vert 100 〉 , \vert 111 〉 \} . \qquad ( 3 )$$

A whole family of Hamiltonians with the ground space of Eq. (3) can be constructed. One particular choice is given by

$${H}_{AND} := ( - 1 - {Z}_{u} - {Z}_{v} + {Z}_{uv} ) {Z}_{s} . \qquad ( 4 )$$

The Hamiltonian H_{AND} of Eq. (4) has some desirable properties. Each of the indices u, v and s occurs an even number of times (after expanding the expression (4), u and v each occur twice and s appears four times). Further, the Hamiltonian H_{AND} consists of only four terms (summand Hamiltonians), which is the minimum number of terms required. Further, the coupling strengths are −1 or 1. Further, the spectrum of H_{AND} takes only two values {−2,2} as shown in FIG. 17.

Using the above approach, a logic gate circuit built from logic gates can be encoded into the ground space of a Hamiltonian. This holds in particular for a logic gate circuit implementing the multiplicative relation between two integers (multiplication circuit). FIG. 16 shows a possibility to create a binary multiplication circuit based on based on AND gates and AND.FA gates. An AND.FA gate is made of a concatenation of an AND gate and a Full Adder (FA) gate, as shown in FIG. 16b. The AND gate implements the binary multiplication of two bits u and v by virtue of the relation uΛv=u·v, and the FA gate maps a sum variable s and a carry variable c (or carry overflow variable) into a new sum variable s′ and new carry variable c′ in a manner such that the following relation is satisfied:

$$s + c + u \cdot v = 2 {c}^{′} + {s}^{′} . \qquad ( 5 )$$

The AND.FA gate is defined by the expression (5). This gate operates on six bits u, v, c, s, c′, s′, four of which are input variables (namely u, v, c, s), so that there are 16 valid input-output configurations in total. These input-output configurations can be encoded into the ground space of a gate-encoding Hamiltonian H_{AND.FA} having 8 terms (i.e. 8 summand Hamiltonians) only:

$${H}_{AND . FA} := ( - 1 - {Z}_{u} - {Z}_{v} + {Z}_{uv} ) {Z}_{{scs}^{′}} + ( - {Z}_{{scs}^{′}} - {Z}_{s} - {Z}_{c} + {Z}_{{s}^{′}} ) {Z}_{{c}^{′}} . \qquad ( 6 )$$

FIG. 18 shows the spectrum of this Hamiltonian. The ground state manifold of H_{AND.FA} has energy −4 while the other states (excited states) have energy 0 or +4. Remarkably, the first four terms (summand Hamiltonians) of the gate-encoding Hamiltonian H_{AND.FA} are very similar to the gate-encoding Hamiltonian H_{AND} for the AND gate from Eq. (4). Instead of having the term Zₛ, there is the product ZₛZ_{c}Zₛ, (denoted for short as Z_{scs′}, in accordance with the notation introduced above). Similar to the AND gate specifying the output variable ‘s’, this part of the Hamiltonian H_{AND.FA} matches the parity of ‘(s, c, s′)’ according to the input on variables ‘u’ and ‘v’ following the logic of an AND gate. Therefore, we call the first four terms of H_{AND.FA} the sum terms, as they do not interact with the carry output ‘c′’. Without the carry terms—the other four terms of H_{AND.FA}—the ground space would be 32-fold degenerate, which allows all possible states without fixing c′. Adding these carry terms removes this degeneracy and divides the ground space by favoring states that implement the correct logic of the AND.FA gate.

Again there is a whole family of Hamiltonians capable of encoding the AND.FA logic, but the above-shown Hamiltonian H_{AND.FA} is desirable, particularly since (after expansion) it contains every index u, v, s, c, c′ and s′ an even number of times.

A gate-encoding Hamiltonian, such as the gate-encoding Hamiltonians H_{AND} and H_{AND.FA} of Eq. (4) and Eq. (6), respectively, is a Hamiltonian defined on a system of qubits labelled by the logical variables of the logic gate in question. For example, H_{AND} is defined on a system of three qubits (since the AND gate has three logical variables) and H_{AND.FA} is defined on a system of six qubits (since the AND.FA gate has six logical variables). We call the qubits on which a gate-encoding Hamiltonian is defined “auxiliary qubits”, and the quantum system formed by the auxiliary qubits the “auxiliary quantum system”. As described herein, the determination of the gate-encoding Hamiltonians is an intermediate classical step, in other words neither the auxiliary qubits nor the interactions represented by the gate-encoding Hamiltonians need to be physically implemented. Rather, the gate-encoding Hamiltonians are mapped to constituents of another quantum system (that does not include the auxiliary qubits), and it is the latter quantum system that will be realized physically. Said quantum system will be called “main quantum system” in the following, to distinguish from the “auxiliary quantum system”. The main quantum system refers to the quantum system recited in the claims and described in the corresponding embodiments set out above.

Specifically, for each term (summand Hamiltonian) of a gate-encoding Hamiltonian, we introduce a qubit (called herein primary constituent, or primary qubit) of the main quantum system. For each summand Hamiltonian of the form c ZᵢZⱼZₖ . . . (with c a coefficient) that acts on auxiliary qubits i, j, k, . . . , the associated qubit of the main quantum system may be labelled by (i, j, k, . . . ). The following condition is imposed:

$$〈 {Z}_{( i , j , k , … )} 〉 = 〈 {Z}_{i} {Z}_{j} {Z}_{k} … 〉 . \qquad ( 7 )$$

Therein, the expectation value on the right is an expectation value of the operator ZᵢZⱼZₖ . . . acting on the auxiliary qubits i, j, k, . . . of the auxiliary quantum system. The expectation value on the left is an expectation value of the operator Z_{(i,j,k, . . . )} acting on the qubit (i,j, k, . . . ) of the main quantum system that is associated with the summand Hamiltonian c ZᵢZⱼZₖ . . . . Eq. (7) defines a mapping, or encoding, from a first quantum state of the auxiliary quantum system to a second quantum state of the main quantum system. According to this encoding, the second quantum state of the main quantum system is |0> if the first quantum state of the auxiliary quantum system has an even number of |1)'s on positions i, j, k, . . . and is |1> otherwise. The second quantum state thus encodes the parity of a given subset of auxiliary qubits i, j, k, . . . in the first quantum state. In that sense, a 2-body term ZᵢZⱼ only discriminates according the relative orientation between the auxiliary qubits i and j such that the subspace spanned by parallel auxiliary qubits (i.e. both auxiliary qubits are in the state |0> or both are in the state |1>) maps onto the state |0> in the main quantum system and the subspace spanned by anti-parallel auxiliary qubits (i.e. one auxiliary qubit is in the state |0> and the other is in the state |1>) is mapped to the state |1> in the main quantum system.

In the case of the AND gate, the Hamiltonian Eq. (4) has four terms. Consequently, we introduce four (primary) qubits (s), (u, s), (v, s) and (u, v, s) of the main quantum system encoding the expectation values of the terms Zₛ, Zᵤ,Zₛ, ZᵥZₛ and ZᵤZᵥZₛ respectively. Under the action of this mapping, the gate-encoding Hamiltonian H_{AND} reduces to a single-body Hamiltonian (sum of local fields). Within the set of four qubits associated with the gate-encoding Hamiltonian H_{AND}, forming a local subsystem of the main quantum system, we denote the subspace of all quantum states that are obtained by applying the mapping defined above by Eq. (7) as the valid subspace of the local subsystem in question. All quantum states in the valid subspace obey the same parity condition, namely

$${Z}_{( s )} {Z}_{( u , s )} {Z}_{( v , s )} {Z}_{( u , v , s )} = {( {Z}_{u} )}^{2} {( {Z}_{v} )}^{2} {( {Z}_{s} )}^{4} = 1. \qquad ( 8 )$$

This is due to the particular choice for the AND gate encoding in the form of Eq. (4), where each logical variable in H_{AND} appears an even number of times and (Zᵢ)²=1 holds in general. Consequently, only every second basis state belongs to the valid subspace. This is understandable, since there are 8 possible bit configurations (u, v, s) i.e. the Hilbert space of three auxiliary qubits is 2³=8 dimensional and we map these to a system with four qubits in the main quantum system, said four qubits having a 16-dimensional Hilbert space. The addition of a penalty term (constraint Hamiltonian) of the form −kZ₍ₛ₎Z_{(u,s)}Z_{(v,s)}Z_{(u,v,s)} splits the set of states of said 4-qubit local subsystem according to their parity and energetically favors the valid subspace. Summarizing, the gate-encoding Hamiltonian is mapped to a short-range quantum Hamiltonian H_{AND}^{SR} acting on a set of four qubits forming a local subsystem of the main quantum system and having the form

$${H}_{AND}^{SR} := {H}_{AND}^{1 - body} + {H}_{AND}^{cons} = - {Z}_{( s )} - {Z}_{( u , s )} - {Z}_{( v , s )} + {Z}_{( u , v , s )} - {kZ}_{( s )} {Z}_{( u , s )} {Z}_{( v , s )} {Z}_{( u , v , s )} \qquad ( 9 )$$

where k>0. The four qubits in question are arranged on a plaquette such that the 4-body penalty term −kZ₍ₛ₎Z_{(u,s)}Z_{(v,s)}Z_{(u,v,s)} is local in a geometrical sense.

The multiplication circuit further includes AND.FA gates. Next it is shown how the H_{AND.FA} gate-encoding Hamiltonian of Eq. (6) can be mapped onto a short-range quantum Hamiltonian H_{AND.FA}^{SR} that has single-body fields acting on 8 qubits (of the main quantum system) arranged on two 4-body plaquettes, each plaquette being equipped with a 4-body parity constraint [see FIG. 15ii]. Since the first 4 terms (summand Hamiltonians) of H_{AND.FA} are conceptually similar to the AND gate encoding, we can assign these terms to four qubits (s, c, s′), (u, s, c, s′), (v, s, c, s′) and (u, v, s, c, s′) (of the main quantum system) arranged on a plaquette with a single-body Hamiltonian −Z_{(s,c,s′)}−Z_{(u,s,c,s′)}−Z_{(v,s,c,s′)}+Z_{(u,v,s,c,s′)} and a corresponding 4-body parity penalty term (constraint Hamiltonian) −kZ_{(s,c,s′)}Z_{(u,s,c,s′)}Z_{(v,s,c,s′)}Z_{(u,v,s,c,s′)} acting on said plaquette. We call this plaquette the sum plaquette. Due to the form of H_{AND.FA}, also each of the other 4 terms of H_{AND.FA} can be identified each with a respective qubit (s, c, s′, c′), (s, c′), (c, c′) and (s′, c′) (of the main quantum system) such that Z_{(s,c,s′,c′)}Z_{(s,c′)}Z_{(c,c′)}Z_{(s′,c′)}=1 if, and only if, the state of these qubits is a “valid” state. It is therefore possible to collect these terms in a second plaquette. We will call it the carry plaquette, made up of 4 qubits on which a single-body Hamiltonian −Z_{(s,c,s′,c′)}−Z_{(s,c′)}−Z_{(c,c′)}+Z_{(s′, c′,)} and a 4-body parity constraint −kZ_{(s,c,s′,c′)}Z_{(s,c′)}Z_{(c,c′)}Z_{(s′,c′)} act [see FIG. 15ii]. Accordingly, the gate-encoding Hamiltonian H_{AND.FA} is mapped to the following short-range Hamiltonian H_{AND.FA}^{SR} acting on a set of eight qubits (s, c, s′), (u, s, c, s′), (v, s, c, s′), (u, v, s, c, s′), (s, c, s′, c′), (s, c′), (c, c′), (s′, c′) arranged on the vertices of a cube:

$${H}_{AND . FA}^{SR} := {H}_{AND . FA}^{1 - body} + {H}_{AND . FA}^{cons} = - {Z}_{( s , c , {s}^{′} )} - {Z}_{( u , s , c , {s}^{′} )} - {Z}_{( v , s , c , {s}^{′} )} + {Z}_{( u , v , s , c , {s}^{′} )} - {Z}_{( s , c , {s}^{′} , {c}^{′} )} - {Z}_{( s , {c}^{′} )} - {Z}_{( c , {c}^{′} )} + {Z}_{( {s}^{′} , {c}^{′} )} - {kZ}_{( s , c , {s}^{′} )} {Z}_{( u , s , c , {s}^{′} )} {Z}_{( v , s , c , {s}^{′} )} {Z}_{( u , v , s , c , {s}^{′} )} - {kZ}_{( s , c , {s}^{′} , {c}^{′} )} {Z}_{( s , {c}^{′} )} {Z}_{( c , {c}^{′} )} {Z}_{( {s}^{′} , {c}^{′} )} \qquad ( 10 )$$

with k>0. In contrast to a direct implementation of H_{AND.FA}, an implementation of H_{AND.FA}^{SR} only needs 1-body fields and two 4-body terms instead of three 2-body, one 3-body, three times a 4-body and one 5-body term. Furthermore, a direct implementation of H_{AND.FA} in order to build the whole multiplication circuit would lead to a long-range Hamiltonian. This comes from the fact that the input variables pᵢ and qⱼ serve as input for a whole row or column of AND.FA gates (see FIG. 16a). In comparison, the method according to embodiments described herein involves short-range interactions only.

The short-range Hamiltonians H_{AND}^{SR} and H_{AND.FA}^{SR} are building blocks that will be used to construct a total Hamiltonian that encodes the multiplication circuit. To achieve this, the Hamiltonians H_{AND}^{SR} and H_{AND.FA}^{SR} have to be connected like bricks, reflecting that outputs of previous gates are inputted in subsequent gates. In addition, the total Hamiltonian shall encode that multiple gates may share the same input. We will show how we can use the short-range Hamiltonians H_{AND}^{SR} and H_{AND.FA}^{SR} and assemble them such that the desired logic is implemented.

We first focus on two adjacent AND gates as they appear in the first row of the multiplication circuit [see FIG. 15iii]. The corresponding inputs are labeled with p₀, q₀ and p₁, q₀. Since q₀ appears twice (as a common input variable of the first and the second AND gate), we only need three qubits to encode the input information instead of four. By identifying these inputs, we ‘lose’ a degree of freedom. In the main quantum system, however, we would still like to encode each AND gate into a respective plaquette of four qubits. The total number of qubits included in the two plaquettes is 8, whereas the number of logical variables of both AND gates is 5 instead of 6, since one of the variables is a common variable. Since 8-5=3, the identification of the two input variables must be compensated for by adding a constraint, penalizing half of the quantum states. If we call s₀ the output of the first AND gate and s₁ the output of the second AND gate, we have so, (q₀,s₀), (p₀,s₀), (p₀, q₀,s₀) as the labels for the qubits on the first plaquette and s₁, (q₀,s₁), (p₁,s₁), (p₁, q₀, s₁) as the labels of the qubits on the second plaquette. That the variable q₀ is a common input variable, i.e. appears in both plaquettes, can be enforced in the quantum system by introducing an additional 4-body Hamiltonian (common variable Hamiltonian) which is formed of four Z operators acting on the qubits (p₀, s₀), (p₀, q₀, s₀) and (s₁), (q₀, s₁), respectively [see FIG. 15iii].

Suppose, for the sake of concreteness but without loss of generality, that p and q are natural numbers that both fit into a register of 1/2 bits. Consequently, the product n=pq has at most l bits. Implementing the corresponding multiplication circuit requires 1/2 AND gates and ½(½-1) AND.FA gates. Without considering the gate interconnections and the common variables, counting only the input and output nodes of the gates, 31(1−1)/2 logical variables are needed to describe the system. However, by connecting these gates and by enforcing that some input variables are common variables in order to implement the multiplication circuit, we need to identify

$${m}_{id} = l ( l - \frac{5}{2} )$$

of these variables [cf. FIG. 16a]. This implies that we have to construct m_{id} additional independent constraints (coupling Hamiltonians) on the main quantum system in order to restrict the Hilbert space by penalizing subspaces spanned by unwanted states.

In the following we present a possible arrangement of the AND and AND.FA local subsystems to design a degenerate stabilizer space spanned by all valid states corresponding to multiplications of ½-bits times ½-bit numbers. The qubits (s), (u, s), (v, s) and (u, v, s) as well as (s, c, s′), (u, s, c, s′), (v, s, c, s′), (u, v, s, c, s′), (s, c, s′, c′), (s, c′), (c, c′), (s′, c′) of the main quantum system that are associated with the terms (summand Hamiltonians) of the gate-encoding Hamiltonians H_{AND}^{SR} and H_{AND.FA}^{SR}, are called the primary qubits of the main quantum system. We arrange the primary qubits according to two layers of a 3D grid and add secondary qubits in the center of the body-centered cubic grid. Using these secondary qubits, we are able to implement the missing m_{id} constraints as 3- or 4-body parity constrains (coupling Hamiltonians) using short-range interactions only. Furthermore, we will show how the degeneracy of the ground space can be split by adding additional constraints encoding the bi-prime n of interest. This isolates (apart from exchanging p and q) a single ground state, which encodes the information of the prime factors n=p·q.

As described above, the first four terms (summand Hamiltonians) in H_{AND.FA} are conceptionally similar to the terms of H_{AND}. This leads to two separate plaquettes—the sum and the carry plaquette. We can arrange the sum plaquettes onto a 2D grid extending the row of plaquettes associated with the AND gates. Since in the layout of the multiplication circuit the input variables p₀, . . . , p_{1/2-1} repeat vertically and q₀, . . . , q_{1/2-1} repeat horizontally [see FIG. 16a], it is possible to arrange these plaquettes such that common variables are always shared by adjacent plaquettes. To account for the common variables, the plaquettes are connected via additional parity constraints (common variable Hamiltonians) [cf. FIGS. 14 and 15]. The missing m_{id}−1(½-1) constraints result from the identification of an output node of one gate with the input node of another gate (gate interconnections).

The whole multiplication circuit can be thought of as being made up of individual AND and AND.FA gates that are interconnected using the following rules:
a) Identify the sum output of an AND gate with a sum input of an AND.FA gate (sum-to-sum). See FIG. 15vi.
b) Connect two AND.FA gates ‘horizontally’ i.e. connect the carry output of one AND.FA gate to the carry input of another AND.FA gate (carry-to-carry). See FIG. 15iv.
c) Connect two AND.FA gates ‘vertically’ by identifying the sum output of the first AND.FA gate with the sum input of the second AND.FA gate (sum-to-sum). See FIG. 15v.
d) Take the carry output of an AND.FA gate and feed it into the sum input of a second AND.FA gate (carry-to-sum). See FIG. 15vii.

We first discuss the case b) and follow the labeling in FIG. 15iv. In addition to the gate interconnection given by the carry variable c₁, the input variable q₀ is a common input variable to both gates.

To construct a first constraint reflecting that q₀ is a common input variable, we arrange the sum plaquettes next to each other and leave space for an additional 4-body plaquette (equipped with a parity penalty term)—similar to the case of two AND gates described in relation to FIG. 15iii.

To construct a second independent constraint reflecting the interconnection given by the carry variable c₁, we place the carry plaquettes on a second layer of the 3D grid—right above their sum plaquette counterpart. We add a secondary qubit, denoted by (c′), placed at the center of each cube formed by the respective 8 qubits and call this secondary qubit (c′) the carry qubit. In order to fix the value of the carry qubit, we note that the terms Z_{scs′}, and Z_{scs},Z_{c}, appearing in H_{AND.FA} only differ by Z_{c′}. Hence, a 3-body parity constraint (gate interconnection Hamiltonian) acting on two primary qubits (s, c, s′) and (s, c, s′, c′) and on the carry qubit (c′) of each cube can be imposed to favour states such that the state of the carry qubit of the cube corresponds to the carry output value c′ of the corresponding AND.FA gate [see FIG. 15iv]. In addition, this constraint corrects the size of the Hilbert space, which increased after the introduction of the carry qubit. After the introduction of the carry qubit, every index appears exactly twice, such that Z_{(c′)}Z_{(s,c,s′)}Z_{(s,c,s′,c′)}=1 iff there exists a valid logical assignment.

Where two AND.FA gates are connected horizontally as shown in FIG. 15iv, the first carry variable c₁ is a repeated variable i.e. is also present in the second pair of plaquettes as (c₁, c₂). If we call c₂ the output carry variable of the second AND.FA gate—whose value is encoded in its corresponding carry qubit—the triple (c₁), (c₂) and (c₁, c₂) allows the introduction of a further parity constraint, namely a 3-body Hamiltonian acting on the carry qubits (c₁), (c₂) of the respective cubes and on the qubit (c₁, c₂) of one of the cubes [see FIG. 15iv].

Further, adding a carry qubit to each cube and adding the corresponding 3-body parity constraint described above allows solving the cases a), c) and d) as well.

As regards case c), following the labeling in FIG. 15v, the variable s₁ denotes the sum output of a first AND.FA gate that also serves as the sum input of a second AND.FA gate. To enforce this gate interconnection, a 4-body parity constraint (product of Z operators) acts on the two carry qubits (c₁) and (c₃) and on the primary qubits labeled with (c₁, s₁) and (s₁, c₃) both in the top layer. This constraint is indicated in FIG. 15v by a quadrangle.

The cases a) and d) are boundary cases, related to the first row of AND gates or the leftmost diagonal of AND.FA gates. FIG. 15vi) illustrates case a). The sum output of an AND gate is directly accessible as there exists a qubit labeled (s₁) in the plaquette of four qubits associated with the AND gate (see FIG. 15i). As shown in FIG. 15vi, this sum output is connected to the sum input of an AND.FA gate. If the corresponding carry output variable is denoted with c₃ we can construct a parity constraint (product of Z operators) acting on the qubits (s₁), (s₁, c₃) and (c₃) as shown in FIG. 15vi. The case d) deals with an overflow to be carried onto the next column, when there is no partial sum yet and we want to add the carry to pₖ·q₁₊₁ with another AND.FA unit as shown in FIG. 15vii. Since, the carry output of the first FA gate, denoted by cs, is identified with the sum input of the next gate, this variable appears in both involved Hamiltonians. Hence, the local subsystem associated with the second AND.FA gate includes a qubit (cs, c₃) which, according to the Hamiltonian H_{AND.FA} corresponds to the combination (s, c′). With this, there is another independent parity constraint (product of Z operators) acting on the qubits (cs), (cs, c₃) and (c₃).

Beside the gate interconnections described above under items a) to d), it must also be enforced that variables pᵢ and qⱼ are common variables according the multiplication circuit shown in FIG. 16a. The case of a variable qᵢ that is a common variable of two AND gates was discussed above, see the discussion relating to FIG. 15iii. The case of a variable qᵢ that is a common variable of two AND.FA gates was discussed above in relation to FIG. 15iv. The case of a variable pⱼ that is a common variable of an AND gate and an AND.FA gate is treated similarly, as illustrated in FIG. 15viii. Further, that a variable pⱼ is a common variable of two AND.FA gates can be enforced in the manner shown in FIG. 15ix. See also FIG. 15vii showing a further case of two AND.FA gates having a common variable pₖ.

The introduction of the additional carry qubits (secondary qubits) is also useful for encoding the desired bi-prime n=n₀n₁n₂ . . . (with nᵢ the bits of n) into the quantum system by means of a suitable output-encoding Hamiltonian. To illustrate this, focus on the 3 bit×3 bit example (see FIG. 20]. Each of the inputs p and q are 3-bit integers, i.e. integers in the range from 0 to 7. Accordingly, the product n=p·q cannot be larger than 7×7=49, which is a 6-bit integer. Thus, without loss of generality we may represent n as a 6-bit integer, i.e. n=n₅n₄ . . . n₀. The lowest significant bit n₀ is the sum output variable of the rightmost AND gate of the multiplication circuit (see FIGS. 1σₐ and 20a). Therefore, n₀ is easy to fix (by a Z operator) since the bit n₀ is present as a primary qubit (no) of the corresponding plaquette. The bit n₁ is a sum output variable of an AND.FA gate (see FIGS. 1σₐ and 20a). The bit n₁ itself is not directly accessible as a corresponding qubit. Yet, denoting by c₀ the carry output variable of the AND.FA gate in question, the carry plaquette of the associated local subsystem has a qubit (n₁, c₀), and (c₀) is the carry qubit of the local subsystem. The relative alignment between these qubits only depends on n₁. Hence, the addition of the 2-local term ±k·σ_{c}_{₀}σ(n₁,c₀) fixes the value n₁ according to the sign of the interaction. Analogous, the parity between (c₂, (n₂, c₂)), (c₃, (n₃, c₃)) and (n₅, (n₄, n₅)) fix the values n₂,n₃ and n₄. The value n₅ is encoded in the auxiliary qubit n₅ and can be fixed by the sign of the local field ±k·σ_{c}_{₅}. As we make repetitive use of the Full-Adder gate, even when there is no previous sum or carry, we have to fix some of the inputs of the AND.FA gate to zero. This is done similar to the case of fixing the outputs values of nᵢ by imposing anti/ferromagnetic interactions on (cs, (a₀, cs)), (c₀, (a₁, c₀)) and (c₂, (a₂, c₂)).

In general, the bits n₀, . . . , n₁ of the integer n appear as output on the rightmost AND.FA gates and the lowest row of AND.FA gates as demonstrated in FIG. 16a. All Half- and Full-Adders are realized with an AND.FA unit. As shown in FIG. 16a, the lowest significant bit no is a sum output variable of an AND gate. Therefore, the bit n₀ is present as a primary qubit (n₀) of the corresponding plaquette. The value of n₀ can thus be encoded into the quantum system by a single-qubit Z operator acting on the qubit (no). Further, as shown in FIG. 16a, the highest significant bit n₁ is a carry output variable of an AND.FA gate. The latter carry output variable is also directly accessible since we introduced the corresponding carry qubit (secondary qubit). The value of n₁ can thus be encoded into the quantum system by a single-qubit Z operator acting on the carry qubit in question. As further shown in FIG. 16a, the bits n₁, . . . , n₁₋₁ are sum output variables of AND.FA gates. Each of these bits can be encoded into the quantum system by a two-body operator (of the form ZZ) between the carry qubit c′ and the qubit (s′, c′) of the respective local subsystem, which in consequence fixes the value of the sum-output s′. Thus, an output-encoding Hamiltonian can be provided which is a sum of the single-body and two-body terms described above. Accordingly, the output-encoding Hamiltonian in question is a two-body Hamiltonian.

As further shown in FIG. 16a), the carry inputs c of the rightmost AND.FA gates may be set to zero (in order to realize the behavior of a Half-Adder with the use of a AND.FA gate). This can again be performed by imposing 2-body constraints (of the form ZZ) between the qubits c′ (carry qubit) and (c, c′) (primary qubit of a carry plaquette).

A multiplication circuit capable of multiplying 1/2 times 1/2 bit numbers produces an output n of size l=[log₂(n)] bits. Such a circuit consists of 1/2 AND gates and 1/2(1/2-1) AND.FA gates. When including the carry qubits forming the middle layer, one needs 1(91−10)/4 qubits to build up the plaquettes. If the multiplication circuit is used to find the factors of an odd bi-prime n=p·q, both p and q have to be odd, so that p₀=q₀=1. This makes the first row of AND gates unnecessary, as AND(u, 1)=u holds. Consequently, −41+2 qubits related to the AND gates can be removed from our count s.t.

$${m}_{phys} = ( 9 {l}^{2} - 26 l + 8 ) / 4$$

indicates the number of qubits required.

The construction described above is optimized (in terms of qubit count) to factor n=p·q such that both factors fit into a register of size l/2. In general, in the factoring decomposition for an arbitrary bi-prime n, a sufficient length of the factors is L, =l=└ log₂(n)┘ and

$${L}_{q} = ⌈ \frac{1}{2} ( l + 1 ) ⌉ - 1.$$

Not knowing the length of the factors in advance is part of the factoring problem. The extreme cases in which one of the factors is very small or when both are equal can be approached classically. Using e.g. simple trial division, factors up to certain threshold size of r bits could be checked. On the other hand, factoring algorithms as Fermat's method perform well if both factors are close in value. When using the RSA protocol, one is interested in making an attack as tough as possible, so one can assume that neither of the factors is small nor of the same size. In order to span this range of possible sizes the circuit must be able to encode the multiplication of (Lₚ−r) bit times L_{q} bit numbers resulting into a l bit number. Without any pre-processing i.e. r=0, the maximal resources needed are approximately

$$\frac{3}{2} {m}_{phys} ( l ) qubits .$$

This leads to an estimate of 3.4 l² qubits.

Table I describes a binary multiplication table. With the binary representation of p and q, the product n=p·q can be rewritten in terms of the bits pᵢ and qⱼ as

$$n = {\sum }_{i , j} {p}_{i} {q}_{j} {2}^{i + j} = {\sum }_{k} ( {\sum }_{i} {p}_{i} {q}_{k - i} ) {2}^{k} .$$

However, the coefficients Σᵢ pᵢ qₖ₋ᵢ in the above expansion cannot be identified with the bits nₖ of the binary representation of n, since Σᵢ pᵢ qₖ₋ᵢ can take values ranging form 0 all the way up to min(k+1, l−k). Collecting the binary products pᵢqᵢ column-wise within Table I according to their associated powers 2^{k} with k=i+j, a set of equations can be derived. The complete set of equations are also called factoring equations, which include carry variables like c₁₂. In the particular case of c₁₂, that variable carries the potential overflow when calculating the sum mod 2 of all terms related to the 2¹ column s.t. q₀p₁+q₁p₀=c₁₂2+n₁. The number of terms in each column of the multiplication table defines the number of carry variables needed. In the worst case, all of them are 1, thus the leading term of the binary expansion of ‘#(terms)’ defines the highest column j such that cᵢⱼ≠0 is required.

TABLE I
Binary multiplication table

| power | 2⁷ | 2⁶ | 2⁵ | 2⁴ | 2³ | 2² | 2¹ | 2⁰ |
|---|---|---|---|---|---|---|---|---|
| p | | | | | p₃ | p₂ | p₁ | p₀ |
| q | | | | | q₃ | q₂ | q₁ | q₀ |
| 1q₀ · p | | | | | q₀p₃ | q₀p₂ | q₀p₁ | q₀p₀ |
| 2q₁ · p | | | | q₁p₃ | q₁p₂ | q₁p₁ | q₁p₀ | |
| 4q₂ · p | | | q₂p₃ | q₂p₂ | q₂p₁ | q₂p₀ | | |
| 8q₃ · p | | q₃p₃ | q₃p₂ | q₃p₁ | q₃p₀ | | | |
| carries | c₆₇ | c₅₆ | c₄₅ | c₃₄ | c₂₃ | c₁₂ | | |
| | c₅₇ | c₄₆ | c₃₅ | c₂₄ | | | | |
| n | n₇ | n₆ | n₅ | n₄ | n₃ | n₂ | n₁ | n₀ |

[symbol]

[symbol]

col₂(p, q, c, n) := q₀p₂ + q₁p₁ + q₂q₂ + c₁₂ − (2c₂₃ + 4c₂₄) − n₂ = 0

According to embodiments described herein, carry variables and sum variables may be introduced for every product pᵢqⱼ appearing in the multiplication table. While the carry variable connects different columns of the table, the sum variable connects different rows—thereby dividing the whole multiplication table into cells. For performing the multiplication of p and q, the sum over all terms in each column is calculated, while balancing the carry variables connecting to higher order columns. Sum variables keep track of the partial sum mod 2, while the carry variables connect only neighbouring columns. It is usual to describe the logic of these individual cells in the language of boolean circuits. The corresponding cells are described by Half Adder (HA) and Full Adder (FA) gates respectively. Given a previous partial sum ‘s’ from the row above and a carry from the previous column ‘c’ the relation

$$s + c + x = 2 {c}^{′} + {s}^{′}$$

defines the new sum s′ and the new carry c′ variables. In the multiplication circuit, each cell x is of the form pᵢqⱼ and can be seen as the logical AND between the variables pᵢ and qⱼ.

As described herein, after the quantum system has been evolved to a ground state of the total Hamiltonian, at least a portion of the quantum system (i.e. the main quantum system) may be measured. For example, all primary qubits (primary constituents) may be measured. Each measurement of a qubit of the main quantum system may be a measurement of the Pauli operator Z, yielding a read-out δ (measurement outcome) which is either 1 or −1. By virtue of the parity mapping described herein (see e.g. Eq. (7)), a Pauli operator Z acting on a primary qubit a=(i, j, k, . . . ) of the main quantum system corresponds to a summand Hamiltonian of a gate-encoding Hamiltonian, the summand Hamiltonian being proportional to a product of Pauli operators Zᵢ Zⱼ Zₖ . . . . The operators Zᵢ, Zⱼ Zₖ, . . . act on qubits i, j, k, . . . , respectively, of the auxiliary quantum system. A variable σᵢ ∈{−1,1} may be assigned to the qubit i of the auxiliary quantum system; a variable σⱼ ∈{−1,1} may be assigned to the qubit j of the auxiliary quantum system; a variable σₖ ∈{−1,1} may be assigned to the qubit k of the auxiliary quantum system; and so on. The variables σᵢ, σⱼ, σₖ . . . represent the possible measurement outcomes of the operators Zᵢ, Zⱼ Zₖ, . . . acting on the qubits i, j, k, . . . , respectively, of the auxiliary quantum. That a measurement of the Pauli operator Z acting on the primary qubit (i, j, k, . . . ) of the main quantum system yields the read-out δ means that that δ=σᵢσⱼσₖ . . . , in other words the read-out δ is the product of the variables σᵢ, σⱼ, σₖ . . . Each measurement outcome of a primary qubit corresponds in this manner to a product of variables assigned to the associated qubits of the auxiliary quantum system under the parity mapping. The task of inverting the parity mapping amounts to determining the set of variables σᵢ, σⱼ, σₖ . . . associated to each qubit of the auxiliary quantum system based on the set of measurement outcomes δ obtained by measuring the primary qubits of the main quantum system. Accordingly, a system of equations of the following form needs be solved:

$${σ}_{{ω}_{1}} = {δ}_{1} , {σ}_{{ω}_{2}} = {δ}_{2} , … , {σ}_{{ω}_{r}} = {δ}_{r} ,$$

Therein, each δₐ ∈{−1,1} denotes a measurement outcome (read-out) obtained by measuring a primary qubit a of the main quantum system, and r is the number of primary. Further, σ_{ω}_{ₐ} is a short-hand notation for the product σ_{ω}_{ₐ}=σ_{ω}_{ₐ₁} σ_{ω}_{ₐ₂} σ_{ω}_{ₐ₃} . . . where σ_{ω}_{ₐ₁} ∈{−1,1} and a1, a2, a3, . . . are the qubits of the auxiliary system that are associated with the primary qubit a under the parity mapping, as described above.

Multiplication of elements from {−1,1} is isomorph to performing an XOR operation (or addition modulo 2) on variables {0,1}. Therefore, with the change of variables sₖ−(1−σₖ)/2 and dᵢ=(1−δᵢ)/2, the above system of equations is equivalent to a second system of equations as follows:

$${s}_{{ω}_{11}} ⊕ {s}_{{ω}_{12}} ⊕ … = {d}_{1} \\ {s}_{{ω}_{21}} ⊕ {s}_{{ω}_{22}} ⊕ … = {d}_{2} \\ ⋮ \\ {s}_{{ω}_{r 1}} ⊕ {s}_{{ω}_{r 2}} ⊕ … = {d}_{r} .$$

Since x₁ ⊕ . . . ⊕ xₘ=y⇔x₁ ⊕ . . . ⊕ xₘ ⊕ y=0, the second system is equivalent the SAT formula

$$[ ¬ {S}_{{ω}_{11}} ⊕ {s}_{{ω}_{12}} ⊕ … ⊕ {d}_{1} ] … [ ¬ {S}_{{ω}_{r 1}} ⊕ {s}_{{ω}_{r 2}} ⊕ … ⊕ {d}_{r} ]$$

i.e. to the problem of finding a satisfying assignment of the variables sᵢ. By Schaefer's dichotomy theorem, XOR-SAT is in the complexity class P and can be solved by Gaussian elimination (the second system is a system of linear equations modulo 2). Since there are quadratically many logical variables as a function of the size of the problem l=└ log₂(n)┐, the inversion of the parity mapping can be performed efficiently, i.e. in polynomial time in l.

An illustrative example of a 3 bit×3 bit multiplier is depicted in FIGS. 20A-B. The input numbers (prime factors) are p=p₂p₁p₀ and q=q₂q₁q₀ given in binary expansion. Since p and q are both integers between zero and seven, their product cannot exceed 49. Hence, the output number n fits into a register n=n₅n₄ . . . n₀ of six bits. In order to compute the binary digits of the product integer n=p·q, the multiplication circuit presented in FIG. 16a) has to sum up 3²=9 binary products pᵢqⱼ while respecting carry overflows to higher powers of two. The corresponding circuit is built up from three AND gates and six AND.FA units as shown in FIG. 20A. As discussed above, each relation between gate nodes is compensated for by an independent constraint between the corresponding local subsystems. There are two types of such relations: a) common variables, i.e. two input nodes are connected such that their corresponding states equal, and b) gate interconnections, i.e. an output node of a preceding gate is also an input node of a subsequent gate.

As illustrated in FIG. 20A, left panel, each variable qⱼ is a common variable of three gates. In this sense, q₀ serves as common input for all three AND gates, while q₁ and q₂ act as common inputs for three AND.FA gates each. In our arrangement the variables qⱼ repeat ‘horizontally’. Likewise, the input variables pᵢ repeat ‘vertically’: each column of gates −consisting of one AND gate and two AND.FA gates—has a common input pᵢ. In contrast to the case of three independent AND gates, the connections between input nodes in the first row given by q₀, reduces the number of independent variables by two. Since the 3-bit example circuit is implemented over three rows and three columns of gates, there are in total 2·2·3=12 connections between input nodes.

FIG. 20A, right panel, shows the gate interconnections. The rightmost AND gate directly outputs the lowest significant bit n₀ but the other two AND gates feed their outputs so and s₁ into two subsequent AND.FA gates. Furthermore, the sum output of an AND.FA gate is connected to a sum input of a second AND.FA gate twice. On four occasions, two AND.FA gates are connected from carry output to carry input and finally, in one case the carry output is fed into a sum input of an AND.FA gate. This yields a total of 9 gate interconnections.

Summarizing, 12+9=21 constraints are needed (12 common variable constraints plus 9 gate interconnection constraints) to build the 3 bit×3 bit multiplier from basic AND and AND.FA gates. FIG. 20A shows the labeling of the associated 24 logical variables. Six of them store the input p, q and six hold the output information n. Furthermore, we need four sum variables s₀,s₁,s₂,s₃ and four carry variables c₀, c₁, c₃, c₄ and a special variable cs for connecting the leftmost carry output to the sum input of the next row. Finally, since we make repetitive use of the AND.FA gate—even when there is no previous carry or sum—we introduce three auxiliary variables a₀, a₁, a₂. Setting these inputs to zero enables the implementation of the required Half-Adders within the implementation of a Full-Adder.

The translation into the parity model proceeds as described above: Each AND gate is implemented as a plaquette of 4 qubits while AND.FA gates are realized by body-centered cubes of 9 qubits in total. Furthermore, gate-node connections are translated into parity constraints (gate interconnection Hamiltonians, common variable Hamiltonians) connecting bare plaquettes. FIG. 15i-ix show the basic translation steps.

The common variable Hamiltonians are described next. FIG. 15iii-iv show the cases of ‘horizontally’ repeating qⱼ input variables. As described above, the common input variable qⱼ appearing in neighbouring gates translates to an additional 4-body constraint (common variable Hamiltonian) in the parity model connecting both sum plaquettes. Beside horizontal connections of input variables we also have vertically repeating variables pᵢ. Similar to the horizontal case, these connections lead to additional 4-body constraints connecting the sum plaquettes (see FIG. 15vii-ix). For better understanding it is useful to consider a simpler circuit: Consider a 2D-grid of AND gates of size k×k. We connect the first input nodes of the gates column-wise and the second input nodes row-wise such that the circuit has 2k(k−1) connections between input nodes. We translate the logic of the AND gates into the parity model using k² plaquettes. We enumerate the AND gates by └i,j└, where i denotes the column index and j the row index [similar to FIG. 20A, left panel]. If we call s_{i,j} the sum output of the [i, j]-AND gate, the corresponding plaquette has labels (s_{i,j}), (pᵢ, s_{i,j}), (qⱼ, s_{i,j}) and (pᵢ, qⱼ, s_{i,j}). We can group these into sets R: ={(s_{i,j}), (qⱼ, s_{i,j})} and L: ={(pᵢ, s_{i,j}), (pᵢ, qⱼ, s_{i,j})} or alternative into D: ={(s_{i,j}), (pᵢ, s_{i,j})} and U: ={(qⱼ, s_{i,j}), (pᵢ, qⱼ, s_{i,j})}. The two tuples from the set ‘right’ R and ‘left’ L formally differ by qⱼ—independent of the column i, while the elements in ‘down’ D and ‘up’ U differ by pᵢ for all row indices j. Neighbouring AND parity plaquettes [i,j], [i+1j] can thus be connected with a parity constraint involving qubits labeled by e.g. L₁: ={(pᵢ, s_{i,j}), (pᵢ, qⱼ, s_{i,j})} and R₂: ={(s_{i+1,j}), (qⱼ, s_{i+1,j}) i.e. the left set of the first plaquette and the right set of the second plaquette. Similarly, vertically neighbouring AND parity plaquettes [i,j], [i,j+1] can be connected with a parity constraint on qubits with labels in D₁: ={(s_{i,j}), (pᵢ, s_{i,j})} and U₂: ={(qⱼ₊₁, s_{i,j+1}), (pᵢ, qⱼ₊₁, s_{i,j+1})}. Notably, by carefully arranging the labeling in-between the plaquettes, horizontal and vertical parity constraints are simultaneously available. A possible way is to arrange the labeling in each plaquette such that the upper qubits are labeled with labels from the set U and respective the lower, the right and the left qubits. In that sense, the qubit in the right lower corner should be get the label RD=R∩D=(s_{i,j}). Analogously, we get LD=(pᵢ, s_{i,j}), RU=(qⱼ, s_{i,j}) and LU=(pᵢ, qⱼ, s_{i,j}). It is straightforward to check this arrangement yields 2k(k−1) new 4-body parity constraints.

With this analysis in mind we focus again on the arrangement of AND and AND.FA plaquettes found in the multiplication circuit. As already described above, it is noted that one of the two AND.FA plaquettes is conceptually similar to the AND parity plaquette i.e. the corresponding labeling is obtained by formally replacing the sum output label s by the triple s, c, s′. Beside this difference, the overall structure of the sum plaquettes related to the multiplier circuit is the same as the 2D-grid example of AND gates. Again, the input variables pᵢ repeat vertically and the variables qⱼ horizontally. With this, it is easy to understand that the plaquettes and the sum plaquettes of the corresponding AND.FA gates can be arranged in a 2D layer with 2k(k−1) new 4-parity constraints acting on a plaquette of neighbouring qubits. In the case of k=3 there are 12 new constraints as depicted in FIG. 20B, left panel. These plaquettes are arranged in a first layer. The drawing in FIG. 20B, left panel, shows the labeling of the physical qubits. Since several indices appear repeatedly amongst qubits belonging to the same plaquette, we introduce a shorthand notation: We formally split the string of labels into a common part and unique parts. The common part, denoted in FIG. 20B by an expression of the form +(common-labels), is presented on the center of the plaquettes and the unique and distinct part are represented as labels associated to the qubits. Whenever the reader finds an expression of the form+(common-labels) at the center of a plaquette, this should be understood such that the labels of each of the four qubits of said plaquette should be extended by the common part (common-labels) to form the actual labeling string. For example, regarding the plaquette in the upper right corner in FIG. 20B, left panel, three qubits of said plaquette are labelled by (p₀, q₀), (q₀), (p₀), and one qubit of said plaquette has no label. Further, the expression+no is shown at the center of the plaquette. Accordingly, the qubit labels of said plaquette should be understood as (p₀, q₀, n₀), (q₀, n₀), (p₀, n₀) and (n₀) where the common part is no.

Beside the nine plaquettes forming the first layer (i.e. the sum plaquettes), there are six plaquettes—related to the six AND.FA gates (the carry plaquettes)—that are still disconnected from the first layer. Gate interconnections translate into parity constraints (gate interconnection Hamiltonians) for coupling the carry plaquettes to the first layer. The basic construction steps are described above and are shown in FIG. 15iv-vii. As described above, for each pair of sum and carry plaquettes, a 3-body parity constraint (gate interconnection Hamiltonian) and a carry qubit is introduced such that the constraint fixes the value of the corresponding carry qubit. While the carry plaquettes can be arranged on a second layer—above their sum counterparts (cf. FIG. 20B, right panel)—the carry qubits can be arranged in between these two layers in a middle layer (cf. FIG. 20B, middle panel). With the help of the six C₀, c₁, Cs, C₂, c₃, n₅ auxiliary carry qubits, the missing nine constraints associated to the gate interconnections can be constructed as shown in Table II:

TABLE II
nine constraints associated to the gate interconnections

| comm. var. | constraint | # qubits |
|---|---|---|
| s₀ | (s₀), (s₀, c₀), (c₀) | 3-body |
| s₁ | (s₁), (s₁, c₁), (c₁) | 3-body |
| s₂ | (s₂, c₁), (c₁), (s₂, c₂), (c₂) | 4-body |
| s₃ | (s₃, cs), (cs), (s₃, c₃), (c₃) | 4-body |
| c₀ | (c₀), (c₀, c₁), (c₁) | 3-body |
| c₁ | (c₁), (c₁, cs), (cs) | 3-body |
| c₂ | (c₂), (c₂, c₃), (c₃) | 3-body |
| c₃ | (c₃), (c₃, n₅), (n₅) | 3-body |
| cs | (cs), (cs, n₅), (n₅) | 3-body |

In table II, labels with two variables refer to qubits in the top layer and the others containing a single variable are either associated to the carry qubits in the middle layer or the output qubit of the first row of plaquettes in the lowest layer [cf. FIG. 20B]. The column ‘comm.var.’ shows the common variables associated to the respective gate interconnections. Each such gate interconnection in the circuit allows the construction of a parity constraint (gate interconnection Hamiltonian) in the quantum system. Some of them are highlighted in FIG. 20B, such as a 4-body constraint and 3-body constraints. See also FIG. 14 for a 3D schematic visualization of the 3 bit×3 bit multiplier example. In total 12+9=21 parity constraints compensate the 21 identifications made by common input variables and gate interconnections when building up the multiplication circuit from raw gates. The 3 bit×3 bit multiplying architecture can be programmed—that is to say, the integer n that is to be factorized can be encoded into the quantum system—by introducing single-body fields (single-body Hamiltonians) on qubits associated to the labels n₀ and n₅ and 2-body Hamiltonians related to the sets of labels {(c₂), (n₂, c₂)}, {(c₃), (n₃, c₃)} and {(cs), (n₄, c₅)}. For the sake of illustration, FIG. 20B shows one of the two-body Hamiltonians necessary to program the bit n₂. Additionally, some carry inputs a₁, a₂ and a sum input a₀ are set to zero by adding additional Hamiltonians acting on {(cs), (a₀, cs)}, {(c₀), (a₁, c₀)} and {(c₂), (a₂, c₂)}. This allows to mimic the logic of a Half-Adder within the implementation of AND.FA gates.

The 3 bit×3 bit example described above can be generalized to arbitrary integers in a straightforward manner.

While the foregoing is directed to embodiments, other and further embodiments may be devised without departing from the scope determined by the claims.

1. A quantum computational method of performing prime factorization of an integer, comprising:
a) determining a logic gate circuit including logic gates, the logic gate circuit being configured to compute a multiplication function having, as an output, the integer;
b) determining gate-encoding Hamiltonians (H_{G}), one for each logic gate of the logic gates, wherein each gate-encoding Hamiltonian encodes an input-output relation of a logic gate of the logic gates and is a sum of summand Hamiltonians;
c) providing a quantum system comprising constituents, wherein each summand Hamiltonian of each gate-encoding Hamiltonian of the gate-encoding Hamiltonians is associated with a respective constituent of the quantum system;
d) determining a first set of short-range quantum interactions of the constituents based on the logic gates of the logic gate circuit;
e) determining a second set of short-range quantum interactions of the constituents based on the integer;
f) evolving the quantum system, including implementing the first set of short-range quantum interactions and the second set of short-range quantum interactions;
g) measuring at least a portion of the quantum system to obtain a read-out; and
h) determining a prime factor of the integer based on the read-out.

2. The quantum computational method of claim 1, wherein the quantum system includes local subsystems each including a subset of the constituents, wherein each gate-encoding Hamiltonian of the gate-encoding Hamiltonians is associated with a local subsystem.

3. The quantum computational method of claim 2, wherein determining the first set of short-range quantum interactions includes:
for each gate-encoding Hamiltonian of the gate-encoding Hamiltonians, determining short-range quantum interactions from the gate-encoding Hamiltonian, the determined short-range quantum interactions acting inside the local subsystem associated with the gate-encoding Hamiltonian,
wherein implementing the first set of short-range quantum interactions includes implementing the determined short-range quantum interactions.

4. The quantum computational method of claim 2, wherein determining the first set of short-range quantum interactions includes:
for each gate-encoding Hamiltonian of the gate-encoding Hamiltonians, determining single-body interactions from the gate-encoding Hamiltonian, the determined single-body interactions being representable by a single-body Hamiltonian acting inside the local subsystem associated with the gate-encoding Hamiltonian,
wherein implementing the first set of short-range quantum interactions includes implementing the determined single-body interactions.

5. The quantum computational method of claim 4, wherein each summand Hamiltonian of each gate-encoding Hamiltonian of the gate-encoding Hamiltonians has an interaction coefficient, wherein the interaction coefficient is mapped to a single-body interaction.

6. The quantum computational method of claim 2, wherein determining the first set of short-range quantum interactions includes:
for each gate-encoding Hamiltonian of the gate-encoding Hamiltonians, determining one or more constraint interactions from the gate-encoding Hamiltonian, wherein the one or more constraint interactions are representable by a constraint Hamiltonian acting inside the local subsystem associated with the gate-encoding Hamiltonian,
wherein implementing the first set of short-range quantum interactions includes implementing the determined one or more constraint interactions.

7. The quantum computational method of claim 2, wherein:
(a) the logic gate circuit includes gate interconnections between pairs of logic gates, wherein determining the first set of short-range quantum interactions includes:
for each gate interconnection of the gate interconnections, determining one or more gate interconnection interactions from the gate interconnection, the one or more gate interconnection interactions being representable by a gate interconnection Hamiltonian coupling at least two local subsystems of the quantum system,
wherein implementing the first set of short-range quantum interactions includes implementing the determined gate interconnection interactions; and/or
(b) the logic gate circuit includes common variables of groups of logic gates, wherein determining the first set of short-range quantum interactions includes:
for each common variable of a set of common variables, determining one or more common variable interactions from the common variable, the one or more common variable interactions being representable by a common variable Hamiltonian coupling at least two local subsystems of the quantum system,
wherein implementing the first set of short-range quantum interactions includes implementing the determined common variable interactions.

8. (canceled)

9. The quantum computational method of claim 1, wherein evolving the quantum system includes evolving the quantum system towards a ground state of a total Hamiltonian, the total Hamiltonian being a sum including a first Hamiltonian and a second Hamiltonian, the first Hamiltonian representing the first set of short-range quantum interactions and the second Hamiltonian representing the second set of short-range quantum interactions.

10. The quantum computational method of claim 1, wherein:
(a) evolving the quantum system includes:
cooling the quantum system; or
performing an adiabatic evolution of the quantum system; or
performing a counter-diabatic evolution of the quantum system; or
performing a unitary evolution of the quantum system; or
any combination thereof; and/or
(b) each gate-encoding Hamiltonian of the gate-encoding Hamiltonians is a classical Hamiltonian or a quantum Hamiltonian.

11. (canceled)

12. The quantum computational method of claim 1, wherein the logic gates include AND gates and/or AND.FA gates.

13. The quantum computational method of claim 12, wherein, for each logic gate of the logic gates that is an AND gate, the gate-encoding Hamiltonian associated with the logic gate has the form
$${H}_{AND} = - {σ}_{s} - {σ}_{u} {σ}_{s} - {σ}_{v} {σ}_{s} + {σ}_{u} {σ}_{v} {σ}_{s} ,$$
wherein σᵤ, σᵥ and σₛ are spin observables associated with logical variables u, v and s, respectively, wherein the logical variables u and v are input variables of the AND gate and the logical variable s is an output variable of the AND gate.

14. The quantum computational method of claim 12, wherein, for each logic gate of the logic gates that is an AND.FA gate, the gate-encoding Hamiltonian associated with the logic gate has the form
$${H}_{AND . FA} = - {σ}_{s} {σ}_{c} {σ}_{{s}^{′}} - {σ}_{u} {σ}_{s} {σ}_{c} {σ}_{{s}^{′}} - {σ}_{v} {σ}_{s} {σ}_{c} {σ}_{{s}^{′}} + {σ}_{u} {σ}_{v} {σ}_{s} {σ}_{c} {σ}_{{s}^{′}} - {σ}_{s} {σ}_{c} {σ}_{{s}^{′}} {σ}_{{c}^{′}} - {σ}_{s} {σ}_{{c}^{′}} - {σ}_{c} {σ}_{{c}^{′}} + {σ}_{{s}^{′}} {σ}_{{c}^{′}}$$
wherein σᵤ, σᵥ, σₛ, σ_{c}, σₛ′ and σ_{c}′ are spin observables associated with logical variables u, v, s, c, s′ and c′, respectively, wherein the logical variables u, v, s and c are input variables of the AND.FA gate and the logical variables s′ and c′ are output variables of the AND.FA gate.

15. A quantum computational method of performing prime factorization of an integer, comprising:
a) determining a logic gate circuit including logic gates, the logic gate circuit being configured to compute a multiplication function having, as an output, the integer;
b) providing a quantum system comprising constituents;
c) determining a first set of short-range quantum interactions of the constituents based on the logic gates, wherein the determining comprises, for each logic gate of the logic gates:
determining a subset of constituents associated with the logic gate; and
encoding the logic gate in short-range quantum interactions of the subset of constituents;
d) determining a second set of short-range quantum interactions of the constituents based on the integer;
e) evolving the quantum system, including implementing the first set of short-range quantum interactions and the second set of short-range quantum interactions;
f) measuring at least a portion of the quantum system to obtain a read-out; and
g) determining a prime factor of the integer based on the read-out.

16. A fundamental subroutine of a quantum computation operating with a quantum system including constituents, the fundamental subroutine comprising:
determining an elementary subsystem (S_{AND}) of the quantum system including at least four of the constituents,
wherein each summand Hamiltonian of the gate-encoding Hamiltonian H_{AND} defined by
$${H}_{AND} = - {σ}_{s} - {σ}_{u} {σ}_{s} - {σ}_{v} {σ}_{s} + {σ}_{u} {σ}_{v} {σ}_{s} \qquad ( A )$$
is associated with a respective constituent of the elementary subsystem,
wherein the gate-encoding Hamiltonian H_{AND} encodes an input-output relation of an AND gate having logical variables u and v as input variables and a logical variable s as an output variable,
wherein σᵤ, σᵥ and σₛ are spin observables associated with the logical variables u, v and s, respectively;
determining short-range quantum interactions for the elementary subsystem from the gate-encoding Hamiltonian H_{AND}; and
evolving the quantum system, including implementing the determined short-range quantum interactions in the elementary subsystem.

17. A fundamental subroutine of a quantum computation operating with a quantum system including constituents, the fundamental subroutine comprising:
determining an elementary subsystem (S_{AND.FA}) of the quantum system including at least eight of the constituents,
wherein each summand Hamiltonian of the gate-encoding Hamiltonian H_{AND.FA} defined by
$${H}_{AND . FA} = - {σ}_{s} {σ}_{c} {σ}_{{s}^{′}} - {σ}_{u} {σ}_{s} {σ}_{c} {σ}_{{s}^{′}} - {σ}_{v} {σ}_{s} {σ}_{c} {σ}_{{s}^{′}} + {σ}_{u} {σ}_{v} {σ}_{s} {σ}_{c} {σ}_{{s}^{′}} - {σ}_{s} {σ}_{c} {σ}_{{s}^{′}} {σ}_{{c}^{′}} - {σ}_{s} {σ}_{{c}^{′}} - {σ}_{c} {σ}_{{c}^{′}} + {σ}_{{s}^{′}} {σ}_{{c}^{′}} \qquad ( B )$$
is associated with a respective constituent of the elementary subsystem,
wherein the gate-encoding Hamiltonian H_{AND.FA} encodes an input-output relation of an AND.FA gate having logical variables u, v, s and c as input variables and logical variables s′ and c′ as output variables,
wherein σᵤ, σᵥ, σₛ, σ_{c}, σₛ′ and σ_{c}′ are spin observables associated with the logical variables u, v, s, c, s′ and c′, respectively;
determining short-range quantum interactions for the elementary subsystem from the gate-encoding Hamiltonian H_{AND.FA}; and
evolving the quantum system, including implementing the determined short-range quantum interactions in the elementary subsystem.

18. A method of performing a quantum computation, comprising:
providing a quantum system comprising constituents;
performing one or more fundamental subroutines according to claim 16 and/or one or more fundamental subroutines according to claim 17; and
measuring at least a portion of the quantum system to obtain a read-out.

19. A quantum computational method of inverting a logic gate circuit including logic gates, comprising:
a) providing an output of the logic gate circuit that corresponds to an unknown input of the logic gate circuit;
b) determining gate-encoding Hamiltonians (H_{G}), one for each logic gate of the logic gates, wherein each gate-encoding Hamiltonian encodes an input-output relation of a logic gate of the logic gates and is a sum of summand Hamiltonians;
c) providing a quantum system comprising constituents, wherein each summand Hamiltonian of each gate-encoding Hamiltonian of the gate-encoding Hamiltonians is associated with a respective constituent of the quantum system;
d) determining a first set of short-range quantum interactions of the constituents based on the logic gates of the logic gate circuit;
e) determining a second set of short-range quantum interactions of the constituents based on the output of the logic gate circuit;
f) evolving the quantum system, including implementing the first set of short-range quantum interactions and the second set of short-range quantum interactions;
g) measuring at least a portion of the quantum system to obtain a read-out; and
h) determining the unknown input of the logic gate circuit based on the readout.

20. An apparatus for performing prime factorization of an integer, comprising:
a classical computing system;
a quantum system comprising constituents;
a quantum processing unit; and
a measurement unit,
the classical computing system being configured for
determining a logic gate circuit including logic gates, the logic gate circuit being configured to compute a multiplication function having, as an output, the integer;
determining gate-encoding Hamiltonians, one for each logic gate of the logic gates, wherein each gate-encoding Hamiltonian encodes an input-output relation of a logic gate of the logic gates and is a sum of summand Hamiltonians, wherein each summand Hamiltonian of each gate-encoding Hamiltonian of the gate-encoding Hamiltonians is associated with a respective constituent of the quantum system;
determining a first set of short-range quantum interactions of the constituents based on the logic gates of the logic gate circuit; and
determining a second set of short-range quantum interactions of the constituents based on the integer;
the quantum processing unit being configured for evolving the quantum system, including implementing the first set of short-range quantum interactions and the second set of short-range quantum interactions,
the measurement unit being configured for measuring at least a portion of the quantum system to obtain a read-out,
the classical computing system being further configured for determining a prime factor of the integer based on the read-out.

21. An apparatus for performing prime factorization of an integer, comprising:
a classical computing system;
a quantum system comprising constituents;
a quantum processing unit; and
a measurement unit,
the classical computing system being configured for
determining a logic gate circuit including logic gates, the logic gate circuit being configured to compute a multiplication function having, as an output, the integer;
determining a first set of short-range quantum interactions of the constituents based on the logic gates, wherein the determining comprises, for each logic gate of the logic gates:
determining a subset of constituents associated with the logic gate; and
encoding the logic gate in short-range quantum interactions of the subset of constituents;
determining a second set of short-range quantum interactions of the constituents based on the integer,
the quantum processing unit being configured for evolving the quantum system, including implementing the first set of short-range quantum interactions and the second set of short-range quantum interactions,
the measurement unit being configured for measuring at least a portion of the quantum system to obtain a read-out,
the classical computing system being further configured for determining a prime factor of the integer based on the read-out.

22. An apparatus for inverting a logic gate circuit including logic gates, comprising:
a classical computing system;
a quantum system comprising constituents;
a quantum processing unit; and
a measurement unit,
the classical computing system being configured for
providing an output of the logic gate circuit that corresponds to an unknown input of the logic gate circuit;
determining gate-encoding Hamiltonians, one for each logic gate of the logic gates, wherein each gate-encoding Hamiltonian encodes an input-output relation of a logic gate of the logic gates and is a sum of summand Hamiltonians, wherein each summand Hamiltonian of each gate-encoding Hamiltonian of the gate-encoding Hamiltonians is associated with a respective constituent of the quantum system;
determining a first set of short-range quantum interactions of the constituents based on the logic gates of the logic gate circuit; and
determining a second set of short-range quantum interactions of the constituents based on the output of the logic gate circuit,
the quantum processing unit being configured for evolving the quantum system, including implementing the first set of short-range quantum interactions and the second set of short-range quantum interactions,
the measurement unit being configured for measuring at least a portion of the quantum system to obtain a read-out,
the classical computing system being further configured for determining the unknown input of the logic gate circuit based on the readout.
